(19) United States
(12) Patent Application Publication
(10) Pub. No.: US 2024/0297692 A1
(43) Pub. Date: Sep. 5, 2024

(54) ENHANCEMENT OF TYPE-1 MULTI-PANEL CODEBOOK

(71) Applicant: QUALCOMM Incorporated, San Diego, CA (US)

(72) Inventors: Hyojin Lee, San Diego, CA (US); Yu Zhang, San Diego, CA (US); Hung Dinh Ly, San Diego, CA (US); Muhammad Sayed Khairy Abdelghaffar, San Jose, CA (US); Hwan Joon Kwon, San Diego, CA (US); Tingfang Ji, San Diego, CA (US)

(21) Appl. No.: 18/569,466

(22) PCT Filed: Aug. 26, 2021
(86) PCT No.: PCT/CN2021/114736

§ 371 Date: Dec. 12, 2023

(51) Int. Cl. H04B 7/0456; H04B 7/06

(52) U.S. Cl. CPC H04B 7/0486; H04B 7/0626; H04B 7/0639

(57) ABSTRACT

Aspects of the disclosure relate to multiple-input and multiple-output (MIMO) codebook configuration for wireless downlink communications. A user equipment or a scheduled entity receives a reference signal (channel state information reference signal (CSI-RS) and transmits a CSI report based on the reference signal. The CSI report includes a rank indicator configured to indicate one or more ranks among multiple ranks corresponding to multiple antenna panels associated with the reference signal, and a precoding matrix indicator (PMI) corresponding to a codebook for the plurality of antenna panels. In some examples, a first rank of the multiple ranks is different from a second rank of the plurality of ranks. In other examples, a first antenna panel of the multiple antenna panels having a different number of antenna ports than a second antenna panel of the multiple antenna panels. Other aspects, embodiments, and features are also claimed and described.

### TECHNICAL FIELD

The technology discussed below relates generally to wireless communication systems, and more particularly, to multiple-input and multiple-output (MIMO) codebook configuration for wireless downlink communications.

### INTRODUCTION

Contemporary wireless communication systems frequently employ multiple antenna panels having the same rank for downlink transmissions. Wireless communications using multiple antenna panels having the same rank provide some advantages in system throughput over single-panel communications. As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example a method of wireless communication operable at a scheduled entity is disclosed. The method includes receiving a reference signal; and transmitting a channel state information (CSI) report based on the reference signal. The CSI report may include a rank indicator configured to indicate one or more ranks among a plurality of ranks corresponding to a plurality of antenna panels associated with the reference signal, and a precoding matrix indicator (PMI) corresponding to a codebook for the plurality of antenna panels. In some aspects of this disclosure, a first rank of the plurality of ranks being different from a second rank of the plurality of ranks. In other aspects of this disclosure, a first antenna panel of the plurality of antenna panels having a different number of antenna ports than a second antenna panel of the plurality of antenna panels.

These and other aspects of the technology discussed herein will become more fully understood upon a review of the detailed description, which follows. Other aspects, features, and embodiments will become apparent to those of ordinary skill in the art upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments, it should be understood that such exemplary embodiments can be implemented in various devices, systems, and methods.

### BRIEF DESCRIPTION OF THE DRAWINGS

FIG. 1 is a schematic illustration of a wireless communication system according to some embodiments.

FIG. 2 is a conceptual illustration of an example of a radio access network according to some embodiments.

FIG. 3 is a block diagram illustrating a wireless communication system supporting multiple-input multiple-output (MIMO) communication according to some embodiments.

FIG. 4 illustrates an example of a wireless communication system for downlink communication according to some embodiments.

FIG. 5 illustrates an example of a CSI-RS port array for multiple antenna panels according to some embodiments.

FIGS. 6A and 6B illustrate examples of codebooks for multiple antenna panels having different ranks according to some embodiments.

FIGS. 7A-7D are conceptual illustrations of codebooks using an equal column power method for two antenna panels having different ranks according to some embodiments.

FIGS. 8A-8F are conceptual illustrations of codebooks using an equal column power method for four antenna panels having different ranks according to some embodiments.

FIG. 9 illustrates examples for CSI reporting for a multi-panel codebook using the equal column power according to some embodiments.

FIGS. 10A-10D are conceptual illustrations of codebooks using an equal row power method for two antenna panels having different ranks according to some embodiments.

FIGS. 11A-11F are conceptual illustrations of codebooks using an equal row power method for four antenna panels having different ranks according to some embodiments.

FIG. 12 illustrates examples for CSI reporting for multi-panel codebook with the equal row power

FIG. 13 is a block diagram conceptually illustrating an example of a hardware implementation for a scheduled entity according to some embodiments.

FIG. 14 is a flow chart illustrating an exemplary process for downlink communication using a multi-panel codebook according to some embodiments.

FIG. 15 is a flow chart illustrating an exemplary process for a multi-panel codebook for CSI reporting using an equal column power method according to some embodiments.

FIG. 16 is a flow chart illustrating an exemplary process for a multi-panel codebook for CSI reporting using an row column power method according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

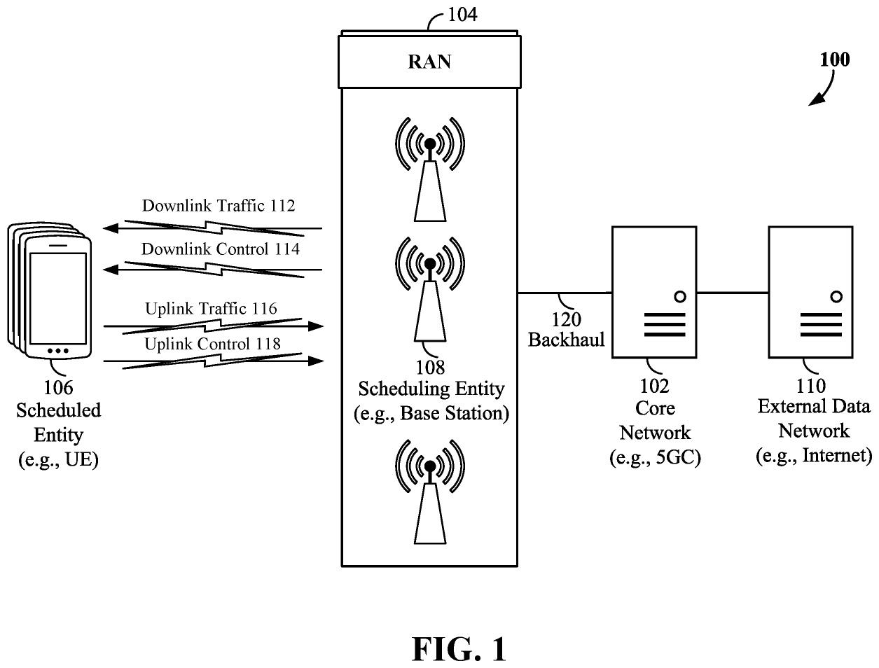

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

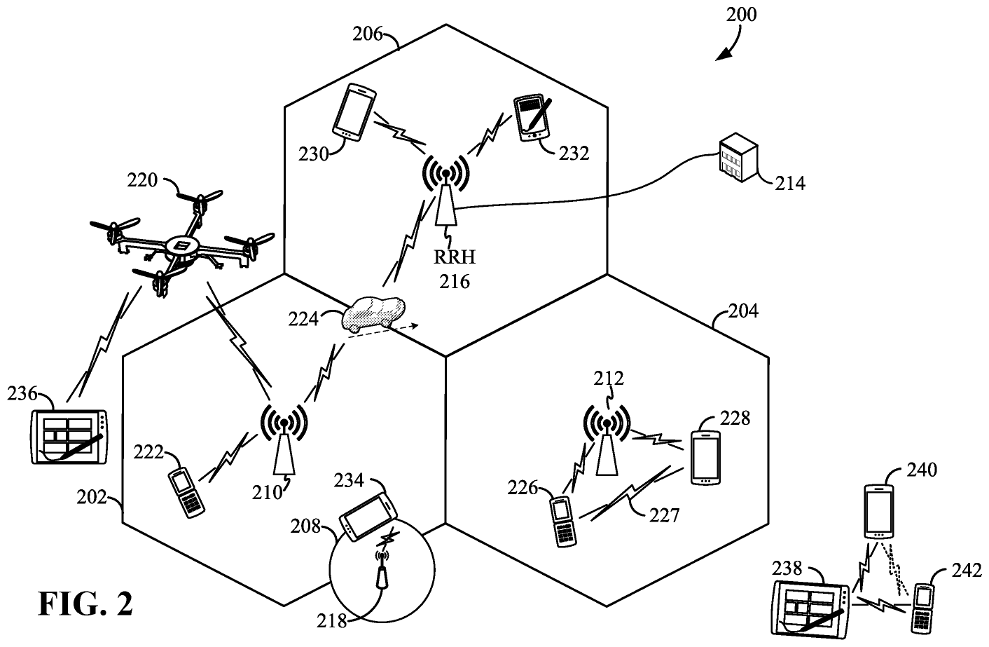

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212. 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224. 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

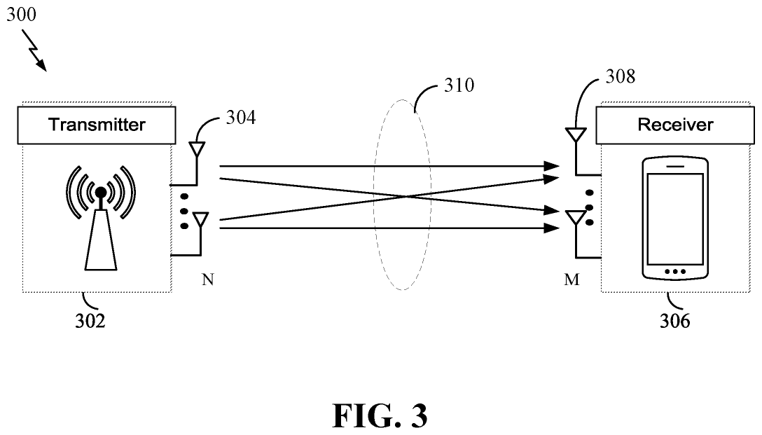

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitter 302 may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In the simplest case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

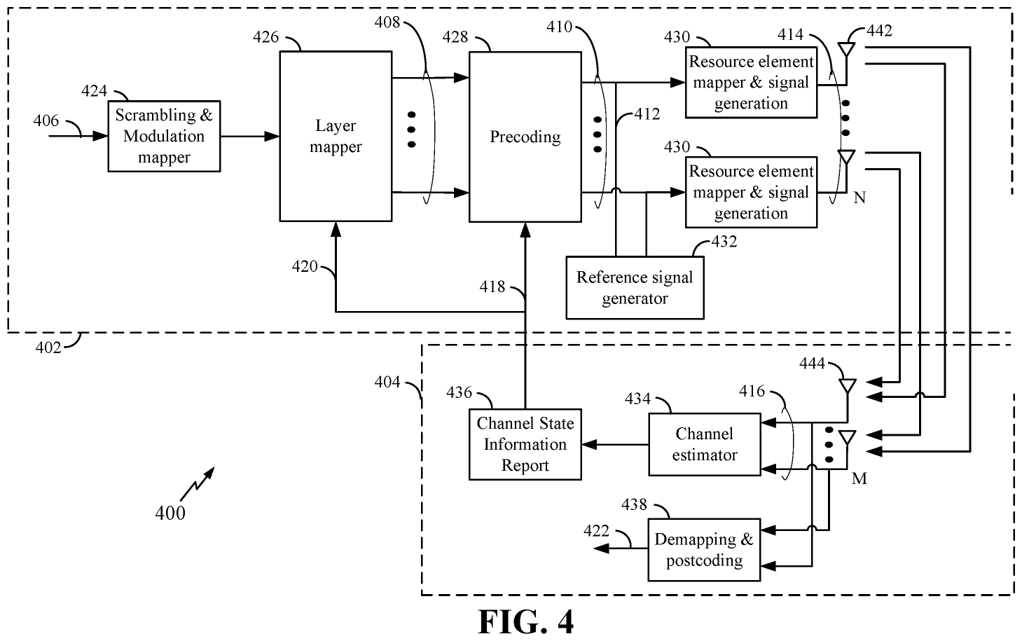

FIG. 4 illustrates an example of a wireless communication system 400 for downlink communication in accordance with some aspects of the present disclosure. In some examples, a reference signal generator 432 of a scheduling entity 402 may generate a CSI-RS 412 and map the CSI-RS to antenna ports 414 (e.g., CSI-RS ports) corresponding to transmit antennas 442. The scheduling entity 402 may then transmit the CSI-RS for multiple layers to provide for multi-layer channel estimation. In response, a scheduled entity 404 may measure the channel quality across layers and resource blocks based on the received CSI-RS. The scheduled entity 404 may then transmit a CSI report including a scheduled entity's preferred rank indicator (RI) 420 and precoding matrix indicator (PMI) 418 to the scheduling entity 402 for future DL transmissions. The CSI report may further include Channel Quality Indicator (CQI), CSI-RS resource indicator (CRI), SS/PBCH Block Resource indicator (SSBRI), layer indicator (LI), L1-RSRP, or L1-SINR.

In the CSI report, an RI 426 is configured to indicate scheduled entity's 404 preferred rank for future downlink transmission. The rank corresponds to the number data streams or layers in a MIMO or MU-MIMO (generally referred to as MIMO) system. In general, the rank of a MIMO system is limited by the number of transmit or receive antennas 442 or 444, whichever is lower. In addition, the channel conditions at the scheduled entity 404, as well as other considerations, such as the available resources at the scheduling entity 402, may also affect the transmission rank. For example, a scheduling entity 402 in a RAN (e.g., base station) may assign a rank (and therefore, a number of data streams) for a DL transmission to a particular scheduled entity 404 (e.g., UE) based on a rank indicator (RI) the scheduled entity 404 transmits to the base station. The UE may determine this RI based on the antenna configuration (e.g., the number of transmit and receive antennas 442, 444) and a measured signal-to-interference-and-noise ratio (SINR) on each of the receive antennas 444. The RI may indicate, for example, the number of layers that the scheduled entity 404 may support under the current channel conditions. The scheduling entity may use the RI along with resource information (e.g., the available resources and amount of data to be scheduled for the UE) to assign a DL transmission rank 408 to the scheduled entity 404.

In addition, a PMI 418 of the CSI report 436 generally reports a precoding matrix index 418 indicating scheduled entity's preferred precoding matrix for the scheduling entity 402 to use, and may be indexed to a predefined codebook (W). The predefined codebook is a set of precoding matrices. The scheduled entity 404 searches one preferred precoding matrix in the codebook based on the reference signal (e.g., a CSI-RS) and reports a PMI indicating the preferred precoding matrix to the scheduling entity 402. A codebook (W) may be given by W=W₁W₂·W₁ is a long-term and wideband codebook reported as a wideband PMI containing beam selection information. When the scheduled entity 404 configures wideband PMI reporting, the scheduled entity may report a wideband PMI for the entire CSI reporting band. W₂ is a short-term and subband codebook reported as a subband PMI containing a co-phasing (φₙ) and possibly sub-beam selection information. When the scheduled entity 404 configure subband PMI reporting, except with 2 antenna ports, the scheduled entity 404 may report a single wideband indication for the entire CSI reporting band and one subband indication for each subband in the CSI reporting band. When the scheduled entity 404 configures subband PMIs with 2 antenna ports, the scheduled entity 404 may report a PMI for each subband in the CSI reporting band.

The scheduling entity 402 may then utilize this PMI 418 to determine a suitable precoding matrix for transmissions to the scheduled entity 404. For the transmissions, the scheduling entity 402 may scramble coded bits in each of the codewords 406 to be transmitted on a physical channel and modulate the scrambled bits to generate complex-valued modulation symbols in a scrambling & modulation mapper 424. The scheduling entity 402 may determine one or several suitable transmission layers 408 based on the RI 420 in the CSI report 436 from the scheduled entity 404. In a layer mapper 426, the scheduling entity 402 may map the complex-valued modulation symbols onto one or several transmission layers 408. Then, the scheduling entity 402 may precode 428 the complex-valued modulation symbols on each layer for transmission on the antenna ports 442 based on a suitable precoding matrix. The scheduling entity 402 may determine the suitable precoding matrix based on the PMI 418 in the CSI report 436 from the scheduled entity 404 or any other suitable parameters.

The scheduling entity 204 may precode layers 408 (e.g., multiple streams of data) based on scheduled entity's preferred precoding matrix corresponding to the reported PMI or any other suitable precoding matrix. Precoding may indicate a linear combination of a precoding matrix (W) with layers 408 (e.g., multiple streams of data) given by

$$[ \begin{matrix}precoded output 1 \\ ⋮ \\ precoded output N\end{matrix} ] = [ \begin{matrix}{W}_{11} & … & {W}_{1 L} \\ ⋮ & ⋱ & ⋮ \\ {W}_{N 1} & … & {W}_{NL}\end{matrix} ] [ \begin{matrix}layer 1 \\ ⋮ \\ layer L\end{matrix} ] .$$

The precoding matrix

$$\\ ( [ \begin{matrix}{W}_{11} & ⋯ & {W}_{1 L} \\ ⋮ & ⋱ & ⋮ \\ {W}_{N 1} & ⋯ & {W}_{NL}\end{matrix} ] )$$

is a matrix with weights to generate precoded data streams 410 to be mapped to antenna ports 414 in a scheduling entity 402. The scheduling entity 402 may obtain a scheduled entity's preferred precoding matrix based on estimated channels that a scheduled entity 404 measures based on a reference signal (e.g., a channel state information reference signal, or CSI-RS). Although the scheduled entity 404 indicates a preferred precoding matrix using a precoding matrix indicator (PMI), the scheduling entity 402 may determine whether the scheduling entity 402 will use the preferred precoding matrix or any other suitable precoding matrix. The scheduled entity 404 can know scheduling entity's determined precoding matrix based on the Demodulation Reference Signal (DMRS) in a downlink communication (e.g., PDSCH).

In a resource element mapper & signal generation 430, the scheduling entity 402 may map complex-valued modulation symbols for each antenna port 442 to resource elements and generate complex-valued time-domain OFDM signal for each antenna port 442. Then, the scheduling entity 402 may transmit the complex-valued time-domain OFDM signal for each antenna port 442 to the scheduled entity 404. When the scheduled entity 404 receives the complex-valued time-domain OFDM signal, the process is reversed 438. After the reversed process, the scheduled entity 404 may obtain the codewords 422, 406 that are transmitted from the scheduling entity 402.

### CSI-RS Antenna Port Array for Multiple Panels

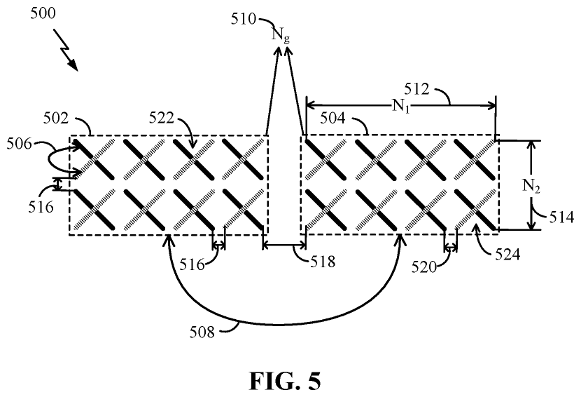

FIG. 5 illustrates an example of a CSI-RS port array for multiple antenna panels 500 in accordance with some aspects of the present disclosure. When a scheduling entity transmits a CSI-RS for channel estimation, scheduling entity's antenna array may constitute single or multiple antenna panels for the CSI-RS transmission. Thus, a scheduled entity may choose a different codebook when the number of antenna panels is different. Along with the number of antenna panels, a different precoding matrix also applies based on the type of codebook (e.g., type I and type II). For example, a type I codebook is generally designed for single-user MIMO and includes multiple predefined precoding matrices. A type II codebook is generally designed for multiple-user MIMO and provides a more sophisticated and detailed precoding matrix than a type I codebook.

Among different types of codebooks, a type I multi-panel codebook may include a set of single-panel precoding matrices with a co-phasing value between multiple antenna panels (e.g., 2 antenna panels or 4 antenna panels) for single-user MIMO. Here, each antenna panel 502 may have a physically and/or spatially separate set of antenna elements 522 from other sets 504 of antennas elements. In some examples, an antenna panel 502 may have an equal antenna space 516 between adjacent antenna elements 522, while two different antenna panels have an antenna panel space 518 different from the antenna space 516 in each antenna panel 502, 504. For example, a first antenna panel may have a first array of antenna elements 522. An antenna space (D₁₁) 516 between two adjacent antenna elements 522 in the first array of antenna elements 522 may have the same antenna space (D₁₁) 516 between two other adjacent antenna elements 522 in the first array 522. A second antenna panel may have a second array of antenna elements 524, and an antenna space (D₁₂) 520 between two adjacent antenna elements 524 in the second array of antenna elements 524 may have the same antenna space (D₁₂) 520 between two other adjacent antenna elements 524 in the second array. However, a panel space (D₂) 518 between the first antenna panel 502 and the second antenna panel 504 may be different from the antenna spaces (D₁₁) 516, and (D₁₂) 520 in the first antenna panel 502 and the second antenna panel 504, respectively.

In other examples, an antenna panel 502 may have a different phase of antenna radiation from another antenna panel 504. In some scenarios, a set of antenna elements having a phase of antenna radiation may be a separate antenna panel from another set of antenna elements having a different phase of antenna radiation. In the example above, the first array of antenna elements 522 in the first antenna panel 502 may have a first phase and amplitude to create a first directional radiation pattern. The second array of antenna elements 524 in the second antenna panel 504 may have a second phase and amplitude to create a second directional radiation pattern. Here, the first directional radiation pattern of the first antenna panel may not be the same as the second directional radiation pattern of the second antenna panel. In this example, the antenna space (D₁₁) 516 or (D₁₂) 520 in the first or second antenna panel 502, 504 might not be necessarily different from the panel space (D₂) 518 between the first 502 and second antenna panels 504.

In some examples, an antenna panel may have N₁ antenna elements 512 in the horizontal domain and N₂ antenna elements 514 in the vertical domain. Each of N_{g} (510) multiple antenna panels may have the same antenna configuration as each other. The values N_{g}, N₁, and N₂ may be configured with higher-layer parameters. The example of FIG. 5 shows that the number of antenna panels (N_{g}) is 2, the number of antenna elements in the horizontal domain (N₁) is 4, and the number of antenna elements in the vertical domain (N₂) is 2. Due to two cross-polarizations, the total number of ports in the multi-panel antenna array of FIG. 5 is 32 (i.e., 2 (cross polarizations)×2(N_{g})×4(N₁)×2(N₂)). Table 1 below shows possible configurations of (N_{g}, N₁, N₂) and (O₁, O₂). O₁ and O₂ are horizontal and vertical oversampling factors in horizontal and vertical domains, respectively. In some examples, oversampling factors (O₁, O₂) along with horizontal and vertical beam spacing values for different layers (k₁, k₂) may determine a PMI index (i_{1,3}) indicating beam spacing between columns of a codebook for different layers or ranks.

TABLE 1
Configuration of (N₁, N₂) and (O₁, O₂) antenna

| Number of CSI-RS antenna ports | (N_{g}, N₁, N₂) | (O₁, O₂) |
|---|---|---|
| 8 | (2, 2, 1) | (4, 1) |
| 26 | (2, 4, 1) | (4, 1) |
| | (4, 2, 1) | (4, 1) |
| | (2, 2, 2) | (4, 4) |
| 32 | (2, 8, 1) | (4, 1) |
| | (4, 4, 1) | (4, 1) |
| | (2, 4, 2) | (4, 4) |
| | (4, 2, 2) | (4, 4) |

A scheduled entity may select a preferred precoding matrix in a multi-panel codebook based on the number of antenna panels, the number of antenna elements in horizontal and vertical domains, oversampling factors, and/or any other suitable parameter. A multi-panel codebook may include multiple single-panel codebooks with one or more co-phasing values between multiple antenna panels. A single-panel codebook for an antenna panel 502 may be given by

$$\\ \frac{1}{\sqrt{{P}_{CSI - RS} / {N}_{g}}} [ \begin{matrix}{v}_{l , m} \\ {φ}_{n} {v}_{l , m}\end{matrix} ] .$$

The quantities of P_{CSI-RS}, φₙ, uₘ, and v_{l,m} are given by

$$\\ {P}_{CSI - RS} = 2 {N}_{g} {N}_{1} {N}_{2} , {φ}_{n} = {e}^{{}_{} j π n / 2}$$

$$\\ {u}_{m} = \{ \begin{matrix}[ 1 {e}^{{}_{} j \frac{2 π m}{{O}_{2} {N}_{2}}} … {e}^{{}_{} j \frac{2 π m ( {N}_{{2}_{}} - 1 )}{{O}_{2} {N}_{2}}} ] ← {N}_{2} > 1 \\ 1 ← {N}_{2} = 1\end{matrix} \} , and$$

$$\\ {v}_{l , m} = {[ {u}_{m} {e}^{{}_{} j \frac{2 π l}{{O}_{1} {N}_{1}}} {u}_{m} … {e}^{{}_{} j \frac{2 π l ( {N}_{{1}_{}} - 1 )}{{O}_{1} {N}_{1}}} {u}_{m} ]}^{T} .$$

Here, P_{CSI-RS} is the number of CSI-RS ports, v_{l,m} is a precoding vector or a component vector, φₙ is a co-phasing value 506 for cross-polarizations of an antenna element 522, l is a horizontal beam index, m is a vertical beam index, and n is a cross-polarization index. For example, an antenna panel 502 in the example of FIG. 5 may have 8 antenna elements 522 (e.g., 4 horizontal antenna elements and 2 vertical antenna elements). Thus, 8 component vectors (v_{l,m}) and 8 component vectors with a co-phasing value (φₙv_{l,m}) may exist for 8 antenna elements 522.

Based on the single-panel codebook with one or more co-phasing values 508 (θₚ_{₁}, θₚ_{₂}, and/or θₚ_{₃}) between multiple antenna panels, a scheduled entity may configure a multi-panel codebook. In some examples for two antenna panels, a multi-panel codebook (W_{l,m,p,n}^{1,2,1}, or W_{l,m,p,n}^{2,2,1}) may be given by

$$\\ {W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {θ}_{{p}_{1}} {v}_{l , m} \\ {θ}_{{p}_{1}} {φ}_{n} {v}_{l , m}\end{matrix} ] , or {W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {θ}_{{p}_{1}} {v}_{l , m} \\ - {θ}_{{p}_{1}} {φ}_{n} {v}_{l , m}\end{matrix} ] .$$

Here, θₚ_{₁} is a co-phasing value 508 between two antenna panels 502 and 504. Other indexes may be the same as those for a single antenna panel. In addition, the superscripts (x, y, z) in the codebook (W_{l,m,p,n}^{x,y,z}) may indicate that x is a codebook index, y is the number of antenna panels, and z is a codebook mode. Also, the subscripts (l, m, p, n) in a codebook (W_{l,m,p,n}^{x,y,z}) indicate that l is a horizontal beam index, m is a vertical beam index, p is a panel co-phasing index, and n is a cross-polarization index.

$$\\ \frac{1}{\sqrt{{P}_{CSI - RS}}}$$

indicates that the power is normalized for a unit power. Thus, the codebook for two antenna panels may include two single-panel codebooks with a panel co-phasing value (θₚ_{₁}) 508. One codebook may be given by

$$\\ [ \begin{matrix}{v}_{l , m} \\ {φ}_{n} {v}_{l , m}\end{matrix} ] and [ \begin{matrix}{v}_{l , m} \\ - {φ}_{n} {v}_{l , m}\end{matrix} ] .$$

In some examples, two codebooks may make two orthogonal columns with a beam vector when the rank is equal to or higher than rank 2. Another codebook is the same codebook with a co-phasing value (φₚ_{₁}) 508. The scheduled entity may stack or align vertically two codebooks for two antenna panels 502 and 504.

In other examples for four antenna panels, multi-panel codebooks (W_{l,m,p,n}^{1,4,1}, and (W_{l,m,p,n}^{2,4,1}) may be given by

$$\\ {W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {θ}_{{p}_{1}} {v}_{l , m} \\ {θ}_{{p}_{1}} {φ}_{n} {v}_{l , m} \\ {θ}_{{p}_{2}} {v}_{l , m} \\ {θ}_{{p}_{2}} {φ}_{n} {v}_{l , m} \\ {θ}_{{p}_{3}} {v}_{l , m} \\ {θ}_{{p}_{3}} {φ}_{n} {v}_{l , m}\end{matrix} ] , and {W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {θ}_{{p}_{1}} {v}_{l , m} \\ - {θ}_{{p}_{1}} {φ}_{n} {v}_{l , m} \\ {θ}_{{p}_{2}} {v}_{l , m} \\ - {θ}_{{p}_{2}} {φ}_{n} {v}_{l , m} \\ {θ}_{{p}_{3}} {v}_{l , m} \\ - {θ}_{{p}_{3}} {φ}_{n} {v}_{l , m}\end{matrix} ] .$$

Here, θₚ_{₁}, θₚ_{₂}, and θₚ_{₃} are co-phasing values for two antenna panels among four antenna panels. For example, among four antenna panels (e.g., panel 1, panel 2, panel 3, and panel 4), co-phasing value 1 may be between panel 1 and panel 2, co-phasing value 2 may be between panel 1 and panel 3, and co-phasing value 3 may be between panel 1 and panel 4. Other indexes may be the same as those for two antenna panels. Thus, the codebook for four antenna panels may include four single-panel codebooks with panel co-phasing values aligned vertically. The four codebooks share the same codebook

$$\\ ( [ \begin{matrix}{v}_{l , m} \\ {φ}_{n} {v}_{l , m}\end{matrix} ] and [ \begin{matrix}{v}_{l , m} \\ - {φ}_{n} {v}_{l , m}\end{matrix} ] )$$

and include three co-phasing values (θₚ_{₁}, θₚ_{₂}, and θₚ_{₃}).

### Multi-Panel Codebook Design

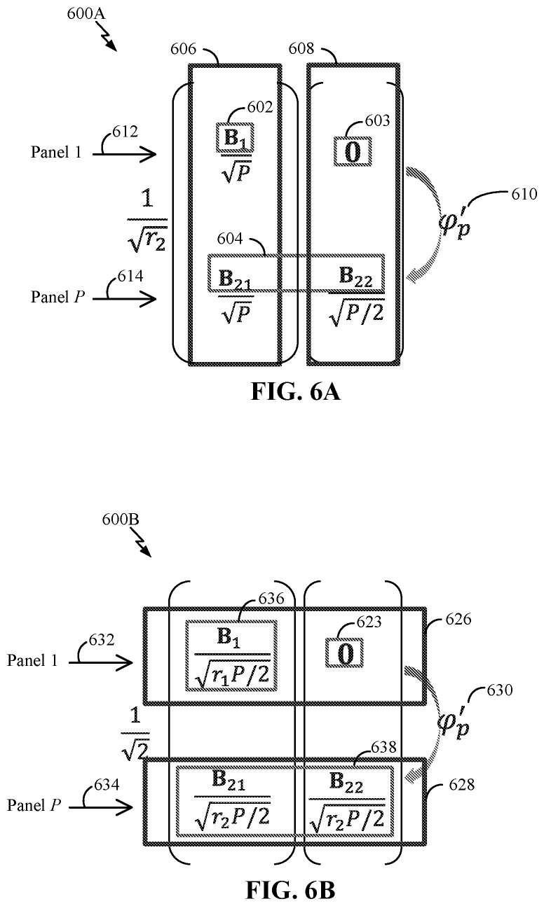

FIGS. 6A and 6B illustrate examples of codebooks 600A and 600B for multiple antenna panels having different ranks. In some examples, considering different antenna configurations and various MIMO channel environments, different ranks between different antenna panels may improve system performance and system flexibility. In addition, for multiple antenna panels, the current specifications do not support more than rank 4 MIMO transmission. However, as a large number of receive antennas are being considered to be included in mobile devices and other devices such as personal laptops and customer-premises equipment are utilizing 5G technologies, more than rank 4 MIMO transmission is becoming possible. This disclosure provides new codebook designs supporting different ranks and/or antenna ports between different antenna panels. Thus, the new codebook designs may increase flexibility with moderate PMI feedback overhead.

In some examples, a scheduled entity may configure a codebook 600A, 600B supporting different ranks for different antenna panels in accordance with some aspects of the present disclosure. The scheduled entity may stack or align vertically component codebooks 602, 604 for corresponding multiple antenna panels. The component precoders 602, 604 may have different numbers of orthogonal columns 606, 608, 636, 638 corresponding multiple ranks. In some examples, since the distance between a scheduling entity and a scheduled entity is generally much longer than the panel distance, cases having a rank combination with a big difference (e.g., more than 1) between ranks for antenna panels might not be common. Thus, considering the cost for PMI overhead and the possibility of having a rank combination having a big difference between ranks for multiple antenna panels, the rank difference may be practically limited to a maximum of 1 (e.g., |r₁−r₂|≤1). In further examples, for an antenna panel with a lower rank than another rank of another antenna panel, the scheduled entity may additionally include a zero matrix 603 in a row corresponding to the antenna panel with the lower rank in the codebook. Considering the PMI overhead, the position of the zero matrix 603 may be at the first column or at the last column of the codebook. In some examples, the zero matrix 603 may include multiple zero entries corresponding to the number of cross polarizations of an antenna element (e.g., a P/Ng-tuple zero vector

$$\\ [ \begin{matrix}0 \\ 0\end{matrix} ] )$$

in a component precoder for the same antenna panel. In other examples, the zero matrix (0) may be an N-tuple zero vector, where N is the total number of CSI-RS ports (P) divided by the total number of antenna panels. A component precoder 604 corresponding to an antenna panel may be the same precoder with another component precoder 602 in the codebook 600A other than a co-phasing value (θₚ′) 610 between multiple antenna panels. After stacking component precoders 602, 604, the scheduled entity may exploit one of two different power normalization methods. One method is to scale the power to make the same column power or to make the precoder a scaled unitary matrix, further described in FIGS. 6A and 7-9. The other method is to scale the power to make the same row power or to make the equal power for different antenna panels. In some examples, different antenna panels with different numbers of antenna ports may use a codebook with the same row power method, further described in FIGS. 6B and 10-12.

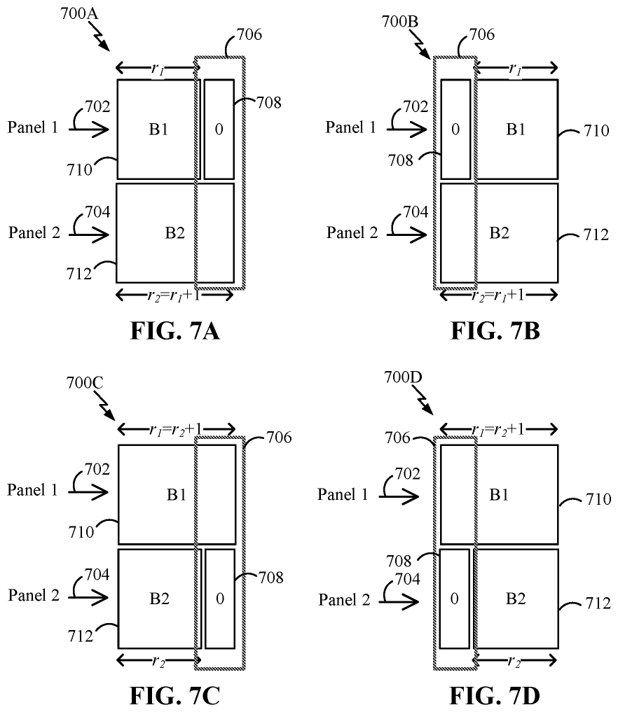

FIG. 6A illustrates an example of a codebook 600A for multiple antenna panels having different ranks with an equal column power in accordance with some aspects of the present disclosure. The equal column power may indicate that a component vector 606, 608 or a column of a codebook 600A is normalized to have a unit norm. That is, each layer 606, 608 corresponding to a column 606, 608 of a codebook 600A has the same power. The codebook may include multiple rows corresponding to multiple antenna panels 612, 614 and multiple columns corresponding to multiple ranks 602, 604. The codebook may also include multiple component vectors corresponding to multiple columns of the codebook for the equal column power. In some examples, for an antenna panel 612 corresponding to a rank 602 lower than another rank 604 of another antenna panel 614, the scheduled entity may additionally include a zero matrix 603 in a row corresponding to the antenna panel 612 in the codebook 600A. For example, the zero matrix 603 may include an N-tuple zero vector, where N is the total number of CSI-RS ports (P) divided by the total number of antenna panels. FIGS. 7A-7D, 8A-8F, and 9 further describe exemplary codebooks and CSI reporting for the equal column power.

FIG. 6B illustrates an example of a codebook 600B for multiple antenna panels having different ranks with an equal row power in accordance with some aspects of the present disclosure. The equal row power may indicate that a component vector 626, 628 or a row of a codebook 600B is normalized to have a unit norm. That is, each row 626, 628 of a codebook 600B corresponding to an antenna panel 632. 634 may have the same power. In the equal row power, a component vector 626, 628 may correspond to a row of a codebook 600B while in the equal column power, a component vector 606, 608 may correspond to a column of a codebook 600B. The codebook may include multiple rows corresponding to multiple antenna panels 632. 634 and multiple columns corresponding to multiple ranks 636, 638. Thus, each row 626, 628 may correspond to a single-panel codebook. The codebook may also include multiple component vectors 626, 628 corresponding to multiple rows of the codebook for the equal row power. In some example, for an antenna panel 632 corresponding to a rank 636 less than another rank 638 of another antenna panel 634, the scheduled entity may additionally include a zero matrix 623 in a row 626 corresponding to the antenna panel 632 with the lower rank in the codebook 600B. For example, the zero matrix 623 may include an N-tuple zero vector, where N is the total number of CSI-RS ports (P) divided by the total number of antenna panels. For example, when the total numbers of ports and antenna panels is 8 and 2, respectively, the zero matrix (0) is a 4-tuple zero vector

$$\\ [ \begin{matrix}0 \\ 0 \\ 0 \\ 0\end{matrix} ] .$$

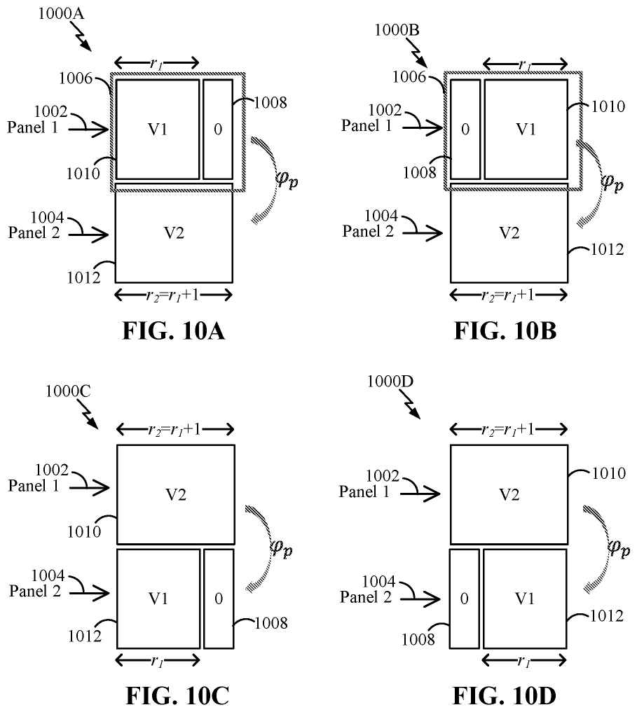

FIGS. 10A-10D, 11A-11F, and 12 further describe exemplary codebooks and CSI reporting with the equal row power.

In some instances, a scheduled entity may configure a codebook using this equal row power for multiple antenna panels having different numbers of antenna ports. In some examples, multiple antenna panels may have the same rank although the antenna panels might have different numbers of antenna ports. In other examples, multiple antenna panels may have different ranks and different numbers of antenna ports for the multiple antenna panels.

### Multi-Panel Codebook With Equal Column Power

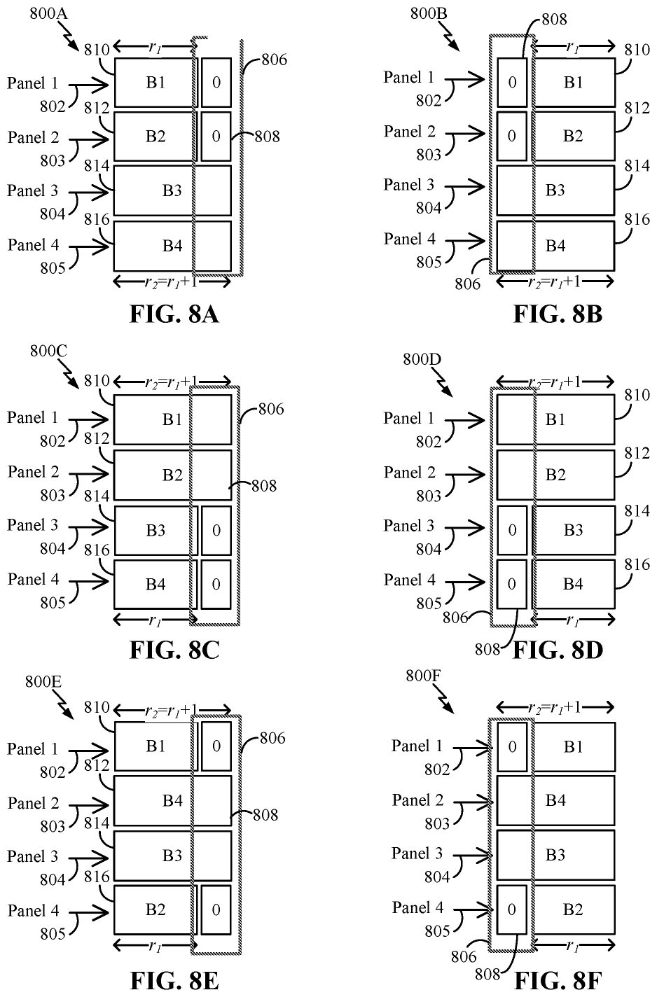

FIGS. 7A-7D and 8A-8F are conceptual illustrations of codebooks 700A-700D and 800A-800F using an equal column power method for multiple antenna panels having different ranks in accordance with some aspects of the present disclosure. As explained above in FIG. 6A, a component vector 606, 608 or a column of a codebook 700A-700D and 800A-800F is normalized to have a unit norm. The scheduled entity may configure a codebook 700A-700D and 800A-800F based on the measured channel quality for multi-panel transmission. The codebook 700A-700D and 800A-800F may include multiple component vectors or columns corresponding to the highest rank of multiple antenna panels. Each entity of a component vector may include a codebook

$$\\ ( e . g . , [ \begin{matrix}{v}_{l , m} \\ {φ}_{n} {v}_{l , m}\end{matrix} ] or [ \begin{matrix}{v}_{l , m} \\ - {φ}_{n} {v}_{l , m}\end{matrix} ] )$$

corresponding to an antenna panel in row and a layer or a rank of the antenna panel in column. Thus, the scheduled entity may configure the codebook by piling or aligning horizontally the multiple component vectors side by side. FIGS. 7A-7D explains two-panel codebook configuration 700A-700D with the equal column power, and FIGS. 8A-8F elaborates four-panel codebook configuration 800A-800F with the equal column power.

### Two-Panel Codebook With Equal Column Power

FIGS. 7A-7D are conceptual illustrations of codebooks 700A-700D using an equal column power method for two antenna panels having different ranks in accordance with some aspects of the present disclosure. For two antenna panels, if every rank for two antenna panels is used, there are 2(R−1) possible combinations of the two panels' ranks (r₁ and r₂) for each overall rank R (max(r₁, r₂)). Then, the total number of possible combinations for 8 ranks (rank 1-rank 8) is 64 (i.e., Σ_{R=1}⁸2(R−1)=64). It might be difficult for a scheduled entity to report a PMI to indicate one of all 64 combinations due to signaling overhead. In addition, the CSI payload size would become too large to indicate one of the whole combinations. Since the distance between a scheduling entity and a scheduled entity is generally much longer than the panel distance, cases having a rank combination with a big difference between ranks for antenna panels would not be common.

Considering the cost for PMI overhead and the possibility of having a rank combination having a big difference between ranks, a rank difference between unequal ranks for two antenna panels may be practically limited to a maximum of 1 (i.e., |r₁−r₂|≤1). For example, for each of ranks 2-8, there are two unequal combinations with a rank difference of one for two antenna panels: Rank R (r₁, r₂)=R (r−1, r), or R (r, r−1) (e.g., Rank 2 (1, 2), (2, 1); Rank 3 (2, 3), (3, 2); Rank 4 (3, 4), (4, 3); Rank 5 (4, 5), (5, 4); Rank 6 (5, 6), (6, 5); Rank 7 (6, 7), (7, 6); and Rank 8 (7, 8), (8, 7)). In some examples, a scheduled entity may configure a codebook 700A-700D for two antenna panels by combining two or more component vectors 706 horizontally. A component vector 706 corresponding to a rank may include two entries corresponding to two antenna panels. Each component vector 706 may be normalized to have the unit norm. That is, each component vector 706 may have the same power (i.e., the equal column power). The total number of component vectors may correspond to the highest rank of ranks for two antenna panels. For example, when two antenna panels correspond to two ranks (r, r−1), the total number of component vectors in a codebook is r. In some examples, a component vector at the first column or the last column may include a zero vector corresponding to an antenna panel with the lowest rank. In some examples, all component vectors 706 for two antenna panels using the equal power column may be given by:

$$\\ {W}_{l , m , p , n}^{1 , 2 , 1} = \frac{1}{\sqrt{P}} [ \begin{matrix}[ \begin{matrix}{v}_{l , m} \\ {φ}_{n} {v}_{l , m}\end{matrix} ] \\ {θ}_{{p}_{1}} [ \begin{matrix}{v}_{l , m} \\ {φ}_{n} {v}_{l , m}\end{matrix} ]\end{matrix} ] , {W}_{l , m , p , n}^{2 , 2 , 1} = \frac{1}{\sqrt{P}} [ \begin{matrix}[ \begin{matrix}{v}_{l , m} \\ - {φ}_{n} {v}_{l , m}\end{matrix} ] \\ {θ}_{{p}_{1}} [ \begin{matrix}{v}_{l , m} \\ - {φ}_{n} {v}_{l , m}\end{matrix} ]\end{matrix} ] ,$$

$$\\ {W}_{l , m , p , n}^{3 , 2 , 1} = \frac{1}{\sqrt{P / 2}} [ \begin{matrix}[ \begin{matrix}{v}_{l , m} \\ {φ}_{n} {v}_{l , m}\end{matrix} ] \\ [ \begin{matrix}0 \\ 0\end{matrix} ]\end{matrix} ] , {W}_{l , m , p , n}^{4 , 2 , 1} = \frac{1}{\sqrt{P / 2}} [ \begin{matrix}[ \begin{matrix}{v}_{l , m} \\ - {φ}_{n} {v}_{l , m}\end{matrix} ] \\ [ \begin{matrix}0 \\ 0\end{matrix} ]\end{matrix} ] ,$$

$$\\ {W}_{l , m , p , n}^{5 , 2 , 1} = \frac{1}{\sqrt{P / 2}} [ \begin{matrix}[ \begin{matrix}0 \\ 0\end{matrix} ] \\ {θ}_{{p}_{1}} [ \begin{matrix}{v}_{l , m} \\ {φ}_{n} {v}_{l , m}\end{matrix} ]\end{matrix} ] , and {W}_{l , m , p , n}^{6 , 2 , 1} = \frac{1}{\sqrt{P / 2}} [ \begin{matrix}[ \begin{matrix}0 \\ 0\end{matrix} ] \\ {θ}_{{p}_{1}} [ \begin{matrix}{v}_{l , m} \\ - {φ}_{n} {v}_{l , m}\end{matrix} ]\end{matrix} ] .$$

Here, the superscripts and subscripts in the codebook (W_{l,m,p,n}^{x,y,z}) may refer to the same definitions provided above. Based on the component vectors 706, a scheduled entity may configure four possible codebooks 700A-700D for an overall rank (R: max (r₁, r₂)) based on a position of the zero matrix 708. For example, a codebook 700A for two antenna panels having corresponding ranks (rank 1 for panel 1 (702) and rank 2 for panel 2 (704)) where a component matrix 706 having a zero matrix 708 is at the last column may be given by:

$$\\ \frac{1}{\sqrt{2}} [ {W}_{l , m , p , n}^{1 , 2 , 1} {W}_{l , m , p , n}^{6 , 2 , 1} ] = \frac{1}{\sqrt{2}} [ \frac{1}{\sqrt{P}} [ \begin{matrix}[ \begin{matrix}{v}_{l , m} \\ {φ}_{n} {v}_{l , m}\end{matrix} ] \\ {θ}_{{p}_{1}} [ \begin{matrix}{v}_{l , m} \\ {φ}_{n} {v}_{l , m}\end{matrix} ]\end{matrix} ] \frac{1}{\sqrt{P / 2}} [ \begin{matrix}[ \begin{matrix}0 \\ 0\end{matrix} ] \\ {θ}_{{p}_{1}} [ \begin{matrix}{v}_{l , m} \\ - {φ}_{n} {v}_{l , m}\end{matrix} ]\end{matrix} ] ] .$$

### Here,

$$\\ \frac{1}{\sqrt{2 P}} [ \begin{matrix}{v}_{l , m} \\ {φ}_{n} {v}_{l , m}\end{matrix} ]$$

is a codebook B1 (710) for panel 1 (702),

$$[ \begin{matrix}0 \\ 0\end{matrix} ]$$

is a zero matrix, and

$$\\ [ \frac{1}{\sqrt{P}} {φ}_{{p}_{1}} [ \begin{matrix}{v}_{l , m} \\ {φ}_{n} {v}_{l , m}\end{matrix} ] \frac{1}{\sqrt{P / 2}} {φ}_{{p}_{1}} [ \begin{matrix}{v}_{l , m} \\ - {φ}_{n} {v}_{l , m}\end{matrix} ] ]$$

is a codebook B2 (712) for panel 2 (704).

In some examples of FIGS. 7A-7D, a scheduled entity may configure a codebook 700A, 700B for two antenna panels with the equal column power. Panel 1 (702) may correspond to a first rank (r₁) while panel 2 (704) may correspond to a second rank (r₂). In FIGS. 7A and 7B, the first rank (r₁) may be one rank lower than the second rank (r₂) (i.e., r₁=r₂−1). In FIGS. 7C and 7D, the first rank (r₁) may be one rank higher than the second rank (r₂) (i.e., r₁=r₂+1). The scheduled entity may configure the codebook 700A-700D by combining two or more component vectors horizontally corresponding to the highest rank among the first (r₁) and send (r₂) ranks. In the combined component vectors, a component vector including a zero matrix 708 may be at the last column 706 of the codebook 700A, 700C or at the first column 706 of the codebook 700B, 700D. The zero matrix 708 may also correspond to a row including the lowest rank among the first (r₁) and send (r₂) ranks.

In FIGS. 7A and 7C, a codebook 700A, 700C may include a component vector including a zero matrix 708 at the last column in the codebook 700A, 700C. The zero matrix 708 may corresponds to an antenna panel having the lowest rank (e.g., panel 1 (702) for the codebook 700A and panel 2 (704) for the codebook 700C). In some examples, the codebook 700A, 700C may include at least one of two component vectors (e.g., W_{l,m,p,n}^{1,2,1} and W_{l,m,p,n}^{2,2,1}) iteratively in an ordered sequence to the lowest rank of two ranks corresponding to two antenna panels for an orthogonal pair with the same beam. For example, when the lowest rank is 1 (e.g., (r₁, r₂)=(1, 2) or (2, 1)), the scheduled entity may place the first component vector of the two component vectors, shown as W_{l,m,p,n}^{1,2,1}. When the lowest rank is 2 (e.g., (r₁, r₂)=(2, 3) or (3, 2)), the scheduled entity may place the two component vectors first, shown as W_{l,m,p,n}^{1,2,1} W_{l,m,p,n}^{2,2,1}. When the lowest rank is 3 (e.g., (r₁, r₂)=(3, 4) or (4, 3)), the scheduled entity may place the two component vectors and the first vector of the two component vectors, shown as W_{l,m,p,n}^{1,2,1} W_{l,m,p,n}^{2,2,1} W_{l′,m′,p,n}^{1,2,1}. When the lowest rank is 4 (e.g., (r₁, r₂)=(4, 5) or (5, 4)), the scheduled entity may place the two component vectors twice, shown as W_{l,m,p,n}^{1,2,1} W_{l,m,p,n}^{2,2,1} W_{l′,m′,p,n}^{1,2,1} W_{l′,m′,p,n}^{2,2,1}.

Then, the scheduled entity may add a component vector including a zero matrix 708 at the last column of the codebook 700A, 700C. The zero matrix may correspond to a row corresponding to an antenna panel having the lowest rank (e.g., panel 1 (702) for a codebook 700A and panel 2 (704) for a codebook 700B) and a column corresponding to the highest rank of two ranks (e.g., r₂ for a codebook 700A and r₁ for a codebook 700B). For example, when a component vector 706 including a zero matrix 708 is next to the first vector (W_{l,m,p,n}^{1,2,1}) of the two iterative component vectors, the component vector including a zero matrix 708 may be W_{l′,m′,p,n}^{6,2,1} for a codebook 700A where the zero matrix 708 corresponds to panel 1 (702) having the lower rank, and W_{l′,m′,p,n}^{4,2,1} for a codebook 700C where the zero matrix 708 corresponds to panel 2 (704) having the lower rank. However, when a component vector including a zero matrix 708 is next to the second vector W_{l,m,p,n}^{2,2,1} of the two iterative component vectors, the component vector including a zero matrix 708 may be W_{l′,m′,p,n}^{5,2,1} for a codebook 700A where the zero matrix 708 corresponds to panel 1 (702) having the lower rank, and W_{l′,m′,p,n}^{3,2,1} for a codebook 700C where the zero matrix 708 corresponds to panel 2 (704) having the lower rank. The combined component vectors may be divided by \sqrt{R} to normalize the total transmit power. This may apply to codebooks for other ranks (e.g., rank 5-rank 8). Here, l′ and m′ may indicate l+k₁ and m+k₂, respectively. k₁ and k₂ may indicate integer multiples of multiples of O₁ and O₂, respectively (e.g., given in Table 2 for overall rank 2 (max(r₁, r₂)) and Table 3 for other ranks). In particular, k₁ may indicate a horizontal beam separation factor for different layers while k₂ may indicate a vertical beam separation factor for different layers. In some examples, the scheduled entity may report beam spacing between columns for different layers or ranks (i_{1,3}) based on beam spacing values k₁ and k₂ and oversampling factors O₁ and O₂. i_{1,3} may indicate the index distance between different beams in a high rank precoder. In some examples, i_{1,3} may be reported with l, m, n, p values.

TABLE 2
Mapping of i_{1, 3} to k₁ and k₁ for overall rank 2

| | | | |
|---|---|---|---|
| N₁ > | | N₁ = ₂, | N₁ > 2, |
| N₂ > 1 | N₁ = N₂ | N₂ = 1 | N₂ = 1 |

| i_{1, 3} | k₁ | k₂ | k₁ | k₂ | k₁ | k₂ | k₁ | k₂ |
|---|---|---|---|---|---|---|---|---|
| 0 | 0 | 0 | 0 | 0 | 0 | 0 | 0 | 0 |
| 1 | O₁ | 0 | O₁ | 0 | O₁ | 0 | O₁ | 0 |
| 2 | 0 | O₂ | 0 | O₂ | | | 2O₁ | 0 |
| 3 | 2O₁ | 0 | O₁ | O₂ | | | 3O₁ | 0 |

TABLE 3
Mapping of i_{1, 3} to k₁ and k₁ for overall rank 3 and 4

| | N₁ = 2, | | N₁ = 4, | | N₁ = 8, | | N₁ = 2, | | N₁ = 4, | |
|---|---|---|---|---|---|---|---|---|---|---|
| | N₂ = 1 | | N₂ = 1 | | N₂ = 1 | | N₂ = 2 | | N₂ = 2 | |
| i_{1, 3} | k₁ | k₂ | k₁ | k₂ | k₁ | k₂ | k₁ | k₂ | k₁ | k₂ |
| 0 | O₁ | 0 | O₁ | 0 | O₁ | 0 | O₁ | 0 | O₁ | 0 |
| 1 | | | 2O₁ | 0 | 2O₁ | 0 | 0 | O₂ | 0 | O₂ |
| 2 | | | 3O₁ | 0 | 3O₁ | 0 | O₁ | O₂ | O₁ | O₂ |
| 3 | | | | | 4O₁ | 0 | | | 2O₁ | 0 |

In connection with primes of subscripts of the codebook (l, m), the number of primes increase every orthogonal pair two component vectors. For example, for the lowest rank 4 (e.g., (r₁, r₂)=(4, 5) or (5, 4)), the codebook may be W_{l,m,p,n}^{x,2,1} W_{l,m,p,n}^{2,2,1} W_{l′,m′,p,n}^{1,2,1} W_{l′,m′,p,n}^{2,2,1} W_{l″,m″,p,n}^{y,2,1}, where x is one of 1, 3, and 5 and y is one of 2, 4, and 6. For the lowest rank 5 (e.g., (r₁, r₂)=(5, 6) or (6, 5)), the codebook may be W_{l,m,p,n}^{x,2,1} W_{l,m,p,n}^{2,2,1} W_{l′,m′,p,n}^{1,2,1} W_{l′,m′,p,n}^{2,2,1} W_{l″,m″,p,n}^{1,2,1} W_{l″,m″,p,n}^{y,2,1}, where x is one of 1, 3, and 5 and y is one of 1, 3, and 5. For the lowest rank 6 (e.g., (r₁, r₂)=(6, 7) or (7, 6)), the codebook may be W_{l,m,p,n}^{x,2,1} W_{l,m,p,n}^{2,2,1} W_{l′,m′,p,n}^{1,2,1} W_{l′,m′,p,n}^{2,2,1} W_{l″,m″,p,n}^{1,2,1} W_{l″,m″,p,n}^{2,2,1} W_{l″,m″,p,n}^{y,2,1}, where x is one of 1, 3, and 5 and y is one of 2, 4, and 6. For the lowest rank 7 (e.g., (r₁, r₂)=(7, 8) or (8, 7)), the codebook may be W_{l,m,p,n}^{x,2,1} W_{l,m,p,n}^{2,2,1} W_{l′,m′,p,n}^{1,2,1} W_{l′,m′,p,n}^{2,2,1} W_{l″,m″,p,n}^{1,2,1} W_{l″,m″,p,n}^{2,2,1} W_{l′″,m′″,p,n}^{1,2,1} W_{l′″,m′″,p,n}^{y,2,1}, where x is one of 1, 3, and 5 and y is one of 1, 3, and 5. Here, l′=l+O₁, m′=m+O₂, l″=l+20₁, m″=m+20₂, l′″=l+30₁, m′″=m+30₂ for rank 5-8.

In FIGS. 7B and 7D, a codebook 700B, 700D may include a component vector including a zero matrix 706 at the first column in the codebook 700B, 700D. The zero matrix 706 corresponds to an antenna panel having the lowest rank (e.g., panel 1 (702) for the codebook 700B and panel 2 (704) for the codebook 700D). The scheduled entity may configure a codebook 700A, 700C for two antenna panels with the equal column power where a zero matrix 706 is at the last column as shown below. The codebook 700B, 700D may include a component vector including a zero matrix 708 at the first column. For example, when panel 1 (e.g., the first row of the codebook) has a lower rank than panel 2 (e.g., the second row of the codebook), the component vector including a zero matrix 708 may be W_{l′,m′,p,n}^{5,2,1} at the first column of a codebook 700B. When panel 2 has a lower rank than panel 1, the component vector including a zero matrix 708 may be W_{l′,m′,p,n}^{3,2,1} at the first column of a codebook 700A.

Then, the scheduled entity may place at least one of two component vectors (e.g., W_{l,m,p,n}^{2,2,1} and W_{l,m,p,n}^{1,2,1}) iteratively next to the component vector 706 including the zero matrix 708 in an ordered sequence to the highest rank of two ranks corresponding to two antenna panels. For example, when the overall rank is 2 (e.g., (r₁, r₂)=(1, 2) or (2, 1)), the codebook 700B, 700D may include the first component vector of the two component vectors W_{l,m,p,n}^{2,2,1} next to the component vector including the zero matrix 708. When the overall rank is 3 (e.g., (r₁, r₂)=(2, 3) or (3,2)), the codebook 700B, 700D may include the two component vectors W_{l,m,p,n}^{2,2,1} W_{l,m,p,n}^{1,2,1} next to the component vector including the zero matrix 708. When the overall rank is 4 (e.g., (r₁, r₂)=(3, 4) or (4,3)), the codebook 700B, 700D may include the two component vectors and the first vector of the two component vectors W_{l,m,p,n}^{2,2,1} W_{l,m,p,n}^{1,2,1} W_{l′,m′,p,n}^{2,2,1} next to the component vector including the zero matrix 708. When the overall rank is 5 (e.g., (r₁, r₂)=(4, 5) or (5.4)), the scheduled entity may place the two component vectors twice W_{l,m,p,n}^{2,2,1} W_{l,m,p,n}^{1,2,1} W_{l′,m′,p,n}^{2,2,1} W_{l′,m′,p,n}^{1,2,1} next to the component vector 706 including the zero matrix 708. The combined component vectors may be divided by VR to normalize the total transmit power. This may apply to codebooks for other ranks (e.g., rank 5-rank 8).

### Four-Panel Codebook With Equal Column Power

FIGS. 8A-8F are conceptual illustrations of codebooks 800A-800F using an equal column power method for four antenna panels having different ranks. For four antenna panels, due to signaling overhead and increased CSI payload size, the rank difference between different antenna panels may be restricted to a maximum of 1 (i.e., |rₘ−rₙ|≤1, where m, n ∈{1, 2, 3, 4}). Further, a scheduled entity may configure a codebook for four antenna panels with different ranks such that two adjacent antenna panels have the same rank (e.g., two adjacent panels having the highest rank). For example, for each of ranks 2-8, there are three unequal combinations with a maximum rank difference of one for four antenna panels: Rank R (r₁, r₂, r₃, r₄)=R (r−1, r−1, r, r), (r−1, r, r, r−1), (r, r, r−1, r−1). In some examples, a scheduled entity may configure a codebook 800A-800F for four antenna panels by combining two or more component vectors 806 horizontally. A component vector 806 may include four entries corresponding to four antenna panels 802, 803, 804, 805. Each component vector 806 may be normalized to have the unit norm. That is, each component vector 806 may have the same power (i.e., the equal column power). The total number of component vectors may correspond to the highest rank of ranks for four antenna panels 802, 803, 804, 805. A component vector 806 at the first column or the last column may include a zero vector 808 corresponding to an antenna panel with the lowest rank. In some examples, all component vectors 806 for four antenna panels using the equal power column may be given by:

$${w}_{l , m , , p , n}^{1 , 4 , 1} = \frac{1}{\sqrt{P}} [ \begin{matrix}[ \begin{matrix}{ν}_{l , m} \\ {φ}_{n} {ν}_{l , m}\end{matrix} ] \\ {θ}_{{p}_{1}} [ \begin{matrix}{ν}_{l , m} \\ {φ}_{n} {ν}_{l , m}\end{matrix} ] \\ {θ}_{{p}_{2}} [ \begin{matrix}{ν}_{l , m} \\ {φ}_{n} {ν}_{l , m}\end{matrix} ] \\ {θ}_{{p}_{3}} [ \begin{matrix}{ν}_{l , m} \\ {φ}_{n} {ν}_{l , m}\end{matrix} ]\end{matrix} ] ,$$

$${w}_{l , m , , p , n}^{2 , 4 , 1} = \frac{1}{\sqrt{P}} [ \begin{matrix}[ \begin{matrix}{ν}_{l , m} \\ - {φ}_{n} {ν}_{l , m}\end{matrix} ] \\ {θ}_{{p}_{1}} [ \begin{matrix}{ν}_{l , m} \\ - {φ}_{n} {ν}_{l , m}\end{matrix} ] \\ {θ}_{{p}_{2}} [ \begin{matrix}{ν}_{l , m} \\ - {φ}_{n} {ν}_{l , m}\end{matrix} ] \\ {θ}_{{p}_{3}} [ \begin{matrix}{ν}_{l , m} \\ - {φ}_{n} {ν}_{l , m}\end{matrix} ]\end{matrix} ] ,$$

$${w}_{l , m , p , n}^{3 , 4 , 1} = \frac{1}{\sqrt{P / 2}} [ \begin{matrix}[ \begin{matrix}{ν}_{l , m} \\ {φ}_{n} {ν}_{l , m}\end{matrix} ] \\ {θ}_{{p}_{1}} [ \begin{matrix}{ν}_{l , m} \\ {φ}_{n} {ν}_{l , m}\end{matrix} ] \\ [ \begin{matrix}0 \\ 0\end{matrix} ] \\ [ \begin{matrix}0 \\ 0\end{matrix} ]\end{matrix} ] ,$$

$${w}_{l , m , p , n}^{4 , 4 , 1} = \frac{1}{\sqrt{P / 2}} [ \begin{matrix}[ \begin{matrix}{ν}_{l , m} \\ - {φ}_{n} {ν}_{l , m}\end{matrix} ] \\ {θ}_{{p}_{1}} [ \begin{matrix}{ν}_{l , m} \\ - {φ}_{n} {ν}_{l , m}\end{matrix} ] \\ [ \begin{matrix}0 \\ 0\end{matrix} ] \\ [ \begin{matrix}0 \\ 0\end{matrix} ]\end{matrix} ] ,$$

$${w}_{l , m , p , n}^{5 , 4 , 1} = \frac{1}{\sqrt{P / 2}} [ \begin{matrix}[ \begin{matrix}0 \\ 0\end{matrix} ] \\ {θ}_{{p}_{1}} [ \begin{matrix}{ν}_{l , m} \\ {φ}_{n} {ν}_{l , m}\end{matrix} ] \\ {θ}_{{p}_{2}} [ \begin{matrix}{ν}_{l , m} \\ {φ}_{n} {ν}_{l , m}\end{matrix} ] \\ [ \begin{matrix}0 \\ 0\end{matrix} ]\end{matrix} ] ,$$

$${w}_{l , m , p , n}^{6 , 4 , 1} = \frac{1}{\sqrt{P / 2}} [ \begin{matrix}[ \begin{matrix}0 \\ 0\end{matrix} ] \\ {θ}_{{p}_{1}} [ \begin{matrix}{ν}_{l , m} \\ - {φ}_{n} {ν}_{l , m}\end{matrix} ] \\ {θ}_{{p}_{2}} [ \begin{matrix}{ν}_{l , m} \\ - {φ}_{n} {ν}_{l , m}\end{matrix} ] \\ [ \begin{matrix}0 \\ 0\end{matrix} ]\end{matrix} ] ,$$

$${w}_{l , m , p , n}^{7 , 4 , 1} = \frac{1}{\sqrt{P / 2}} [ \begin{matrix}[ \begin{matrix}0 \\ 0\end{matrix} ] \\ [ \begin{matrix}0 \\ 0\end{matrix} ] \\ {θ}_{{p}_{2}} [ \begin{matrix}{ν}_{l , m} \\ {φ}_{n} {ν}_{l , m}\end{matrix} ] \\ {θ}_{{p}_{3}} [ \begin{matrix}{ν}_{l , m} \\ {φ}_{n} {ν}_{l , m}\end{matrix} ]\end{matrix} ] , and$$

$${w}_{l , m , p , n}^{8 , 4 , 1} = \frac{1}{\sqrt{P / 2}} [ \begin{matrix}[ \begin{matrix}0 \\ 0\end{matrix} ] \\ [ \begin{matrix}0 \\ 0\end{matrix} ] \\ {θ}_{{p}_{2}} [ \begin{matrix}{ν}_{l , m} \\ - {φ}_{n} {ν}_{l , m}\end{matrix} ] \\ {θ}_{{p}_{3}} [ \begin{matrix}{ν}_{l , m} \\ - {φ}_{n} {ν}_{l , m}\end{matrix} ]\end{matrix} ] .$$

Here, the superscripts and subscripts in the codebook (W_{l,m,p,n}^{x,y,z}) may refer to the same definitions provided above. Based on the component vectors 806, a scheduled entity may configure eight possible codebooks 800A-800F for an overall rank (R: max (r₁, r₂)) based on a position of the zero matrix 808. For example, a codebook 800A for four antenna panels having corresponding ranks (rank 1: panel 1 (802) and panel 2 (803); and rank 2: panel 3 (804) and panel 4 (805)) where a component matrix 806 having a zero matrix 808 is at the last column may be given by:

$$\frac{1}{\sqrt{2}} [ {W}_{l , m , p , ′ n}^{1 , 4 , 1} {W}_{{l}^{′} , {m}^{′} , p , n}^{8 , 4 , 1} ] = \frac{1}{\sqrt{2}} [ \frac{1}{\sqrt{P}} [ \begin{matrix}[ \begin{matrix}{ν}_{l , m} \\ {φ}_{n} {ν}_{l , m}\end{matrix} ] \\ {θ}_{{p}_{1}} [ \begin{matrix}{ν}_{l , m} \\ {φ}_{n} {ν}_{l , m}\end{matrix} ] \\ {θ}_{{p}_{2}} [ \begin{matrix}{ν}_{l , m} \\ {φ}_{n} {ν}_{l , m}\end{matrix} ] \\ {θ}_{{p}_{3}} [ \begin{matrix}{ν}_{l , m} \\ {φ}_{n} {ν}_{l , m}\end{matrix} ]\end{matrix} ] [ \begin{matrix}[ \begin{matrix}0 \\ 0\end{matrix} ] \\ [ \begin{matrix}0 \\ 0\end{matrix} ] \\ {θ}_{{p}_{2}} [ \begin{matrix}{ν}_{l , m} \\ - {φ}_{n} {ν}_{l , m}\end{matrix} ] \\ {θ}_{{p}_{3}} [ \begin{matrix}{ν}_{l , m} \\ - {φ}_{n} {ν}_{l , m}\end{matrix} ]\end{matrix} ] ] .$$

### Here,

$$\frac{1}{\sqrt{2 P}} [ \begin{matrix}{ν}_{l , m} \\ {φ}_{n} {ν}_{l , m}\end{matrix} ]$$

is codebook B1(810) for panel 1 (802),

$$\frac{{ϕ}_{{p}_{1}}}{\sqrt{2 P}} [ \begin{matrix}{ν}_{l , m} \\ {φ}_{n} {ν}_{l , m}\end{matrix} ]$$

is a codebook B2 (812) for panel 2 (803),

$$\frac{{φ}_{{p}_{2}}}{\sqrt{2 P}} [ \begin{matrix}{ν}_{l , m} \\ {φ}_{n} {ν}_{l , m}\end{matrix} ] \frac{{φ}_{{p}_{2}}}{\sqrt{2 P}} [ \begin{matrix}{ν}_{l , m} \\ - {φ}_{n} {ν}_{l , m}\end{matrix} ]$$

is codebook B3 (814) for panel 3 (804),

$$\frac{{φ}_{{p}_{3}}}{\sqrt{2 P}} [ \begin{matrix}{ν}_{l , m} \\ {φ}_{n} {ν}_{l , m}\end{matrix} ] \frac{{φ}_{{p}_{3}}}{\sqrt{P}} [ \begin{matrix}{ν}_{l , m} \\ - {φ}_{n} {ν}_{l , m}\end{matrix} ]$$

is codebook B4 (816) for panel 4 (805), and

$$[ \begin{matrix}0 \\ 0\end{matrix} ]$$

is a zero matrix.

In some examples, a codebook 800A, 800C, 800E having zero matrices 808 at the last column may include at least one of two component vectors (e.g., W_{l,m,p,n}^{1,4,1} and W_{l,m,p,n}^{2,4,1}) iteratively in an ordered sequence to the lowest rank of four ranks corresponding to two antenna panels. Then, the scheduled entity may add a component vector 806 including two zero matrices 808 at the last column corresponding to the highest rank of four ranks. For example, when a component vector 806 including two zero matrices 808 is next to the first vector (W_{l,m,p,n}^{1,4,1}) of the two iterative component vectors (i.g., with ranks 3, 5, or 7), the component vector 806 including two zero matrices 808 may be W_{l′,′m,p,n}^{8,4,1} for a codebook 800A, W_{l′,m′,p,n}^{4,4,1} for a codebook 800C, or W_{l′,m′,p,n}^{6,4,1} for a codebook 800E. However, when a component vector 806 including two zero matrices 808 is next to the second vector (W_{l,m,p,n}^{2,4,1}) of the two iterative component vectors (i.g., with ranks 2, 4, 6, or 8), the component vector 806 including two zero matrices 808 may be W_{l′,m′,p,n}^{7,4,1} for a codebook 800A, W_{l′,m′,p,n}^{3,4,1} for a codebook 800C, or W_{l′,m′,p,n}^{5,4,1} for a codebook 800E. The combined component vectors may be divided by \sqrt{R} to normalize the total transmit power.

In other examples, a codebook 800B, 800D, 800F may have zero matrices 808 at the first column. The scheduled entity may place a component vector 806 including zero matrices 808 in a codebook. The component vector 806 including two zero matrices 808 may be W_{l′,m′,p,n}^{7,4,1} for a codebook 800B, W_{l′,m′,p,n}^{3,4,1} for a codebook 800D, or W_{l′,m′,p,n}^{5,4,1}for a codebook 800F. Then, the scheduled entity may place at least one of two component vectors (e.g., W_{l,m,p,n}^{2,4,1} and W_{l,m,p,n}^{1,4,1}) iteratively next to the component vector 806 including the zero matrices 808 in an ordered sequence to the highest rank of four ranks corresponding to four antenna panels. Thus, when the highest rank is ranks 2, 4, 6, or 8, the last column of the codebook may be W_{l′,m′,p,n}^{2,4,1}, while when the highest rank is ranks 3, 5, or 7, the last column of the codebook may be W_{l′,m′,p,n}^{1,4,1}. The combined component vectors may be divided by \sqrt{R} to normalize the total transmit power.

### CSI Reporting for Multi-Panel Codebook With Equal Column Power

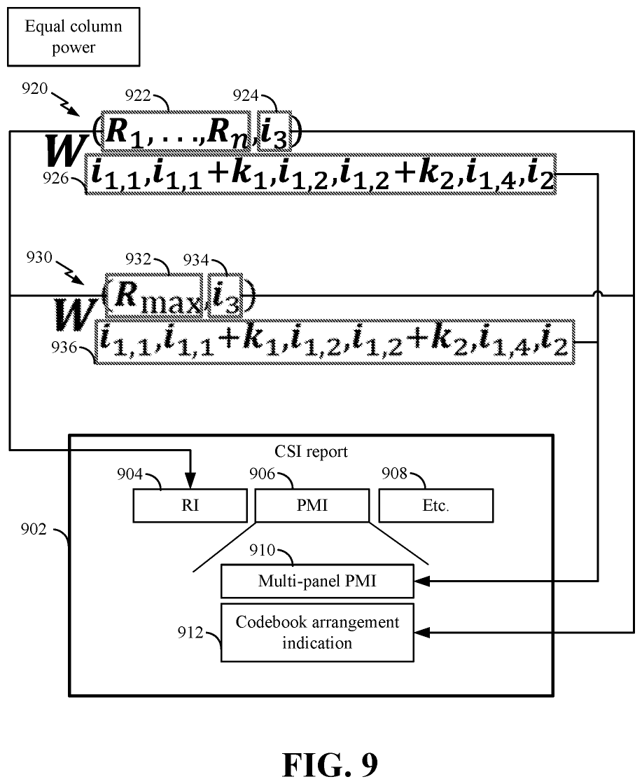

FIG. 9 illustrates examples for CSI reporting for a multi-panel codebook using the equal column power in accordance with some aspects of the present disclosure. Based on a configured codebook of FIGS. 7A-7D and 8A-8F, the scheduled entity may determine a preferred rank 904 and a preferred PMI 906 in the configured codebook based on an estimated channel of a CSI-RS. The scheduled entity further transmit a CSI report 902 including the RI 904 and the PMI 906 to a scheduling entity. An RI 904 of the CSI report may include 1) all preferred ranks 922 corresponding to multiple antenna panels or 2) a general rank or the highest rank 932 among the all preferred ranks corresponding to multiple antenna panels. The scheduled entity may determine a codebook arrangement indicator (i₃) 924 or 934 in the PMI 906 based on the types 922 or 932 of RI 904 and a position of a zero matrix in a codebook 920, 930.

### CSI Reporting for Two-Panel Codebook With Equal Column Power

In some examples for reporting all ranks 922 corresponding to two antenna panels, a codebook arrangement indicator (i₃) 924 may indicate a position (e.g., the first or last column and a row corresponding to an antenna panel with the lowest rank in a codebook 920) of a zero matrix. Thus, the scheduled entity may transmit a CSI report 902 including an RI 904 that indicates all ranks 922 corresponding to two antenna panels and a PMI 906 including a codebook arrangement indicator (i₃) indicating whether a zero matrix corresponding to an antenna panel having the lowest rank is at the first column or the last column of a codebook 920. The PMI 906 may further include scheduled entity's preferred values for a multi-panel PMI 910 (e.g., i_{1,1}, i_{1,1}+k₁, i_{1,2}, i_{1,2}30 k₂, i_{1,4}, and i₂). Exemplary codebooks with codebook mode 700A-700D using the equal column power for two-panel CSI reporting may be given as follows in Tables 4-9. Component vectors in the exemplary codebooks in Tables 14-9 may be the same as those described in the two-panel codebook with the equal column power above.

TABLE 4
Codebook for overall rank 2 CSI reporting when (r₁, r₂) = (1, 2)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(1,2,i}^{₃}⁾ |

where
${W}_{l , {l}^{′} , m , {m}^{′} , p , n}^{( 1 , 2 , 0 )} = \frac{1}{\sqrt{2}} [ \begin{matrix}{W}_{l , m , p , n}^{1 , 2 , 1} & {W}_{{l}^{′} , {m}^{′} , p , n}^{6 , 2 , 1}\end{matrix} ] or {W}_{l , {l}^{′} , m , {m}^{′} , p , n}^{( 1 , 2 , 1 )} = \frac{1}{\sqrt{2}} [ \begin{matrix}{W}_{l , m , p , n}^{5 , 2 , 1} & {W}_{{l}^{′} , {m}^{′} , p , n}^{2 , 2 , 1}\end{matrix} ] ,$ and k₁ and k₂ is integer multiples of O₁ and O₂, respectively, e.g., given in Table 2 above.

Here, subscripts (l, l′, m, m′, p, n) in the codebook W_{l,l′,m,m′,p,n}^{(x,y,z)} may indicate that l is i_{1,1}, l′is i_{1,1}+k₁, m is i_{1,2}, m′is i_{1,2}+k₂, p is i_{1,4}, and n is i₂. Here, i_{1,4} may include i_{1,4,q} (q=1, . . . , N_{g}−1) and indicate an antenna panel co-phasing indicator, and i₂ may indicate cross-polarization co-phasing indicator. The definitions for other parameters may be the same as those in the above in the disclosure. A scheduled entity may select preferred values for i_{1,1}, i_{1,1}+k₁, i_{1,2}, i_{1,2}+k₂, i_{1,4}, and i₂ and report the preferred values as a multi-panel PMI 910 in a PMI 906. The superscripts (x, y, z) in the codebook W_{l,l′,m,m′,p,n}^{(x,y,z)} may indicate that x is the scheduled entity's preferred rank (r₁) of panel 1 (702), y is another scheduled entity's preferred rank (r₂) of panel 2 (704), and z is a codebook arrangement indicator (i₃) for indicating a position of the zero matrix in the codebook. For example, when i₃ is 0, a zero matrix corresponding to an antenna panel having the lowest rank is at the last column of the codebook. On the other than, when i₃ is 1, a zero matrix corresponding to an antenna panel having the lowest rank is at the first column of the codebook. Since all scheduled entity's preferred ranks corresponding to all antenna panels may be reported in an RI 904 of a CSI report 902, the codebook arrangement indicator (i₃) 924 for two antenna panels may just select one of two codebooks depending on whether a zero matrix is at the first column or the last column of the codebook. The explanation of the RI 904 and PMI 906 including the codebook arrangement indicator (i₃) 912 and the multi-panel PMI 910 may be applicable to other examples of codebooks for CSI reporting in Tables 5-9 below.

TABLE 5
Codebook for overall rank 2 CSI reporting when (r₁, r₂) = (2, 1)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(2,1,i}^{₃}⁾ |

where
${W}_{l , {l}^{′} , m , {m}^{′} , p , n}^{( 2 , 1 , 0 )} = \frac{1}{\sqrt{2}} [ \begin{matrix}{W}_{l , m , p , n}^{1 , 2 , 1} & {W}_{{l}^{′} , {m}^{′} , p , n}^{4 , 2 , 1}\end{matrix} ] or {W}_{l , {l}^{′} , m , {m}^{′} , p , n}^{( 2 , 1 , 1 )} = \frac{1}{\sqrt{2}} [ \begin{matrix}{W}_{l , m , p , n}^{3 , 2 , 1} & {W}_{{l}^{′} , {m}^{′} , p , n}^{2 , 2 , 1}\end{matrix} ] ,$ and k₁ and k₂ is integer multiples of O₁ and O₂, respectively, e.g., given in Table 2 above.

TABLE 6
Codebook for overall rank 3 CSI reporting when (r₁, r₂) = (2, 3)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(2,3,i}^{₃}⁾ |

where
$w here {W}_{l , {l}^{′} , m , {m}^{′} , p , n}^{( 2 , 3 , 0 )} = \frac{1}{\sqrt{3}} [ \begin{matrix}{W}_{l , m , p , n}^{1 , 2 , 1} & {W}_{l , m , p , n}^{2 , 2 , 1} & {W}_{{l}^{′} , {m}^{′} , p , n}^{5 , 2 , 1}\end{matrix} ] or$ ${W}_{l , {l}^{′} , m , {m}^{′} , p , n}^{( 2 , 3 , 1 )} = \frac{1}{\sqrt{3}} [ \begin{matrix}{W}_{l , m , p , n}^{5 , 2 , 1} & {W}_{l , m , p , n}^{2 , 2 , 1} & {W}_{{l}^{′} , {m}^{′} , p , n}^{2 , 2 , 1}\end{matrix} ] ,$ and k₁ and k₂ is integer multiples of O₁ and O₂, respectively, e.g., given in Table 3 above.

TABLE 7
Codebook for overall rank 3 CSI reporting when (r₁, r₂) = (3, 2)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(3,2,i}^{₃}⁾ |

where
$w here {W}_{l , {l}^{′} , m , {m}^{′} , p , n}^{( 3 , 2 , 0 )} = \frac{1}{\sqrt{3}} [ \begin{matrix}{W}_{l , m , p , n}^{1 , 2 , 1} & {W}_{l , m , p , n}^{2 , 2 , 1} & {W}_{{l}^{′} , {m}^{′} , p , n}^{3 , 2 , 1}\end{matrix} ] or$ ${W}_{l , {l}^{′} , m , {m}^{′} , p , n}^{( 3 , 2 , 1 )} = \frac{1}{\sqrt{3}} [ \begin{matrix}{W}_{l , m , p , n}^{3 , 2 , 1} & {W}_{l , m , p , n}^{2 , 2 , 1} & {W}_{{l}^{′} , {m}^{′} , p , n}^{1 , 2 , 1}\end{matrix} ] ,$ and k₁ and k₂ is integer multiples of O₁ and O₂, respectively, e.g., given in Table 3 above.

TABLE 8
Codebook for overall rank 4 CSI reporting when (r₁, r₂) = (3, 4)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(3,4,i}^{₃}⁾ |

where
$w here {W}_{l , {l}^{′} , m , {m}^{′} , p , n}^{( 3 , 4 , 0 )} = \frac{1}{\sqrt{4}} [ \begin{matrix}{W}_{l , m , p , n}^{1 , 2 , 1} & {W}_{l , m , p , n}^{2 , 2 , 1} & {W}_{{l}^{′} , {m}^{′} , p , n}^{1 , 2 , 1} & {W}_{{l}^{′} , {m}^{′} , p , n}^{6 , 2 , 1}\end{matrix} ] or$ ${W}_{l , {l}^{′} , m , {m}^{′} , p , n}^{( 3 , 4 , 1 )} = \frac{1}{\sqrt{4}} [ \begin{matrix}{W}_{l , m , p , n}^{5 , 2 , 1} & {W}_{l , m , p , n}^{2 , 2 , 1} & {W}_{{l}^{′} , {m}^{′} , p , n}^{1 , 2 , 1} & {W}_{{l}^{′} , {m}^{′} , p , n}^{2 , 2 , 1}\end{matrix} ] ,$ and k₁ and k₂ is integer multiples of O₁ and O₂, respectively, e.g., given in Table 3 above.

TABLE 9
Codebook for overall rank 4 CSI reporting when (r₁, r₂) = (4, 3)
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(2,i}^{₃}⁾ |

where
$w here {W}_{l , {l}^{′} , m , {m}^{′} , p , n}^{( 4 , 3 , 0 )} = \frac{1}{\sqrt{4}} [ \begin{matrix}{W}_{l , m , p , n}^{1 , 2 , 1} & {W}_{l , m , p , n}^{2 , 2 , 1} & {W}_{{l}^{′} , {m}^{′} , p , n}^{1 , 2 , 1} & {W}_{{l}^{′} , {m}^{′} , p , n}^{4 , 2 , 1}\end{matrix} ] or$ ${W}_{l , {l}^{′} , m , {m}^{′} , p , n}^{( 4 , 3 , 1 )} = \frac{1}{\sqrt{4}} [ \begin{matrix}{W}_{l , m , p , n}^{3 , 2 , 1} & {W}_{l , m , p , n}^{2 , 2 , 1} & {W}_{{l}^{′} , {m}^{′} , p , n}^{1 , {N}_{g} , 1} & {W}_{{l}^{′} , {m}^{′} , p , n}^{2 , 2 , 1}\end{matrix} ] ,$ and k₁ and k₂ is integer multiples of O₁ and O₂, respectively, e.g., given in Table 3 above.

The scheduled entity may configure a CSI report of other codebooks for rank 5-rank 8 using this method.

In other examples, the scheduled entity may report the highest rank of two ranks corresponding to two antenna panels. When an RI includes the highest rank 932 of all ranks corresponding to two antenna panels, a codebook arrangement indicator (i₃) 934 may indicate a position of the zero matrix in the codebook 930 and two ranks for two antenna panels of a codebook 930. Unlike reporting all ranks in an RI, the RI does not indicate a row that corresponds to a zero matrix in reporting the highest rank. Thus, a codebook arrangement indicator (i₃) 934 may indicate one of five possible codebooks (e.g., two codebooks for (R, R−1), two codebooks for (R−1, R), and one codebook for (R, R)). Thus, the scheduled entity may transmit a CSI report 902 including an RI 904 that indicates the highest rank 932 of ranks corresponding to antenna panels and a PMI 906 including a codebook arrangement indicator (i₃) 934 indicating a position of a zero matrix corresponding to an antenna panel having the lowest rank and all ranks corresponding to antenna panels. The PMI 906 may further include scheduled entity's preferred values for a multi-panel PMI 910 (e.g., i_{1,1}, i_{1,1}+k₁, i_{1,2}, i_{1,2}+k₂, i_{1,4}, and i₂) (936). For reporting the highest rank in an RI, exemplary codebooks 700A-700D using the equal column power for two-panel CSI reporting may be given as follows in Table 10.

TABLE 10
Codebook for overall rank 2 CSI reporting when the highest rank is 2
N_{g} = 2

| i_{1,1} | i_{1,2} | i_{1,4,1} | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(2,i}^{₃}⁾ |

where
${W}_{{i}_{1 , 1} , {i}_{1 , 1} + {k}_{1} , {i}_{1 , 2} , {i}_{1 , 2} + {k}_{2} , {i}_{1 , 4} , {i}_{2}}^{( 2 , {i}_{3} )}$ ${W}_{l , {l}^{′} , m , {m}^{′} , p , n}^{( 2 , 0 )} = \frac{1}{\sqrt{2}} [ \begin{matrix}{W}_{l , m , p , n}^{1 , 2 , 1} & {W}_{{l}^{′} , {m}^{′} , p , n}^{4 , 2 , 1}\end{matrix} ] , {W}_{l , {l}^{′} , m , {m}^{′} , p , n}^{( 2 , 1 )} = \frac{1}{\sqrt{2}} [ \begin{matrix}{W}_{l , m , p , n}^{3 , 2 , 1} & {W}_{{l}^{′} , {m}^{′} , p , n}^{2 , 2 , 1}\end{matrix} ]$ ${W}_{l , {l}^{′} , m , {m}^{′} , p , n}^{( 2 , 2 )} = \frac{1}{\sqrt{2}} [ \begin{matrix}{W}_{l , m , p , n}^{1 , 2 , 1} & {W}_{{l}^{′} , {m}^{′} , p , n}^{6 , 2 , 1}\end{matrix} ] , {W}_{l , {l}^{′} , m , {m}^{′} , p , n}^{( 2 , 3 )} = \frac{1}{\sqrt{2}} [ \begin{matrix}{W}_{l , m , p , n}^{5 , 2 , 1} & {W}_{{l}^{′} , {m}^{′} , p , n}^{2 , 2 , 1}\end{matrix} ] , or$ ${W}_{l , {l}^{′} , m , {m}^{′} , p , n}^{( 2 , 4 )} = \frac{1}{\sqrt{2}} [ \begin{matrix}{W}_{l , m , p , n}^{1 , 2 , 1} & {W}_{{l}^{′} , {m}^{′} , p , n}^{2 , 2 , 1}\end{matrix} ] ;$ and k₁ and k₂ is integer multiples of O₁ and O₂, respectively, e.g., given in Table 2 above.

Here, the RI may include the highest rank 2 among two ranks corresponding to two antenna panels. The PMI may include a codebook arrangement indicator (i₃) which choose one codebook among 5 possible codebooks (e.g, W^{(2,0)}, W^{(2,1)}, W^{(2,2)}, W^{(2,3)}, W^{(2,4)}) based on a position of a zero matrix and all ranks for two antenna panels. When i₃ is 0, the codebook may indicate rank 2 corresponds to panel 1, rank 1 corresponds to panel 2 (i.e., (r₁, r₂)=(2, 1)), and a zero matrix corresponding to panel 2 having the lowest rank is at the last column of the codebook. When i₃ is 1, the codebook may indicate rank 2 corresponds to panel 1, rank 1 corresponds to panel 2 (i.e., (r₁, r₂)=(2, 1)), and a zero matrix corresponding to panel 2 having the lowest rank is at the first column of the codebook. When i₃ is 2, the codebook may indicate that rank 1 corresponds to panel 1, rank 2 corresponds to panel 2 (i.e., (r₁, r₂)=(1,2)), and a zero matrix corresponding to panel 1 having the lowest rank is at the last column of the codebook. When i₃ is 3, the codebook may indicate that rank 1 corresponds to panel 1, rank 2 corresponds to panel 2 (i.e., (r₁, r₂)=(1,2)), and a zero matrix corresponding to panel 1 having the lowest rank is at the first column of the codebook. Finally, when i₃ is 4, the codebook may indicate that rank 2 corresponds to panels 1 and 2 (i.e., (r₁, r₂)=(2, 2)). The scheduled entity may configure a CSI report of other codebooks for the highest rank 3-rank 8 using this method.

### CSI Reporting for Four-Panel Codebook With Equal Column Power

In some examples, based on a configured codebook of FIGS. 8A-8F for four antenna panels, the scheduled entity may configure a CSI report 902 to be transmitted to a scheduling entity. An RI 904 of the CSI report may include 1) all preferred ranks 922 corresponding to four antenna panels or 2) a general rank or the highest rank 932 among the all preferred ranks corresponding to four antenna panels. The scheduled entity may determine a codebook arrangement indicator (i₃) 924 or 934 in a PMI 906 based on the types 922 or 932 of RI 904.

In some examples for reporting all ranks 922 corresponding to four antenna panels, a codebook arrangement indicator (i₃) 924 may indicate a position of a zero matrix corresponding to an antenna panel with the lowest rank. Thus, the scheduled entity may transmit a CSI report 902 including an RI 904 that indicates all four ranks 922 corresponding to all four antenna panels and a PMI 906 including a codebook arrangement indicator (i₃) indicating whether two zero matrices corresponding to two antenna panels having the lowest rank is at the first column or the last column of a codebook 920. The PMI 906 may further include scheduled entity's preferred values for a multi-panel PMI 910 (e.g., i_{1,1}, i_{1,1}+k₁, i_{1,2}, i_{1,2}+k₂, i_{1,4}, and i₂). Exemplary codebooks 900A-900F using the equal column power for four-panel CSI reporting may be given as follows in Tables 11-13. Component vectors in the exemplary codebooks in Tables 11-13 may be the same as those described in the four-panel codebook with the equal column power above.

TABLE 11
Codebook for overall rank 2 when (r₁, r₂, r₃, r₄) = (1, 1, 2, 2)
N_{g} = 4

| i_{1,1} | i_{1,2} | i_{1,4,q}, q = 1, 2, 3 | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(1,1,2,2,i}^{₃}⁾ |

where
${W}_{l , {l}^{′} , m , {m}^{′} , p , n}^{( 1 , 1 , 2 , 2 , 0 )} = \frac{1}{\sqrt{2}} [ \begin{matrix}{W}_{l , m , p , n}^{1 , 4 , 1} & {W}_{{l}^{′} , {m}^{′} , p , n}^{8 , 4 , 1}\end{matrix} ] , {W}_{l , {l}^{′} , m , {m}^{′} , p , n}^{( 1 , 1 , 2 , 2 , 1 )} = \frac{1}{\sqrt{2}} [ \begin{matrix}{W}_{l , m , p , n}^{7 , 4 , 1} & {W}_{{l}^{′} , {m}^{′} , p , n}^{2 , 4 , 1}\end{matrix} ] ,$ and k₁ and k₂ is integer multiples of O₁ and O₂, respectively, e.g., given in Table 2 above.

TABLE 12
Codebook for overall rank 2 when (r₁, r₂, r₃, r₄) = (1, 2, 2, 1)
N_{g} = 4

| i_{1,1} | i_{1,2} | i_{1,4,q}, q = 1, 2, 3 | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(1,2,2,1,i}^{₃}⁾ |

where
${W}_{l , {l}^{′} , m , {m}^{′} , p , n}^{( 1 , 2 , 2 , 1 , 0 )} = \frac{1}{\sqrt{2}} [ \begin{matrix}{W}_{l , m , p , n}^{1 , {N}_{g} , 1} & {W}_{{l}^{′} , {m}^{′} , p , n}^{6 , {N}_{g} , 1}\end{matrix} ] , {W}_{l , {l}^{′} , m , {m}^{′} , p , n}^{( 1 , 2 , 2 , 1 , 1 )} = \frac{1}{\sqrt{2}} [ \begin{matrix}{W}_{l , m , p , n}^{5 , {N}_{g} , 1} & {W}_{{l}^{′} , {m}^{′} , p , n}^{2 , {N}_{g} , 1}\end{matrix} ] ,$ and k₁ and k₂ is integer multiples of O₁ and O₂, respectively, e.g., given in Table 2 above.

TABLE 13
Codebook for overall rank 2 when (r₁, r₂, r₃, r₄) = (2, 2, 1, 1)
N_{g} = 4

| i_{1,1} | i_{1,2} | i_{1,4,q}, q = 1, 2, 3 | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(1,1,2,2,i}^{₃}⁾ |

where
${W}_{l , {l}^{′} , m , {m}^{′} , p , n}^{( 2 , 2 , 1 , 1 , 0 )} = \frac{1}{\sqrt{2}} [ \begin{matrix}{W}_{l , m , p , n}^{1 , {N}_{g} , 1} & {W}_{{l}^{′} , {m}^{′} , p , n}^{4 , {N}_{g} , 1}\end{matrix} ] , {W}_{l , {l}^{′} , m , {m}^{′} , p , n}^{( 2 , 2 , 1 , 1 , 1 )} = \frac{1}{\sqrt{2}} [ \begin{matrix}{W}_{l , m , p , n}^{3 , {N}_{g} , 1} & {W}_{{l}^{′} , {m}^{′} , p , n}^{2 , {N}_{g} , 1}\end{matrix} ] ,$ and k₁ and k₂ is integer multiples of O₁ and O₂, respectively, e.g., given in Table 2 above.

The scheduled entity may configure a CSI report of other codebooks for overall rank 3-rank 8 using this method.

In other examples, the scheduled entity may report the highest rank among four ranks corresponding to four antenna panels. When an RI of a CSI report includes the highest rank 932 of all ranks corresponding to four antenna panels, a codebook arrangement indicator (i₃) 934 may indicate a position of the zero matrix in the codebook 930 and four ranks for four antenna panels of a codebook 930. Since the RI 904 just includes the highest rank (R) 932 of all ranks, a codebook arrangement indicator (i₃) 934 may indicate one of seven possible codebooks (e.g., two codebooks for (R−1, R−1, R, R), two codebooks for (R−1, R, R, R−1), two codebooks for (R, R, R−1, R−1), and one codebook for (R, R, R, R)). Thus, the scheduled entity may transmit a CSI report 902 including an RI 904 that indicates the highest rank 932 of ranks corresponding to antenna panels and a PMI 906 including a codebook arrangement indicator (i₃) 912, 934 indicating a position of a zero matrix corresponding to an antenna panel having the lowest rank and all ranks corresponding to antenna panels. The PMI 906 may further include scheduled entity's preferred values for a multi-panel PMI 910 (e.g., i_{1,1}, i_{1,1}+k₁, i_{1,2}, i_{1.2}+k₂, i_{1,4}, and i₂) (936). For reporting the highest rank in an RI, exemplary codebooks 900A-900F using the equal column power for four-panel CSI reporting may be given as follows in Table 14.

TABLE 14
Codebook for the highest rank 2
Codebook Mode = 1, N_{g} = 4

| i_{1,1} | i_{1,2} | i_{1,4,q}, q = 1, 2, 3 | i₂ | i₃ | |
|---|---|---|---|---|---|
| 0, . . . , N₁O₁−1 | 0, . . . , N₂O₂−1 | 0, 1, 2, 3 | 0, 1 | 0, 1 | Wᵢ_{_{1,1}},i_{_{1,1}}+k_{₁},i_{_{1,2}},i_{_{1,2}}+k_{₂},i_{_{1,4}},i_{₂}^{(2,i}^{₃}⁾ |

where
${W}_{l , {l}^{′} , m , {m}^{′} , p , n}^{( 4 , 0 )} = \frac{1}{\sqrt{2}} [ \begin{matrix}{W}_{l , m , p , n}^{1 , 4 , 1} & {W}_{{l}^{′} , {m}^{′} , p , n}^{8 , 4 , 1}\end{matrix} ] , {W}_{l , {l}^{′} , m , {m}^{′} , p , n}^{( 4 , 1 )} = \frac{1}{\sqrt{2}} [ \begin{matrix}{W}_{l , m , p , n}^{7 , 4 , 1} & {W}_{{l}^{′} , {m}^{′} , p , n}^{2 , 4 , 1}\end{matrix} ]$ ${W}_{l , {l}^{′} , m , {m}^{′} , p , n}^{( 4 , 2 )} = \frac{1}{\sqrt{2}} [ \begin{matrix}{W}_{l , m , p , n}^{1 , 4 , 1} & {W}_{{l}^{′} , {m}^{′} , p , n}^{6 , 4 , 1}\end{matrix} ] , {W}_{l , {l}^{′} , m , {m}^{′} , p , n}^{( 4 , 3 )} = \frac{1}{\sqrt{2}} [ \begin{matrix}{W}_{l , m , p , n}^{5 , 4 , 1} & {W}_{{l}^{′} , {m}^{′} , p , n}^{2 , 4 , 1}\end{matrix} ] ,$ ${W}_{l , {l}^{′} , m , {m}^{′} , p , n}^{( 4 , 4 )} = \frac{1}{\sqrt{2}} [ \begin{matrix}{W}_{l , m , p , n}^{1 , 4 , 1} & {W}_{{l}^{′} , {m}^{′} , p , n}^{3 , 4 , 1}\end{matrix} ] , {W}_{l , {l}^{′} , m , {m}^{′} , p , n}^{( 4 , 5 )} = \frac{1}{\sqrt{2}} [ \begin{matrix}{W}_{l , m , p , n}^{4 , 4 , 1} & {W}_{{l}^{′} , {m}^{′} , p , n}^{2 , 4 , 1}\end{matrix} ] , or$ and k₁ and k₂ is integer multiples of O₁ and O₂, respectively, e.g., given in Table 2 above.

Here, the RI may include the highest rank 2 among four ranks corresponding to four antenna panels. The PMI may include a codebook arrangement indicator (i₃) 912 which choose one codebook among 7 possible codebooks based on a position of a zero matrix and all ranks for four antenna panels. When i₃ is 0, the codebook 800A may indicate that rank 1 corresponds to panel 1, rank 1 corresponds to panel 2, rank 2 corresponds to panel 3, rank 2 corresponds to panel 4 (i.e., (r₁, r₂, r₃, r₄)=(1,1,2,2)), and two zero matrices corresponding to panels 1 and 2 having the lowest rank are at the last column of the codebook. When i₃ is 1, the codebook 800B may indicate a rank combination for four antenna panels is (r₁, r₂, r₃, r₄)=(1,1,2,2)), and two zero matrices corresponding to panels 1 and 2 having the lowest rank are at the first column of the codebook. When i₃ is 2, the codebook 800E may indicate a rank combination for four antenna panels is (r₁, r₂, r₃, r₄)=(1,2,2,1)), and two zero matrices corresponding to panels 1 and 2 having the lowest rank are at the last column of the codebook. When i₃ is 3, the codebook 800F may indicate a rank combination for four antenna panels is (r₁, r₂, r₃, r₄)=(1,2,2,1)), and two zero matrices corresponding to panels 1 and 2 having the lowest rank are at the first column of the codebook. When i₃ is 4, the codebook 800C may indicate a rank combination for four antenna panels is (r₁, r₂, r₃, r₄)=(2,2,1,1)), and two zero matrices corresponding to panels 1 and 2 having the lowest rank are at the last column of the codebook. When i₃ is 5, the codebook 800D may indicate a rank combination for four antenna panels is (r₁, r₂, r₃, r₄)=(2,2,1,1)), and two zero matrices corresponding to panels 1 and 2 having the lowest rank are at the first column of the codebook. When i₃ is 6, the codebook may indicate a rank combination for four antenna panels is (r₁, r₂, r₃, r₄)=(2,2,2,2)).

### Multi-Panel Codebook With Equal Row Power

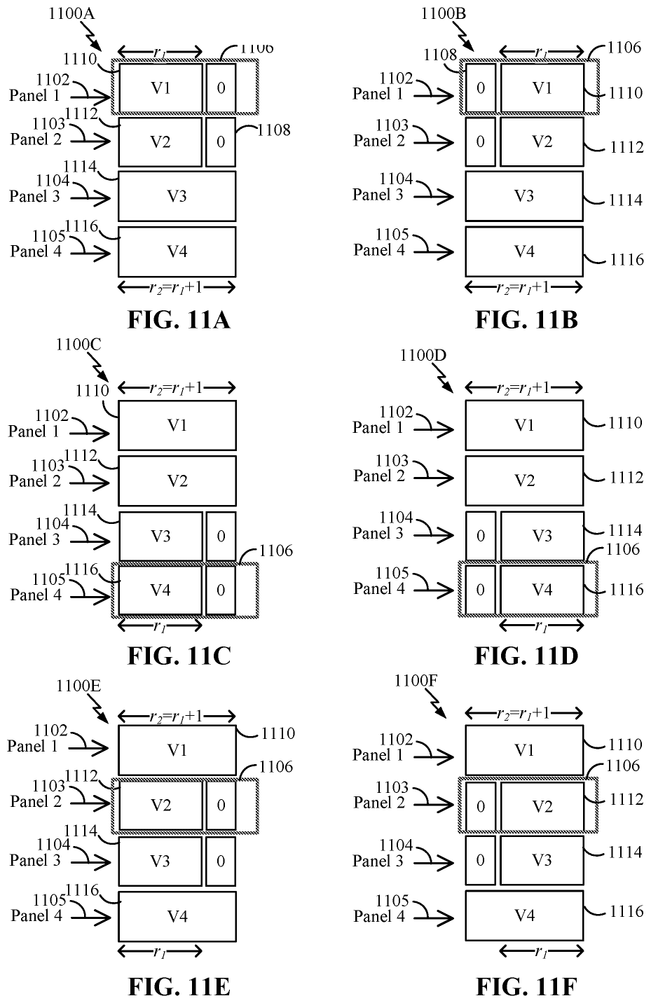

FIGS. 10A-10D and 11A-11F are conceptual illustrations of codebooks 1000A-1000D and 1100A-1100F using an equal row power method for multiple antenna panels having different ranks in accordance with some aspects of the present disclosure. As explained above in FIG. 6B, a component vector 626, 628 or a row of a codebook 1000A-1000D and 1100A-1100F is normalized to have a unit norm. The scheduled entity may configure a codebook 1000A-1000D and 1100A-1100F based on the measured channel quality for multi-panel transmission. The codebook 1000A-1000D and 1100A-1100F may include multiple component vectors or rows corresponding to multiple antenna panels. Thus, the scheduled entity may configure the codebook by stacking or aligning vertically the multiple component vectors. Each row may include a (P/N_{g})-port type-I single-panel codebook corresponding to an antenna panel. Here, P is the number of ports for the CSI-RS (i.e., 2 (cross polarizations of an antenna element)×N_{g} (number of antenna panels)×N₁ (number of antenna elements in horizontal domain)×N₂ (number of antenna elements in vertical domain)). A person having ordinary skill in the art would appreciate a type-I single-panel codebook that is the same type of codebook provided in existing 3GPP specifications. The scheduled entity may determine the codebook 1010, 1012, 1110, 1112, 1114, 1116 for each antenna panel 1002, 1004, 1102, 1103, 1104, 1105. The scheduled entity may apply a different rank restriction and/or a different beam restriction to a different codebook 1010, 1012 for each antenna panel 1002, 1004, 1102, 1103, 1104, 1105. In addition, for the similar reason as a multi-panel codebook using the same column power, a rank difference between unequal ranks for multiple antenna panels may be practically limited to a maximum of 1 (e.g., |rₘ−rₙ|=1, where m, n ∈{1, 2} for two antenna panels and {1, 2, 3, 4} for four antenna panels).

Based on the determined codebooks for corresponding multiple antenna panels, the scheduled entity may configure a multi-panel codebook 1000A-1000D and 1100A-1100F by stacking or aligning vertically the determined codebooks 1010, 1012, 1110, 1112. 1114, 1116. In some examples with two antenna panels in FIGS. 10A-10D, there are three rank combinations for a general rank (r) (e.g., (r₁, r₂)=(r, r), (r−1, r), (r, r−1). For example, when a first rank (r₁) for panel 1 (1002) and a second rank (r2) for panel 2 (1004) are the same (r₁=r₂), a codebook may be

$$W = \frac{1}{\sqrt{2}} [ \begin{matrix}{V}_{1} \\ {φ}_{p} {V}_{2}\end{matrix} ]$$

where V₁ and V₂ are r₁(=r₂) layer (P/2)-port type-I single-panel codebooks. When a first rank (r₁) for panel 1 (1002) is one rank lower than a second rank (r₂) for panel 2 (1004) (r₁=r₂−1), a codebook may be

$$W = \frac{1}{\sqrt{2}} [ \begin{matrix}{V}_{1} 0 \\ {θ}_{p} {V}_{2}\end{matrix} ]$$

(e.g., a codebook 1000A in FIG. 10A) or

$$W = \frac{1}{\sqrt{2}} [ \begin{matrix}0 {V}_{1} \\ {θ}_{p} {V}_{2}\end{matrix} ]$$

(e.g., a codebook 1000B in FIG. 10B) where V₁ and V₂ are r₁-layer and r₂-layer (P/2)-port type-I single-panel codebooks, and 0 is a zero matrix including a P/2-tuple zero vector. Also, when a first rank (r₁) for panel 1 (1002) is one rank higher than a second rank (r₂) for panel 2 (1004) (r₁=r₂+1), a codebook may be

$$W = \frac{1}{\sqrt{2}} [ \begin{matrix}{V}_{1} \\ {θ}_{p} {V}_{2} 0\end{matrix} ]$$

(e.g., a codebook 1000C in FIG. 10C) or

$$W = \frac{1}{\sqrt{2}} [ \begin{matrix}{V}_{1} \\ 0 θ {V}_{2}\end{matrix} ]$$

(e.g., a codebook 1000D in FIG. 10D) where V₁ and V₂ are r₁-layer and r₂-layer (P/2)-port type-I single-panel codebooks, respectively, and 0 is a zero matrix including a P/2-tuple zero vector.

In other examples with four antenna panels in FIG. 11A-11F, there are four rank combinations for a general rank (r) (e.g., (r₁, r₂, r₃, r₄)=(r, r, r, r), (r−1, r−1, r, r), (r, r, r−1, r−1), or (r−1, r, r, r−1). For example, when a first rank (r₁) for panel 1 (1002), a second rank (r₂) for panel 2 (1003), a third rank (r₃) for panel 3 (1004), a fourth rank (r4) for panel 4 (1005) are the same (i.e., r₁=r₂=r₃=r₄), a codebook may be

$$W = \frac{1}{\sqrt{4}} [ \begin{matrix}{V}_{1} \\ {θ}_{{p}_{1}} {V}_{2} \\ {θ}_{{p}_{2}} {V}_{3} \\ {θ}_{{p}_{3}} {V}_{3}\end{matrix} ]$$

where V₁, V₂, V₃, and V₄ are r₁(=r₂=r₃=r₄) layer (P/4)-port type-I single-panel codebooks. When a third rank (r₃) and a fourth rank (r₄) are one rank higher than a first rank (r₁) and a second rank (r₂) (i.e., (r₁, r₂, r₃, r₄)=(r−1, r−1r, r, r)), a codebook may be

$$W = \frac{1}{\sqrt{4}} [ \begin{matrix}{V}_{1} 0 \\ {θ}_{{p}_{1}} {V}_{2} 0 \\ {θ}_{{p}_{2}} {V}_{3} \\ {θ}_{{p}_{3}} {V}_{4}\end{matrix} ]$$

(e.g., a codebook 1100A in FIG. 11A) or

$$W = \frac{1}{\sqrt{4}} [ \begin{matrix}0 {V}_{1} \\ 0 {θ}_{{p}_{1}} {V}_{2} \\ {θ}_{{p}_{2}} {V}_{3} \\ {θ}_{{p}_{3}} {V}_{4}\end{matrix} ]$$

(e.g., a codebook 1100B in FIG. 11B), where V₁, V₂, V₃, and V₄ are r₁-layer, r₂-layer, r₃-layer, and r₄-layer (P/4)-port type-I single-panel codebooks, and 0 is a zero matrix including a P/4-tuple zero vector. When a first rank (r₁) and a second rank (r₂) are one rank higher than a third rank (r₃) and a fourth rank (r₄) (i.e., (r₁, r₂, r₃, r₄=(r,r, r−1, r−1)), a codebook may be

$$W = \frac{1}{\sqrt{4}} [ \begin{matrix} & {V}_{1} & \\ {θ}_{{p}_{1}} & {V}_{2} & \\ {θ}_{{p}_{2}} & {V}_{3} & 0 \\ {θ}_{{p}_{3}} & {V}_{4} & 0\end{matrix} ]$$

(e.g., a codebook 1100C in FIG. 11C) or

$$W = \frac{1}{\sqrt{4}} [ \begin{matrix} & & {V}_{1} \\ & {θ}_{{p}_{1}} & {V}_{2} \\ 0 & {θ}_{{p}_{2}} & {V}_{3} \\ 0 & {θ}_{{p}_{3}} & {V}_{4}\end{matrix} ]$$

(e.g., a codebook 1100D in FIG. 11D), where V₁, V₂, V₃, and V₄ are r₁-layer, r₂-layer, r₃-layer, and r₄-layer (P/4)-port type-I single-panel codebooks, and 0 is a zero matrix including a P/4-tuple zero vector. When a second rank (r₂) and a third rank (r₃) for panel 3 (1004) are one rank higher than a first rank (r₁) and a fourth rank (r₄) (i.e., (r₁, r₂, r₃, r₄)=(r₁, r, r, r−1), a codebook may be

$$W = \frac{1}{\sqrt{4}} [ \begin{matrix} & {V}_{1} & \\ {θ}_{{p}_{1}} & {V}_{2} & 0 \\ {θ}_{{p}_{2}} & {V}_{3} & 0 \\ {θ}_{{p}_{3}} & {V}_{4} & \end{matrix} ]$$

(e.g., a codebook 1100E in FIG. 11E) or

$$W = \frac{1}{\sqrt{4}} [ \begin{matrix} & & {V}_{1} \\ 0 & {θ}_{{p}_{1}} & {V}_{2} \\ 0 & {θ}_{{p}_{2}} & {V}_{3} \\ & {θ}_{{p}_{3}} & {V}_{4}\end{matrix} ]$$

(e.g., a codebook 1100F in FIG. 11F), where V₁, V₂, V₃, and V₄ are r₁-layer, r₂-layer, r₃-layer, and r₄-layer (P/4)-port type-I single-panel codebooks, respectively, and 0 is a zero matrix including a P/4-tuple zero vector.

### CSI Reporting for Multi-Panel Codebook With Equal Row Power

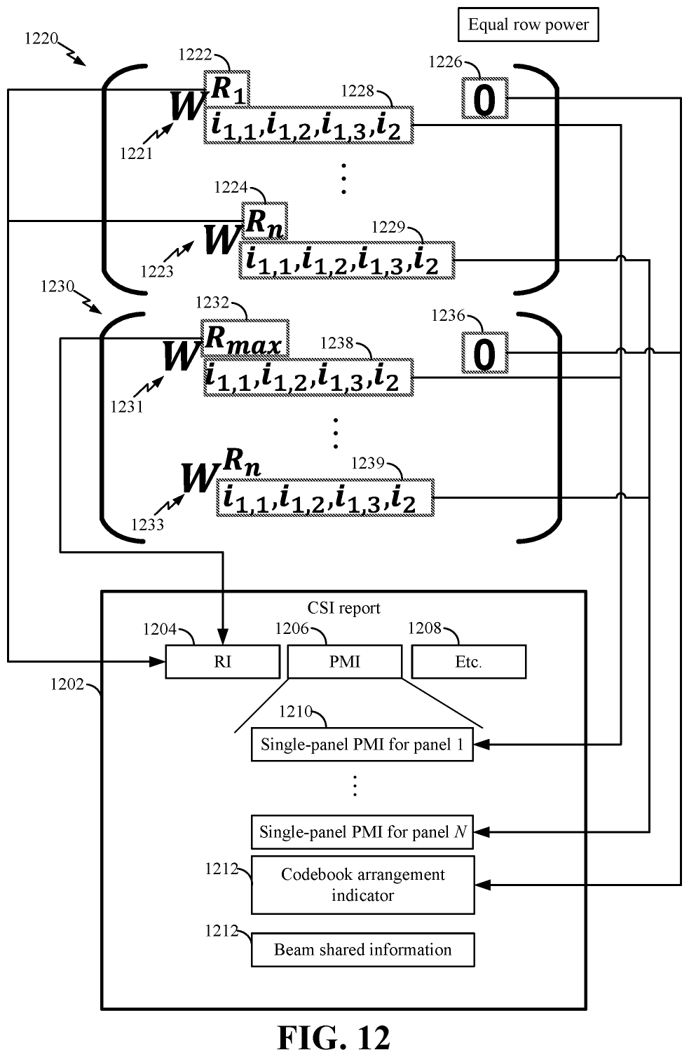

FIG. 12 illustrates examples for CSI reporting for multi-panel codebook with the equal row power in accordance with some aspects of the present disclosure. Based on a configured codebook of FIGS. 10A-10D and 11A-10F, the scheduled entity may determine a preferred rank 1204 and a preferred PMI 1206 in the configured codebook 1220, 1230 based on an estimated channel of a CSI-RS. The scheduled entity further transmit a CSI report 1202 including the RI 1204 and the PMI 1206 to a scheduling entity. An RI of the CSI report may include 1) all ranks 1222, 1224 corresponding to multiple antenna panels as shown in a codebook 1220 or 2) a general rank or the highest rank 1232 among the all ranks corresponding to multiple antenna panels as shown in a codebook 1230. The scheduled entity may determine a codebook arrangement indicator 1226 or 1236 in a PMI 1206 based on the types 1222 or 1232 of RI 1204 and a position of a zero matrix 1226, 1236 in a codebook 1220, 1230.

### CSI Reporting for Two-Panel Codebook With All Ranks Reporting

In some examples for reporting all ranks 1222, 1224 corresponding to two antenna panels, an RI 1204 of a CSI report 1202 may indicate two ranks (r₁, r₂) 1222, 1224 corresponding to two antenna panels. In some examples, the RI 1204 may be a maximum of 5 bits to indicate all ranks for multiple antenna panels. The CSI report 1202 may include two preferred single-panel PMIs 1210 for two codebooks (V₁ 1221 and V₂ 1223) corresponding to two antenna panels. For example, a first single-panel PMI 1228 for a first codebook (V₁) 1221 may include i_{1,1}⁽¹⁾ indicating a horizontal beam index, i_{1,2}⁽¹⁾ indicating a vertical beam index, i_{1,3}⁽¹⁾ indicating a beam spacing value between columns in case of multi-rank (if applicable), and/or i₂⁽¹⁾ indicating a cross polarization co-phasing & beam selection value (if applicable). In some examples, i₂⁽¹⁾ may have beam selection capability using codebook mode 2. Then, i₁⁽¹⁾ may select a group of beams, and i₂⁽¹⁾ may select one beam among the group of beams. A second single-panel PMI 1229 for a second codebook (V₂) 1223 may also include i_{1,1}⁽²⁾, i_{1,2}⁽²⁾, i_{1,3}⁽²⁾ (if applicable), and/or i₂⁽²⁾ (if applicable).

In some examples, the PMI may include a codebook arrangement indicator 1212 for indicating a position of a zero matrix 1226 that may include a P/2-tuple zero vector when a first rank for a first antenna panel is not the same as a second rank for a second antenna panel. In some instances, the codebook arrangement indicator 1212 may be one bit to indicate that the zero matrix is at the first column or the last column of the codebook 1220. In some examples, the codebook arrangement indicator 1212 may also include a co-phasing value (φₚ) between two antenna panels. In further examples, the scheduled entity may configure a CQI based on the ranks 1222, 1224 and the PMIs 1228, 1229.

In some instances, the scheduled entity may reduce the total number of single-panel PMIs using shared beam information 1212 or CSI compression information when different antenna panels are co-located. Thus, the scheduled entity may reduce the PMI payload size considering similar propagation properties of co-located antenna panels when different antenna panels are co-located.

In some examples, shared beam information 1212 may indicate that beam index information is the same between different antenna panels, i.e., i_{1,1}⁽¹⁾=i_{1,1}⁽²⁾ and i_{1,2}⁽¹⁾=i_{1,2}⁽²⁾. Then, the scheduled entity may report one beam index pair (i_{1,1}⁽¹⁾, i_{1,2}⁽¹⁾) for two single-panel PMIs 1228, 1229 in codebooks (V₁ 1221 and V₂ 1223). For example, when different antenna panels are co-located within a scheduling entity site, beam direction toward the scheduled entity would not be so different between antenna panels. Thus, beam index information could be the same between different antenna panels, i.e., i_{1,1}⁽¹⁾=i_{1,1}⁽²⁾ and i_{1,2}⁽¹⁾=i_{1,2}⁽²⁾, and the scheduled entity may report once with the same index pair (i_{1,1}⁽¹⁾, i_{1,2}⁽¹⁾).

In further examples, shared beam information 1212 may indicate that beam spacing values (k₁, k₂) indicated by i_{1,3} are the same between different antenna panels. For example, shared beam information 1212 may indicate that (k₁, k₂) are fixed as (k₁, k₂) =(O₁, 0) for two different antenna panels. Then, the scheduled entity may not report i_{1,3} of single-panel PMIs 1210 for two antenna panels. Alternatively, shared beam information 1212 may indicate that i_{1,3} of single-panel PMIs are the same. Then the scheduled entity may report one i_{1,3} for two single-panel PMIs 1210 for two antenna panels. In some examples, Table 15 may define i_{1,3} when a first rank (r₁) for panel 1 and a second rank (r₂) for panel 2 are (2, 3), (3, 2), (3, 4), or (4, 3) (i.e., (r₁, r₂)=(2, 3), (3, 2), (3, 4), (4, 3)). For other rank combinations, Tables 2 and 3 may define i_{1,3}.

TABLE 15
New mapping of i_{1, 3} to k₁ and k₁

| | N₁ = 2, | | N₁ = 4, | | N₁ ≥ 6, | | N₁ = 2, | | N₁ ≥ 3, | |
|---|---|---|---|---|---|---|---|---|---|---|
| | N₂ = 1 | | N₂ = 1 | | N₂ = 1 | | N₂ = 2 | | N₂ ≥ 2 | |
| i_{1, 3} | k₁ | k₂ | k₁ | k₂ | k₁ | k₂ | k₁ | k₂ | k₁ | k₂ |
| 0 | O₁ | 0 | O | 0 | 0 | 0 | O₁ | 0 | O₁ | 0 |
| 1 | | | 2O₁ | 0 | 2O₁ | 0 | 0 | O₂ | 0 | O₂ |
| 2 | | | 3O₁ | 0 | 3O₁ | 0 | O₁ | O₂ | O₁ | O₂ |
| 3 | | | | | 4O₁ | 0 | | | 2O₁ | 0 |

In further examples, in case of co-located antenna panels, shared beam information 1212 may indicate that cross-polarization co-phasing values for two antenna panels are the same between antenna panels. That is, the scheduled entity may report i₂ once for different antenna panels assuming the same cross-polarization co-phasing value.

### CSI REPORTING FOR FOUR-PANEL CODEBOOK WITH ALL RANKS REPORTING

In other examples for reporting all ranks 1222, 1224 corresponding to four antenna panels, an RI 1204 of a CSI report 1202 may indicate four ranks (r₁, r₂, r₃, r₄) 1222, 1224 corresponding to four antenna panels. In some examples, the RI 1204 may be a maximum of 5 bits to indicate all ranks for multiple antenna panels. The CSI report 1202 may include four preferred single-panel PMIs 1210 for four codebooks (V₁, V₂, V₃, V₄) 1221, 1223 corresponding to four antenna panels. For example, a first single-panel PMI 1228 for a first codebook (V₁) 1221 may include i_{1,1}⁽¹⁾ indicating a horizontal beam index, i_{1,2}⁽¹⁾ indicating a vertical beam index, i_{1,3}⁽¹⁾ indicating a beam spacing value between columns in case of multi-rank (if applicable), and/or i₂⁽¹⁾ indicating a cross polarization co-phasing & beam selection value (if applicable). In some examples, i₂⁽¹⁾ may have beam selection capability using codebook mode 2. Then, i₁⁽¹⁾ may select a group of beams, and i₂⁽¹⁾ may select one beam among the group of beams. Similarly, a second single-panel PMI 1228 for a second codebook (V₂) 1221 may include i_{1,1}⁽²⁾, i_{1,2}⁽²⁾, i_{1,3}⁽²⁾, and/or i₂⁽²⁾; a third single-panel PMI 1228 for a third codebook (V₃) 1221 may include i_{1,1}⁽³⁾, i_{1,2}⁽³⁾, i_{1,3}⁽³⁾, and/or i₂⁽³⁾; and a fourth single-panel PMI 1228 for a fourth codebook (V₄) 1223 may include i_{1,1}⁽⁴⁾, i_{1,2}⁽⁴⁾, i_{1,3}⁽⁴⁾, and/or i₂⁽⁴⁾.

In some examples, the PMI may further include a codebook arrangement indicator 1212 for indicating a position of a zero matrix 1226 that may include two P/4-tuple zero vectors when all four ranks are not the same. In some instances, the codebook arrangement indicator 1212 may be one bit to indicate that the zero matrix is at the first column or the last column of the codebook 1220. In some examples, the codebook arrangement indicator 1212 may also include co-phasing values (φₚ_{₁}, φₚ_{₂}, and φₚ_{₃}) between four antenna panels. In further examples, the scheduled entity may configure a CQI based on the ranks 1222, 1224 and the PMIs 1228, 1229.

In some instances, the scheduled entity may reduce the total number of single-panel PMIs using shared beam information 1212 when different antenna panels are co-located. In some examples, shared beam information 1212 may indicate that beam index information is the same in four different antenna panels, i.e., i_{1,1}⁽¹⁾=i_{1,1}⁽²⁾=i_{1,1}⁽³⁾=i_{1,1}⁽⁴⁾ and i_{1,2}⁽¹⁾=i_{1,2}⁽²⁾=i_{1,2}⁽³⁾=i_{1,2}⁽⁴⁾.Then, the scheduled entity may report one beam index pair (i_{1,1}⁽¹⁾, i_{1,2}⁽¹⁾) for four single-panel PMIs 1228, 1229 in codebooks (V₁, V₂, V₃, and V₄). In other examples, shared beam information 1212 may indicate that beam index information is the same in two antenna panels having the same rank. For examples, when ranks for four antenna panels are (R, R, R−1, R−1) or (R−1, R−1, R, R) (i.e., (r₁, r₂, r₃, r₄)=(R, R, R−1, R−1) or (R−1, R−1, R, R)), shared beam information may indicate i_{1,1}⁽¹⁾=i_{1,1}⁽²⁾, i_{1,1}⁽³⁾=i_{1,1}⁽⁴⁾, i_{1,2}⁽¹⁾=i_{1,2}⁽²⁾, and i_{1,2}⁽³⁾=i_{1,2}⁽⁴⁾. Thus, the scheduled entity may report two beam index pairs (i_{1,1}⁽¹⁾, i_{1,2}⁽¹⁾) and (i_{1,1}⁽³⁾, i_{1,2}⁽³⁾). Similarly, when (r₁, r₂, r₃, r₄)=(R−1, R, R, R−1), shared beam information may indicate i_{1,1}⁽¹⁾=i_{1,1}⁽⁴⁾, i_{1,1}⁽²⁾=i_{1,1}⁽³⁾, i_{1,2}⁽¹⁾=i_{1,2}⁽⁴⁾, and i_{1,2}⁽²⁾=i_{1,2}⁽³⁾. Thus, the scheduled entity may report two beam index pairs (i_{1,1}⁽¹⁾, i_{1,2}⁽¹⁾) and i_{1,1}⁽²⁾, i_{1,2}⁽²⁾. However, it should be appreciated that these are mere examples and other suitable examples to reduce the total number of single-panel PMIs are possible.

In further examples, shared beam information 1212 may indicate that beam spacing values (k₁, k₂) indicated by i_{1,3} are the same between different antenna panels as in two-panel examples above. For example, shared beam information 1212 may indicate that (k₁, k₂) are fixed as (k₁, k₂)=(O₁, 0) for four different antenna panels. Then, the scheduled entity may not report i_{1,3} of single-panel PMIs 1210 for four antenna panels. Alternatively, shared beam information 1212 may indicate that i_{1,3} of single-panel PMIs are the same. Then the scheduled entity may report one i_{1,3} for four single-panel PMIs 1210 for four antenna panels. In some examples, Table 15 above may define i_{1,3} when a first rank (r₁) for panel 1, a second rank (r₂) for panel 2, a third rank (r₃) for panel 3, and a fourth rank (r₄) for panel 4 are 2, 3, or 4. For other rank combinations, Tables 2 and 3 may be used for i_{1,3}.

In further examples, in case of co-located antenna panels, shared beam information 1212 may indicate that cross-polarization co-phasing values for four antenna panels are the same between antenna panels. That is, the scheduled entity may report i₂ once for different antenna panels assuming the same cross-polarization co-phasing value. If the payload sizes of i₂⁽¹⁾, i₂⁽²⁾, i₂⁽³⁾, and i₂⁽⁴⁾ are not the same, the scheduled entity may use the largest one and apply the same interpretation of cross-polarization co-phasing. For example, when (r₁, r₂, r₃, r₄)=(1, 1, 2, 2). i₂ indicates 4 states (2 bits) and apply the same co-phasing interpretation for both rank 1 and rank 2 cases.

### CSI Reporting for Two-Panel Codebook With One Rank Reporting

In some examples for reporting a general rank or the highest rank 1232 among two ranks corresponding to two antenna panels, an RI 1204 of a CSI report 1202 may indicate the highest rank in two ranks (r₁, r₂) corresponding to two antenna panels. In this example, the RI 1204 may use a maximum of conventional 3 bits to indicate the highest rank in two ranks (r₁, r₂). The CSI report 1202 may include two preferred single-panel PMIs 1210 for two codebooks (V₁ 1238 and V₂ 1239) corresponding to two antenna panels. In some examples, the scheduled entity may configure two single-panel PMIs as described above in the CSI reporting for two-panel codebook with all ranks reporting.

Since the RI indicates one of two ranks (r₁, r₂), the PMI 1206 may further include a codebook arrange indicator 1212 to indicate one of five possible codebooks (e.g., two codebooks for r₁+1=r₂, two codebooks for r₁=r₂+1, and one codebook for r₁=r₂). Thus, the codebook arrange indicator 1212 may use a maximum of 3 bits to indicate one of five codebooks for different rank combinations for two antenna panels and a position of a zero matrix in the codebook 1230. In some examples, the codebook arrangement indicator 1212 may also include a co-phasing value (φₚ) between two antenna panels. In further examples, the scheduled entity may configure a CQI based on the ranks 1222, 1224 and the PMIs 1228, 1229.

In some instances, the scheduled entity may reduce the total number of single-panel PMIs using shared beam information 1212 when different antenna panels are co-located as described above in the CSI reporting for two-panel codebook with all ranks reporting.

### CSI Reporting for Four-Panel Codebook With One Rank Reporting

In other examples for reporting a general rank or the highest rank 1232 among all ranks corresponding to four antenna panels, an RI 1204 of a CSI report 1202 may indicate the highest rank among four ranks (r₁, r₂, r₃, r₄) corresponding to four antenna panels. In this example, the RI 1204 may use a maximum of conventional 3 bits to indicate the highest rank in four ranks (r₁, r₂, r₃, r₄). The CSI report 1202 may include four preferred single-panel PMIs 1210 for four codebooks (V₁, V₂, V₃, V₄) corresponding to four antenna panels. In some examples, the scheduled entity may configure four single-panel PMIs as described above in the CSI reporting for four-panel codebook with all ranks reporting.

In some examples, the CSI report 1202 may further include a codebook arrange indicator 1212 to indicate one of seven possible codebooks (e.g., two codebooks for (r₁, r₂, r₃, r₄)=(R, R, R−1, R−1), two codebooks for (r₁, r₂, r₃, r₄)=(R−1, R, R, R−1), two codebooks for (r₁, r₂, r₃, r₄)=(R−1, R−1, R, R), and one codebook for (r₁, r₂, r₃, r₄)=(R, R, R, R)). Thus, the codebook arrange indicator 1212 may use a maximum of 3 bits to indicate one of seven codebooks for different rank combinations for four antenna panels and a position of a zero matrix in the codebook 1230. In some examples, the codebook arrangement indicator 1212 may also include co-phasing values (φₚ_{₁}, φₚ_{₂}, φₚ_{₃}) between four antenna panels. In further examples, the scheduled entity may include the codebook arrangement indicator 1212 in a PMI 1206 or may report separately 1208. In further examples, the scheduled entity may configure a CQI based on the ranks 1222, 1224 and the PMIs 1228, 1229.

In some instances, the scheduled entity may reduce the total number of single-panel PMIs using shared beam information 1212 when different antenna panels are co-located as described above in the CSI reporting for four-panel codebook with all ranks reporting.

### CSI Reporting for Multi-Panel Codebook With Different Ports

In some scenarios, the scheduling entity may transmit a CSI-RS from multiple antenna panels having different numbers of antenna ports. This may increase performance and flexibility of communication transmissions by reusing existing antenna arrays with different sizes and support various signal patterns by coordinating antenna panels with different antenna ports by a central controller that may provide coherent signal combination between different antenna panels. The scheduled entity may configure a codebook for multiple antenna panels with different numbers of ports using the equal row power. That is, the scheduled entity may configure the codebook by stacking single-panel codebooks for the heterogeneous antenna panels. For example, when a CSI-RS is transmitted through P-port CSI-RS resources on multiple (N_{g}) panels, a scheduled entity may configure a heterogeneous-panel codebook using P₁-port, P₂-port, . . . , and P_{N}_{_{g}}-port single-panel codebooks, where Pᵢ-port panel may have antenna configuration (N₁⁽ⁱ⁾, N₂⁽ⁱ⁾) and Σᵢ₌₁^{N}^{_{g}} Pᵢ=P. Here, a first set of antenna panels among N_{g} antenna panels may have a different number of antenna ports from a second set of panels among N_{g} antenna panels. For the similar reason as a multi-panel codebook using the same column power, a rank difference between ranks for heterogeneous multiple antenna panels may be practically limited to a maximum of 1 (e.g., |rₘ−rₙ|≤1, where m, n ∈ {1, 2} for two antenna panels and {1, 2, 3, 4} for four antenna panels).

In some examples for two antenna panels, the scheduled entity may configure a heterogeneous panel codebook similar to a multi-panel codebook with the equal row power described above. For example, panel 1 and panel 2 may correspond to ranks r₁ and r₂ (r₁, r₂), respectively. When rank r₁ is the same as rank r₂ (r₁=r₂), the scheduled entity may configure a heterogeneous panel codebook using

$$W = \frac{1}{\sqrt{2}} [ \begin{matrix} & {V}_{1} \\ {φ}_{p} & {V}_{2}\end{matrix} ] ,$$

where V₁ and V₂ are (r₁(=r₂) layer P₁-port single-panel codebook and P₂ -port single-panel codebook, respectively. When rank r₁ is one rank higher than r₂ (r₁=r₂+1), the scheduled entity may configure a heterogeneous panel codebook using

$$W = \frac{1}{\sqrt{2}} [ \begin{matrix} & {V}_{1} & \\ {θ}_{p} & {V}_{2} & 0\end{matrix} ] or W = \frac{1}{\sqrt{2}} [ \begin{matrix} & & {V}_{1} \\ 0 & {θ}_{p} & {V}_{2}\end{matrix} ] ,$$

where V₁ and V₂ are r₁ -layer P₁ -port single-panel codebook and r₂-layer P₂-port single-panel codebook, respectively, and 0 is a zero matrix including P₁-tuple zero vector. When rank r₂ is one rank higher than r₁ (r₁+1=r₂), the scheduled entity may configure a heterogeneous panel codebook using

$$W = \frac{1}{\sqrt{2}} [ \begin{matrix}{V}_{1} & 0 \\ {θ}_{p} & {V}_{2}\end{matrix} ] or W = \frac{1}{\sqrt{2}} [ \begin{matrix}0 & {V}_{1} \\ {θ}_{p} & {V}_{2}\end{matrix} ]$$

where V₁ and V₂ are r₁ -layer P₁ -port single-panel codebook and r₂-layer P₂-port single-panel codebook, respectively, and 0 is P₁-tuple zero vector.

Some examples for reporting all ranks corresponding to two heterogeneous panels may use FIG. 12. An RI 1204 of a CSI report 1202 may indicate two ranks (r₁, r₂) 1222, 1224 corresponding to two antenna panels. In some examples, the RI 1204 may be a maximum of 5 bits to indicate all ranks for multiple antenna panels. The CSI report 1202 may include two preferred single-panel PMIs 1210 for two codebooks (V₁ 1221 and V₂ 1223) corresponding to two antenna panels. For example, a first single-panel PMI 1228 for a first codebook (V₁) 1221 may include i_{1,1}⁽¹⁾, i_{1,2}⁽¹⁾, i_{1,3}⁽¹⁾ and/or i₂⁽¹⁾ as described above in the CSI reporting for two-panel codebook with all ranks reporting. Similarly, a second single-panel PMI 1229 for a second codebook (V₂) 1223 may include i_{1,1}⁽²⁾, i_{1,2}⁽²⁾, i_{1,3}⁽²⁾, and/or i₂⁽²⁾.

In some examples, the CSI report may further include a codebook arrangement indicator 1212 for indicating a position of a zero matrix 1226 when all two ranks are not the same. In some instances, the codebook arrangement indicator 1212 may be one bit to indicate that the zero matrix is at the first column or the last column of the codebook 1220. In further examples, the codebook arrangement indicator 1212 may also include co-phasing values (φₚ) between two antenna panels. In some instances, the scheduled entity may include the codebook arrangement indicator 1212 in a PMI 1206 or may report separately 1208. In further examples, the scheduled entity may configure a CQI based on the ranks 1222, 1224 and the PMIs 1228, 1229.

In some instances, the scheduled entity may reduce the total number of single-panel PMIs using shared beam information 1212 or CSI compression information when different antenna panels are co-located. In some examples, shared beam information 1212 may indicate that single beam index information can be reported for different antenna panels. For example, the scheduled entity may report a single index i_{1,1} to generate i_{1,1}⁽¹⁾=i_{1,1} and

$${i}_{1 , 1}^{( 2 )} = ⌊ \frac{{N}_{1}^{( 2 )} {O}_{1}^{( 2 )}}{{N}_{1}^{( 1 )} {O}_{1}^{( 1 )}} \cdot {i}_{1 , 1} ⌋$$

when N₁⁽¹⁾O₁⁽¹⁾≥N₁⁽²⁾O₁⁽²⁾, but

$${i}_{1 , 1}^{( 1 )} = ⌊ \frac{{N}_{1}^{( 1 )} {O}_{1}^{( 1 )}}{{N}_{1}^{( 2 )} {O}_{1}^{( 2 )}} \cdot {i}_{1 , 1} ⌋$$

and i_{1,1}⁽²⁾=i_{1,1} when N₁⁽¹⁾O₁⁽¹⁾<N₁⁽²⁾O₁⁽²⁾. Also the scheduled entity may report a single index i_{1,2} to generate i_{1,2}⁽¹⁾⁼ⁱ_{1,2} and

$${i}_{1 , 2}^{( 2 )} = ⌊ \frac{{N}_{2}^{( 2 )} {O}_{2}^{( 2 )}}{{N}_{2}^{( 1 )} {O}_{2}^{( 1 )}} \cdot {i}_{1 , 2} ⌋$$

when N₂⁽¹⁾O₂^{(1)≥N}₂⁽²⁾O₂⁽²⁾, but

$${i}_{1 , 2}^{( 1 )} = ⌊ \frac{{N}_{2}^{( 1 )} {O}_{2}^{( 1 )}}{{N}_{2}^{( 2 )} {O}_{2}^{( 2 )}} \cdot {i}_{1 , 1} ⌋$$

and i_{1,2}⁽²⁾=i_{1,2} when N₂⁽¹⁾O₂⁽¹⁾<N₂⁽²⁾O₂⁽²⁾.

In some examples for four antenna panels, the scheduled entity may configure a heterogeneous panel codebook similar to a multi-panel codebook with the equal row power described above. For example, panel 1, panel 2, panel 3, and panel 4 may correspond to ranks r₁, r₂, r₃, r₄ (r₁, r₂, r₃, r₄), respectively. When all four ranks are the same each other (r₁=r₂=r₃=r₄), the scheduled entity may configure a heterogeneous panel codebook using

$$W = \frac{1}{\sqrt{4}} [ \begin{matrix} & {V}_{1} \\ {θ}_{{p}_{1}} & {V}_{2} \\ {θ}_{{p}_{2}} & {V}_{3} \\ {θ}_{{p}_{3}} & {V}_{3}\end{matrix} ]$$

where V₁, V₂, V₃, and V₄ are r₁ (=r₂=r₃=r₄) layer P₁-port, P₂-port, P₃-port, and P₄-port single-panel codebooks, respectively. When the first and second ranks are one rank higher than the third and fourth ranks (i.e., (r₁=r₂=r₃=r₄)=(R, R, R−1, R−1)), the scheduled entity may configure a heterogeneous panel codebook using

$$W = \frac{1}{\sqrt{4}} [ \begin{matrix} & {V}_{1} & \\ {θ}_{{p}_{1}} & {V}_{2} & \\ {θ}_{{p}_{2}} & {V}_{3} & 0 \\ {θ}_{{p}_{3}} & {V}_{4} & 0\end{matrix} ] or W = \frac{1}{\sqrt{4}} [ \begin{matrix} & & {V}_{1} \\ & {θ}_{{p}_{1}} & {V}_{2} \\ 0 & {θ}_{{p}_{2}} & {V}_{3} \\ 0 & {θ}_{{p}_{3}} & {V}_{4}\end{matrix} ] ,$$

where V₁, V₂, V₃, and V₄ are r₁-layer P₁-port single-panel codebook, r₂-layer P₂-port single-panel codebook, r₃ -layer P₃ -port single-panel codebook, and r₄-layer P₄-port single-panel codebook, respectively, and 0 is a zero matrix. When the first and second ranks are one rank higher than the third and fourth ranks (i.e., (r₁, r₂, r₃, r₄)=(R−1, R, R, R−1)), the scheduled entity may configure a heterogeneous panel codebook using

$$W = \frac{1}{\sqrt{4}} [ \begin{matrix} & {V}_{1} & \\ {θ}_{{p}_{1}} & {V}_{2} & 0 \\ {θ}_{{p}_{2}} & {V}_{3} & 0 \\ {θ}_{{p}_{3}} & {V}_{4} & \end{matrix} ] or W = \frac{1}{\sqrt{4}} [ \begin{matrix} & & {V}_{1} \\ 0 & {θ}_{{p}_{1}} & {V}_{2} \\ 0 & {θ}_{{p}_{2}} & {V}_{3} \\ & {θ}_{{p}_{3}} & {V}_{4}\end{matrix} ] ,$$

V₁, V₂, V₃, and V₄ are r₁-layer P₁-port single-panel codebook, r₂-layer P₂-port single-panel codebook, r₃-layer P₃ -port single-panel codebook, and r₄-layer P₄-port single-panel codebook, respectively, and 0 is a zero matrix. When the first and second ranks are one rank higher than the third and fourth ranks (i.e., (r₁=r₂=r₃=r₄)=(R−1, R−1, R, R)), the scheduled entity may configure a heterogeneous panel codebook using

$$W = \frac{1}{\sqrt{4}} [ \begin{matrix} & {V}_{1} & 0 \\ {θ}_{{p}_{1}} & {V}_{2} & 0 \\ {θ}_{{p}_{2}} & {V}_{3} & \\ {θ}_{{p}_{3}} & {V}_{4} & \end{matrix} ] or W = \frac{1}{\sqrt{4}} [ \begin{matrix}0 & & {V}_{1} \\ 0 & {θ}_{{p}_{1}} & {V}_{2} \\ & {θ}_{{p}_{2}} & {V}_{3} \\ & {θ}_{{p}_{3}} & {V}_{4}\end{matrix} ] ,$$

V₁, V₂, V₃, and V₄ are r₁-layer P₁-port single-panel codebook, r₂-layer P₂-port single-panel codebook, r₃-layer P₃-port single-panel codebook, and r₄-layer P₄-port single-panel codebook, respectively, and 0 is a zero matrix.

Some examples for reporting all ranks corresponding to four panels may use FIG. 12. An RI 1204 of a CSI report 1202 may indicate four ranks (r₁, r₂, r₃, r₄) 1222, 1224 corresponding to four panels. In some examples, the RI 1204 may be a maximum of 5 bits to indicate all ranks for multiple panels. The CSI report 1202 may include four preferred single-panel PMIs 1210 for four codebooks (V₁, V₂, V₃, V₄) corresponding to four panels. For example, an nth single-panel PMI 1228 for an nth codebook (Vₙ) 1221 may include i_{1,1}⁽ⁿ⁾, i_{1,2}⁽ⁿ⁾, i_{1,3}⁽ⁿ⁾, and/or i₂⁽ⁿ⁾ as described above in the CSI reporting for four-panel codebook with all ranks reporting.

In some examples, the CSI report may further include a codebook arrangement indicator 1212 for indicating a position of a zero matrix 1226 when all two ranks are not the same. In some instances, the codebook arrangement indicator 1212 may be one bit to indicate that the zero matrix is at the first column or the last column of the codebook 1220. In further examples, the codebook arrangement indicator 1212 may also include co-phasing values (θₚ_{₁}, θₚ_{₂}, θₚ_{₃}) between four panels. In some instances, the scheduled entity may include the codebook arrangement indicator 1212 in a PMI 1206 or may report separately 1208. In further examples, the scheduled entity may configure a CQI based on the ranks 1222, 1224 and the PMIs 1228, 1229.

In some instances, the scheduled entity may reduce the total number of single-panel PMIs using shared beam information 1212 when different panels are co-located. As described above, the scheduled entity may report a single beam index (i_{1,1}, i_{1,2}) to produce each beam index for each panel based on the number of ports. In other examples, the scheduled entity may report two beam indexes (i_{1,1}^{(m)}, i_{1,2}^{(m)} and i_{1,1}⁽ⁿ⁾, i_{1,2}⁽ⁿ⁾) for two sets of panels, each set including two antenna panels.

### Scheduled Entity

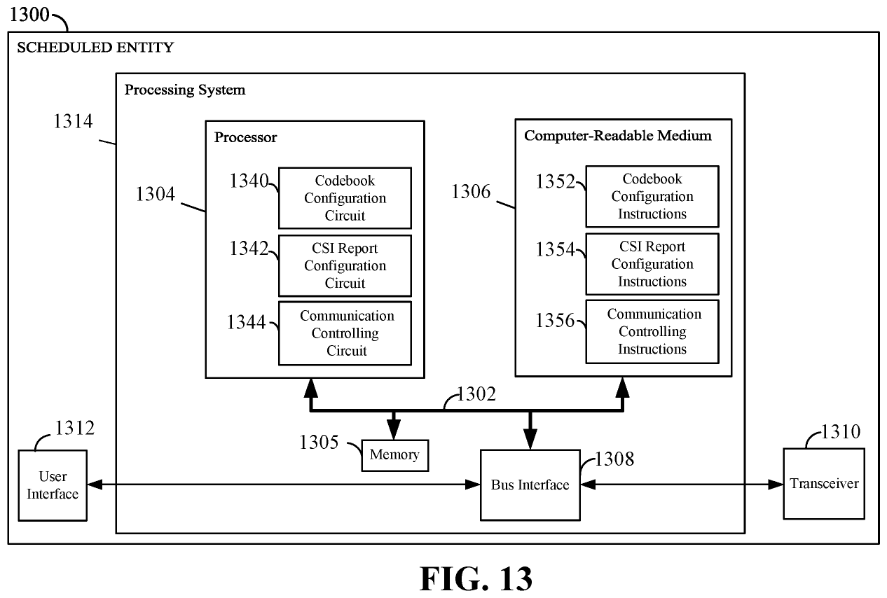

FIG. 13 is a conceptual diagram illustrating an example of a hardware implementation for an exemplary scheduled entity 1300 employing a processing system 1314. In accordance with various aspects of the disclosure, a processing system 1314 may include an element, or any portion of an element, or any combination of elements having one or more processors 1304. For example, the scheduled entity 1300 may be a user equipment (UE) as illustrated in any one or more of FIGS. 1, 2, and/or 3.

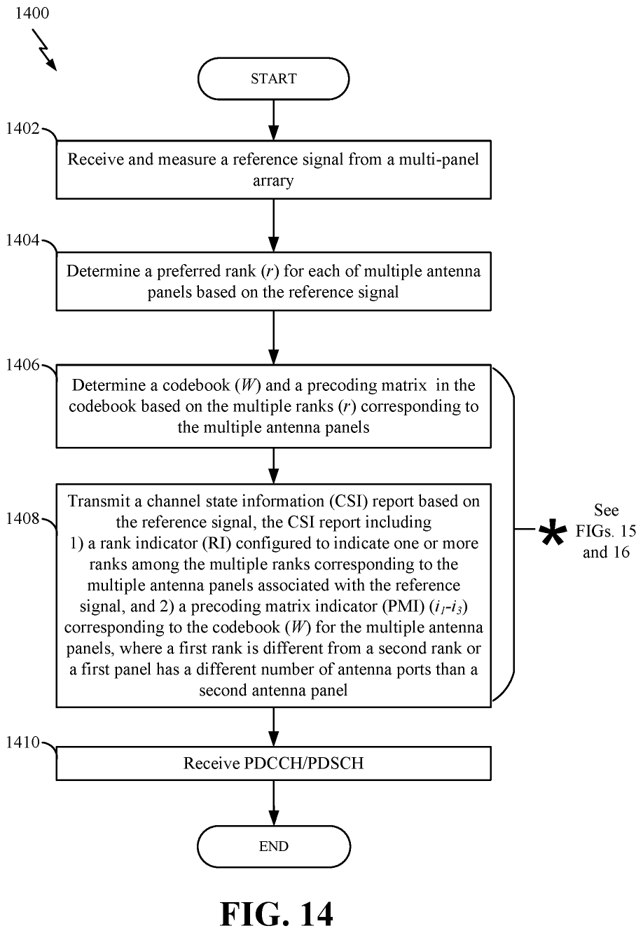

The scheduled entity 1300 may include a processing system 1314 having one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduled entity 1300 may be configured to perform any one or more of the functions described herein. For example, the processor 1304, as utilized in a scheduled entity 1300, may be configured (e.g., in coordination with the memory 1305) to implement any one or more of the processes and procedures described below and illustrated in FIGS. 14-16.

The processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further. A bus interface 1308 provides an interface between the bus 1302 and a transceiver 1310. The transceiver 1310 provides a communication interface or means for communicating with various other apparatus over a transmission medium. Depending upon the nature of the apparatus, a user interface 1312 (e.g., keypad, display, speaker, microphone, joystick) may also be provided. Of course, such a user interface 1312 is optional, and some examples, such as a base station, may omit it.

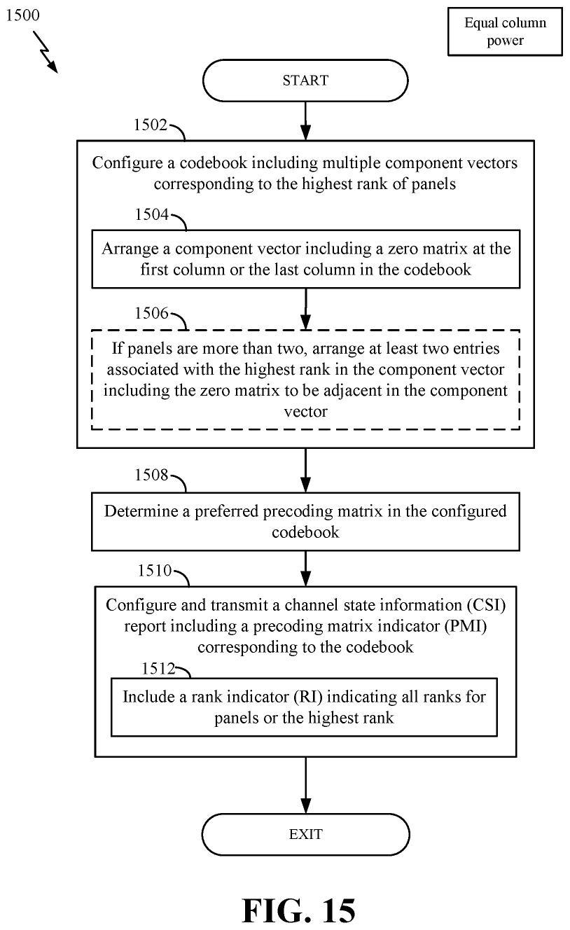

In some aspects of the disclosure, the processor 1304 may include codebook configuration circuitry 1340 configured (e.g., in coordination with the memory 1305) for various functions, including, e.g., configuring a codebook to have multiple component vectors corresponding to the highest rank among multiple ranks corresponding to multiple antenna panels, piling component vectors side-by-side, arranging a component vector including zero matrix corresponding to an antenna panel having the lowest rank among multiple ranks corresponding to multiple antenna panels at the first column or at the last column of the codebook, arranging entries of a component vector having a zero matrix to be at adjacent rows in the component vector. normalizing each component vector in the codebook to have a unit norm, stacking component vectors corresponding to multiple antenna panels, and/or adding a zero vector in a component vector corresponding to an antenna panel having the lowest rank at the first column or the last column of the codebook. For example, the codebook configuration circuitry 1340 may be configured to implement one or more of the functions described below in relation to FIGS. 14, 15, and/or 16, including, e.g., blocks 1406, 1502, 1504, 1506, 1602, and/or 1604.

In some aspects of the disclosure, the processor 1304 may include CSI report configuration circuitry 1342 configured (e.g., in coordination with the memory 1305) for various functions, including, e.g., determining a preferred rank for each of multiple antenna panels based on a reference signal, configuring an RI indicating all ranks for multiple antenna panels, configuring an RI indicating one rank (e.g., the highest rank) for multiple antenna panels, configuring a PMI including a codebook arrangement indicator configured to indicate a position of a zero matrix of a component vector in a codebook, configuring a PMI including a codebook arrangement indicator configured to indicate a position of a zero matrix of a component vector in a codebook and multiple ranks for multiple antenna panels, and/or configuring a PMI including shared beam information for a set of antenna panels in the plurality of antenna panels for reducing the total number of single-panel PMIs in multiple single-panel PMIs. For example, the CSI report configuration circuitry 1342 may be configured to implement one or more of the functions described below in relation to FIGS. 14, 15, and/or 16, including, e.g., blocks 1404, 1408, 1510, 1512, 1608, and/or 1610.

In some aspects of the disclosure, the processor 1304 may include communication controlling circuitry 1344 configured (e.g., in coordination with the memory 1305) for various functions, including, e.g., receiving a reference signal, receiving a reference signal from a multi-panel array, transmitting a CSI report based on the reference signal, and/or receiving a communication (e.g., PDCCH/PDSCH). For example, the communication controlling circuitry 1344 may be configured to implement one or more of the functions described below in relation to FIGS. 14, 15, and/or 16, including, e.g., blocks 1402, 1404, 1408, and/or 1410.

The processor 1304 is responsible for managing the bus 1302 and general processing, including the execution of software stored on the computer-readable medium 1306. The software, when executed by the processor 1304, causes the processing system 1314 to perform the various functions described below for any particular apparatus. The processor 1304 may also use the computer-readable medium 1306 and the memory 1305 for storing data that the processor 1304 manipulates when executing software.

One or more processors 1304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1306. The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1306 may store computer-executable code that includes codebook configuration instructions 1352 that configure a scheduled entity 1300 for various functions, including, e.g., configuring a codebook to have multiple component vectors corresponding to the highest rank among multiple ranks corresponding to multiple antenna panels, piling component vectors side-by-side, arranging a component vector including zero matrix corresponding to an antenna panel having the lowest rank among multiple ranks corresponding to multiple antenna panels at the first column or at the last column of the codebook, arranging entries of a component vector having a zero matrix to be at adjacent rows in the component vector, normalizing each component vector in the codebook to have a unit norm, stacking component vectors corresponding to multiple antenna panels, and/or adding a zero vector in a component vector corresponding to an antenna panel having the lowest rank at the first column or the last column of the codebook. For example, the codebook configuration instructions 1352 may be configured to cause a scheduled entity 1300 to implement one or more of the functions described below in relation to FIGS. 14, 15, and/or 16, including, e.g., blocks 1406, 1502, 1504, 1506, 1602, and/or 1604.

In further examples, the computer-executable code may further include CSI report configuration instructions 1354 that configure a scheduled entity 1300 for various functions, including, e.g., determining a preferred rank for each of multiple antenna panels based on a reference signal, configuring an RI indicating all ranks for multiple antenna panels, configuring an RI indicating one rank (e.g., the highest rank) for multiple antenna panels, configuring a PMI including a codebook arrangement indicator configured to indicate a position of a zero matrix of a component vector in a codebook, configuring a PMI including a codebook arrangement indicator configured to indicate a position of a zero matrix of a component vector in a codebook and multiple ranks for multiple antenna panels, and/or configuring a PMI including shared beam information for a set of antenna panels in the plurality of antenna panels for reducing the total number of single-panel PMIs in multiple single-panel PMIs. For example, the CSI report instructions 1354 may be configured to cause a scheduled entity 1300 to implement one or more of the functions described below in relation to FIGS. 14, 15, and/or 16, including, e.g., blocks 1404, 1408, 1510, 1512, 1608, and/or 1610.

In further examples, the computer-executable code may further include communication controlling instructions 1356 that configure a scheduled entity 1300 for various functions, including, e.g., receiving a reference signal, receiving a reference signal from a multi-panel array, transmitting a CSI report based on the reference signal, and/or receiving a communication (e.g., PDCCH/PDSCH). For example, the communication controlling instructions 1356 may be configured to cause a scheduled entity 1300 to implement one or more of the functions described below in relation to FIGS. 14, 15, and/or 16, including, e.g., blocks 1402, 1404, 1408, and/or 1410.

In one configuration, the apparatus 1300 for wireless communication includes means for configuring a codebook to have multiple component vectors corresponding to the highest rank among multiple ranks corresponding to multiple antenna panels, piling component vectors side-by-side, arranging a component vector including zero matrix corresponding to an antenna panel having the lowest rank among multiple ranks corresponding to multiple antenna panels at the first column or at the last column of the codebook, arranging entries of a component vector having a zero matrix to be at adjacent rows in the component vector, normalizing each component vector in the codebook to have a unit norm, stacking component vectors corresponding to multiple antenna panels, and/or adding a zero vector in a component vector corresponding to an antenna panel having the lowest rank at the first column or the last column of the codebook; means for determining a preferred rank for each of multiple antenna panels based on a reference signal, configuring an RI indicating all ranks for multiple antenna panels, configuring an RI indicating one rank (e.g., the highest rank) for multiple antenna panels, configuring a PMI including a codebook arrangement indicator configured to indicate a position of a zero matrix of a component vector in a codebook, configuring a PMI including a codebook arrangement indicator configured to indicate a position of a zero matrix of a component vector in a codebook and multiple ranks for multiple antenna panels, and/or configuring a PMI including shared beam information for a set of antenna panels in the plurality of antenna panels for reducing the total number of single-panel PMIs in multiple single-panel PMIs; and/or means for receiving a reference signal, receiving a reference signal from a multi-panel array, transmitting a CSI report based on the reference signal, and/or receiving a communication (e.g., PDCCH/PDSCH). In one aspect, the aforementioned means may be the processor(s) 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 1, 2, and/or 3, and utilizing, for example, the processes and/or algorithms described herein in relation to FIGS. 14, 15, and/or 16.

### Flow Charts

FIG. 14 is a flow chart illustrating an exemplary process 1400 for downlink communication using a multi-panel codebook in accordance with some aspects of the present disclosure. As described below, a particular implementation may omit some or all illustrated features, and may not require some illustrated features to implement all embodiments. In some examples, the scheduled entity 1300 illustrated in FIG. 13 may be configured to carry out the process 1400. In some examples, any suitable apparatus or means for carrying out the functions or algorithm described below may carry out the process 1400.

At block 1402, the scheduled entity may receive and measure a reference signal (e.g., a CSI-RS) from a multi-panel array. In some examples, the scheduled entity may determine the number of antenna panels based on physically and/or spatially separate sets of antenna elements. In some examples, an antenna panel may have an equal antenna space between adjacent antenna elements while two different antenna panels may have a panel space between the antenna panels different from the antenna space. In other examples, an antenna panel may have a different phase of antenna radiation from another antenna panel. In some instances, the scheduled entity may choose a different codebook for determining a preferred precoding matrix when the number of antenna panels is different because the number of antenna panels may correspond to the number of rows of a codebook. The scheduled entity may also measure the channel across layers (e.g., rank) based on the received CSI-RS.

At block 1404, the scheduled entity may determine a preferred rank for each of the multiple antenna panels based on the reference signal. The rank of a channel matrix is an indicator of how many data streams can be spatially multiplexed on the MIMO channel. The scheduled entity may also choose different codebooks for different ranks of multiple antenna panels. Since precoding indicates a linear combination of a precoding matrix with layers (rank), a rank may determine the number of columns of a codebook and precoding matrix. In some examples, a set of antenna panels may have a different rank from another set of antenna panels. In other examples, a set of antenna panels may have a different number of antenna ports from another set of antenna panels. Here, an antenna port is generally used as a generic term for signal transmission under identical channel conditions. In some examples, the scheduled entity may measure the number of antenna ports in each panel as follows: 2 (cross polarizations)×N₁ (number of antenna elements in the horizontal domain)×N₂ (number of antenna elements in the vertical domain).

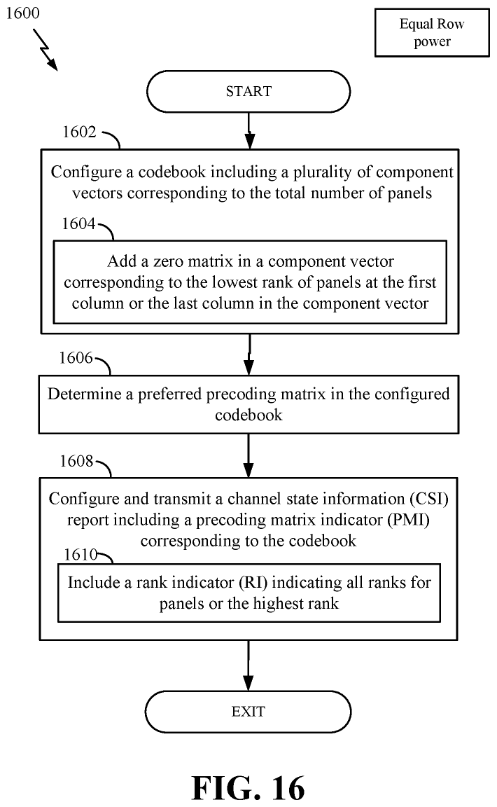

At block 1406, the scheduled entity may determine a codebook (W) and a precoding matrix in the codebook (W) based on the measured channel and the multiple ranks corresponding to multiple antenna panels. In some examples, the scheduled entity may configure a codebook for multiple antenna panels having different ranks or different numbers of antenna ports using an equal column power method (see FIG. 15) or an equal row power method (see FIG. 16). Then, the scheduled entity may select a preferred precoding matrix in the configured codebook based on the measured channel of the CSI-RS. In some examples, different ranks for different antenna panels may increase overall system throughput. Also, different numbers of ports for different antenna panels may increase system flexibility by supporting various panel deployment scenarios.

In some examples, using the equal column power method, the scheduled entity may configure the codebook by piling or aligning horizontally component vectors side-by-side. Here, the scheduled entity may normalize each component vector or column of the codebook to have a unit norm. That is, each component or column in the codebook has the equal column power. A component vector may include multiple entities that correspond to a layer (rank) in a column and correspond to multiple antenna panels in a row. The total number of component vectors in the codebook may correspond to the highest rank in the multiple ranks corresponding to multiple antenna panels. Among component vectors, the scheduled entity may place a component vector including a zero matrix corresponding to an antenna panel having the lowest rank at the first column or the last column in the codebook.

In other examples, using the equal row power method, the scheduled entity may configure the codebook by stacking or aligning vertically component vectors. Here, each component or row in the codebook has the equal row power. A component vector may correspond to a single-panel codebook. The total number of component vectors in the codebook may correspond to multiple antenna panels. Among component vectors, the scheduled entity may add a zero matrix at the first column or the last column of a component vector corresponding to an antenna panel having the lowest rank.

The scheduled entity may select a preferred precoding matrix among all precoding matrices in the configured codebook. In some examples, the preferred precoding matrix may have the maximum signal to interference and noise ratio (SINR) among all precoding matrices in the configured codebook.

At block 1408, the scheduled entity may transmit a CSI report based on the reference signal. The CSI report may include a rank indicator (RI) configured to indicate one or more ranks among the multiple ranks corresponding to the multiple antenna panels associated with the reference signal, and a precoding matrix indicator (PMI) corresponding to the configured codebook for the multiple antenna panels.

In some examples using the equal column and row power methods, the RI may indicate each rank of the multiple ranks corresponding to multiple antenna panels. That is, the RI may indicate all ranks corresponding to multiple antenna panels. When the RI indicates all ranks, in some instances, the PMI may include a codebook arrangement indicator that indicates a position of the zero matrix in the codebook. For example, the position may be at the first column or the last column of the codebook. In other examples, the RI may indicate the highest rank of the multiple ranks corresponding to multiple antenna panels. That is, the IR may indicate just one rank that is the highest rank. When the RI indicates one highest rank, in some instances, the PMI may include a codebook arrangement indicator that indicates a position of the zero matrix in the codebook and the multiple ranks for the multiple antenna panels. For example, the position may be at the first column or the last column of the codebook.

In further examples using the equal row power method, the PMI may further include multiple single-panel PMIs corresponding to multiple antenna panels. To reduce the total number of single-panel PMIs, the scheduled entity may use shared beam information when the multiple antenna panels are co-located. In some examples, the share beam information may indicate that beam index information is the same among the multiple antenna panels, beam spacing values are the same among the multiple antenna panels, and/or cross-polarization co-phasing values for multiple antenna panels are the same.

In FIG. 14, blocks 1406 and 1408 have a star to indicate that further details of some examples of this block are provided in FIGS. 15 and 16.

At block 1410, the scheduled entity may receive a downlink communication (e.g., PDCCH and/or PDSCH). A scheduling entity may transmit the downlink communication based on the scheduling entity's preferred rank and precoding matrix or any other suitable rank and precoding matrix. That is, the scheduling entity may determine whether the scheduling entity will use the preferred precoding matrix or any other suitable precoding matrix. The scheduled entity can know scheduling entity's determined precoding matrix based on the Demodulation Reference Signal (DMRS) in the downlink communication (e.g., PDCCH and/or PDSCH).

FIG. 15 is a flow chart illustrating an exemplary process 1500 for a multi-panel codebook for CSI reporting using an equal column power method in accordance with some aspects of the present disclosure. As described below, a particular implementation may omit some or all illustrated features, and may not require some illustrated features to implement all embodiments. In some examples, the scheduled entity 1300 illustrated in FIG. 13 may be configured to carry out the process 1500. In some examples, any suitable apparatus or means for carrying out the functions or algorithm described below may carry out the process 1500.

In some examples, FIG. 15 may correspond to blocks 1406 and 1408 from FIG. 14 for determining a codebook (W) and configuring a CSI report including an RI and a PMI corresponding to the codebook.

At block 1502, the scheduled entity may configure a multi-panel codebook for different ranks for different antenna panels. Since the distance between a scheduling entity and a scheduled entity is generally much longer than the panel distance, in some examples, a rank difference among multiple antenna panels can be limited to a maximum of 1 (i.e., |rₘ−rₙ|≤1, where m, n ∈ {1, 2} for two antenna panels or {1, 2, 3, 4} for four antenna panels). That is, the rank difference between the highest rank and the lowest rank in the multiple ranks corresponding to the multiple antenna panels is equal to or less than 1. In some examples, the codebook may include multiple component vectors aligned horizontally or piled side-by-side. The scheduled entity may normalize a component vector corresponding to a column of the codebook to have a unit norm. A component vector may include multiple entries vertically corresponding to a layer (rank) in column and multiple antenna panels in row. The total number of component vectors may correspond to the highest rank among multiple ranks corresponding to the multiple antenna panels. Among component vectors, a component vector may include an entry including a zero matrix. In some examples, the zero matrix may include a two-tuple zero vector

$$[ \begin{matrix}0 \\ 0\end{matrix} ] .$$

In an example, the entry including the zero matrix in the component vector may correspond to an antenna panel having the lowest rank. In a further example, the component vector including the zero matrix may be at the first column or the last column in the codebook. In further examples for four antenna panels, a component vector including a zero matrix may include four entries corresponding to four antenna panels. Among the four entries, two entries may be zero matrices. In the component vector including two zero matrices, the other two entries may correspond to two antenna panels having the highest rank and are at adjacent rows in the component vector.

In some examples for two antenna panels, a component vector may include one of three types: a component vector 1) without a zero matrix, 2) having a zero matrix in the second row corresponding to a second antenna panel, or 3) having a zero matrix in the first row corresponding to a first antenna panel. A component vector without a zero matrix may be given by:

$${W}_{l , m , p , n}^{1 , 2 , 1} = \frac{1}{\sqrt{P}} [ \begin{matrix} & [ \begin{matrix} & {v}_{l , m} \\ {θ}_{n} & {v}_{l , m}\end{matrix} ] \\ {θ}_{{p}_{1}} & [ \begin{matrix} & {v}_{l , m} \\ {φ}_{n} & {v}_{l , m}\end{matrix} ]\end{matrix} ] ,$$

$$or$$

$${W}_{l , m , ′ p , n}^{2 , 2 , 1} = \frac{1}{\sqrt{P}} [ \begin{matrix} & [ \begin{matrix} & {v}_{l , m} \\ - {φ}_{n} & {v}_{l , m}\end{matrix} ] \\ {θ}_{{p}_{1}} & [ \begin{matrix} & {v}_{l , m} \\ - {φ}_{n} & {v}_{l , m}\end{matrix} ]\end{matrix} ] .$$

A component vector having a zero matrix in the second row corresponding to a second antenna panel may be given by:

$${W}_{l , m , p , n}^{3 , 2 , 1} = \frac{1}{\sqrt{P / 2}} [ \begin{matrix}[ \begin{matrix} & {v}_{l , m} \\ {φ}_{n} & {v}_{l , m}\end{matrix} ] \\ [ \begin{matrix}0 \\ 0\end{matrix} ]\end{matrix} ] , {W}_{l , m , p , n}^{4 , 2 , 1} = \frac{1}{\sqrt{P / 2}} [ \begin{matrix}[ \begin{matrix} & {v}_{l , m} \\ - {φ}_{n} & {v}_{l , m}\end{matrix} ] \\ [ \begin{matrix}0 \\ 0\end{matrix} ]\end{matrix} ] .$$

A component vector having a zero matrix in the first row corresponding to a first antenna panel may be given by:

$${W}_{l , m , p , n}^{3 , 2 , 1} = \frac{1}{\sqrt{P / 2}} [ \begin{matrix}[ \begin{matrix}0 \\ 0\end{matrix} ] \\ {θ}_{{p}_{1}} [ \begin{matrix} & {v}_{l , m} \\ {φ}_{n} & {v}_{l , m}\end{matrix} ]\end{matrix} ] ,$$

$$or$$

$${W}_{l , m , p , n}^{6 , 2 , 1} = \frac{1}{\sqrt{P / 2}} [ \begin{matrix}[ \begin{matrix}0 \\ 0\end{matrix} ] \\ {θ}_{{p}_{1}} [ \begin{matrix} & {v}_{l , m} \\ - {φ}_{n} & {v}_{l , m}\end{matrix} ]\end{matrix} ] .$$

In some instances for different ranks for two antenna panels, the scheduled entity may configure a codebook having multiple component vectors corresponding to the highest rank. At block 1504, the scheduled entity may arrange a component vector (e.g., W_{l,m,p,n}^{3,2,1}, W_{l,m,p,n}^{4,2,1}, W_{l,m,p,n}^{5,2,1}, or W_{l,m,p,n}^{6,2,1}) having a zero matrix at the first column or the last column in the codebook. The first column may correspond to the first layer (e.g., rank 1), and the last column may correspond to the last layer (e.g., the highest rank). The codebook may also include other component vector(s) (e.g., W_{l,m,p,n}^{1,2,1}, or W_{l,m,p,n}^{2,2,1}) corresponding to other layer(s).

In other examples for four antenna panels, a component vector may include one of four types: a component vector 1) without a zero matrix, 2) having two zero matrices in the third and fourth rows corresponding to third and fourth antenna panels, 3) having two zero matrices in the first and fourth rows corresponding to first and fourth antenna panels, or 4) having two zero matrices in the first and second rows corresponding to first and second antenna panels. A component vector without a zero matrix may be given by:

$${W}_{l , m , p , n}^{1 , 4 , 1} = \frac{1}{\sqrt{P}} [ \begin{matrix} & [ \begin{matrix} & {v}_{l , m} \\ {φ}_{n} & {v}_{l , m}\end{matrix} ] \\ {θ}_{{p}_{1}} & [ \begin{matrix} & {v}_{l , m} \\ {φ}_{n} & {v}_{l , m}\end{matrix} ] \\ {θ}_{{p}_{2}} & [ \begin{matrix} & {v}_{l , m} \\ {φ}_{n} & {v}_{l , m}\end{matrix} ] \\ {θ}_{{p}_{3}} & [ \begin{matrix} & {v}_{l , m} \\ {φ}_{n} & {v}_{l , m}\end{matrix} ]\end{matrix} ] ,$$

$$or$$

$${W}_{l , m , p , n}^{2 , 4 , 1} = \frac{1}{\sqrt{P}} [ \begin{matrix} & [ \begin{matrix} & {v}_{l , m} \\ - {φ}_{n} & {v}_{l , m}\end{matrix} ] \\ {θ}_{{p}_{1}} & [ \begin{matrix} & {v}_{l , m} \\ - {φ}_{n} & {v}_{l , m}\end{matrix} ] \\ {θ}_{{p}_{2}} & [ \begin{matrix} & {v}_{l , m} \\ - {φ}_{n} & {v}_{l , m}\end{matrix} ] \\ {θ}_{{p}_{3}} & [ \begin{matrix} & {v}_{l , m} \\ - {φ}_{n} & {v}_{l , m}\end{matrix} ]\end{matrix} ] .$$

A component vector having two zero matrices in the third and fourth rows corresponding to third and fourth antenna panels may be given by:

$${W}_{l , m , p , n}^{3 , 4 , 1} = \frac{1}{\sqrt{P / 2}} [ \begin{matrix} & [ \begin{matrix} & {v}_{l , m} \\ {φ}_{n} & {v}_{l , m}\end{matrix} ] \\ {θ}_{{p}_{1}} & [ \begin{matrix} & {v}_{l , m} \\ {φ}_{n} & {v}_{l , m}\end{matrix} ] \\ & [ \begin{matrix}0 \\ 0\end{matrix} ] \\ & [ \begin{matrix}0 \\ 0\end{matrix} ]\end{matrix} ] ,$$

$$or$$

$${W}_{l , m , p , n}^{4 , 4 , 1} = \frac{1}{\sqrt{P / 2}} [ \begin{matrix} & [ \begin{matrix} & {v}_{l , m} \\ - {φ}_{n} & {v}_{l , m}\end{matrix} ] \\ {θ}_{{p}_{1}} & [ \begin{matrix} & {v}_{l , m} \\ - {φ}_{n} & {v}_{l , m}\end{matrix} ] \\ & [ \begin{matrix}0 \\ 0\end{matrix} ] \\ & [ \begin{matrix}0 \\ 0\end{matrix} ]\end{matrix} ] .$$

A component vector having two zero matrices in the first and fourth rows corresponding to first and fourth antenna panels may be given by:

$${W}_{l , m , p , n}^{5 , 4 , 1} = \frac{1}{\sqrt{P / 2}} [ \begin{matrix}[ \begin{matrix}0 \\ 0\end{matrix} ] \\ {θ}_{{p}_{1}} [ \begin{matrix} & {v}_{l , m} \\ {φ}_{n} & {v}_{l , m}\end{matrix} ] \\ {θ}_{{p}_{2}} [ \begin{matrix} & {v}_{l , m} \\ {φ}_{n} & {v}_{l , m}\end{matrix} ] \\ [ \begin{matrix}0 \\ 0\end{matrix} ]\end{matrix} ] ,$$

$$or$$

$${W}_{l , m , p , n}^{6 , 4 , 1} = \frac{1}{\sqrt{P / 2}} [ \begin{matrix}[ \begin{matrix}0 \\ 0\end{matrix} ] \\ {θ}_{{p}_{1}} [ \begin{matrix} & {v}_{l , m} \\ - {φ}_{n} & {v}_{l , m}\end{matrix} ] \\ {θ}_{{p}_{2}} [ \begin{matrix} & {v}_{l , m} \\ - {φ}_{n} & {v}_{l , m}\end{matrix} ] \\ [ \begin{matrix}0 \\ 0\end{matrix} ]\end{matrix} ] .$$

A component vector having two zero matrices in the first and second rows corresponding to first and second antenna panels may be given by:

$${W}_{l , m , p , n}^{7 , 4 , 1} = \frac{1}{\sqrt{P / 2}} [ \begin{matrix}[ \begin{matrix}0 \\ 0\end{matrix} ] \\ [ \begin{matrix}0 \\ 0\end{matrix} ] \\ {θ}_{{p}_{2}} [ \begin{matrix} & {v}_{l , m} \\ {φ}_{n} & {v}_{l , m}\end{matrix} ] \\ {θ}_{{p}_{3}} [ \begin{matrix} & {v}_{l , m} \\ {φ}_{n} & {v}_{l , m}\end{matrix} ]\end{matrix} ] ,$$

$$or$$

$${W}_{l , m , p , n}^{8 , 4 , 1} = \frac{1}{\sqrt{P / 2}} [ \begin{matrix}[ \begin{matrix}0 \\ 0\end{matrix} ] \\ [ \begin{matrix}0 \\ 0\end{matrix} ] \\ {θ}_{{p}_{2}} [ \begin{matrix} & {v}_{l , m} \\ - {φ}_{n} & {v}_{l , m}\end{matrix} ] \\ {θ}_{{p}_{3}} [ \begin{matrix} & {v}_{l , m} \\ - {φ}_{n} & {v}_{l , m}\end{matrix} ]\end{matrix} ] .$$

In some instances for different ranks for four antenna panels, the scheduled entity may configure a codebook having multiple component vectors corresponding to the highest rank. At block 1504, the scheduled entity may arrange a component vector (e.g., having two zero matrices at the first column or the last column in the codebook. The first column in the codebook may correspond to the first layer (e.g., rank 1), and the last column in the codebook may correspond to the last layer (e.g., the highest rank). At block 1506, the scheduled entity may arrange entries of a component vector having two zero matrices. For example, the scheduled entity may arrange two entries corresponding to two antenna panels having the highest rank to be adjacent each other. The codebook may also include other component vectors (e.g., W_{l,m,p,n}^{1,2,1}, or W_{l,m,p,n}^{2,2,1}) corresponding to other layers.

At block 1508, the scheduled entity may determine a preferred precoding matrix in the configured codebook. For example, the scheduled entity may calculate the SINR on all precoding matrices in the configured codebook based on the measured channel conditions by the CSI-RS. In some examples, the scheduled entity may select the best precoding matrix having the highest SINR. It should be appreciated that the scheduled entity may select scheduled entity's preferred precoding matrix based on any other suitable parameter.

At block 1510, the scheduled entity may configure and transmit a CSI report including a precoding matrix indicator (PMI) and an RI.

At block 1512, in some examples, the RI may include each rank of multiple ranks corresponding to multiple antenna panels (i.e., RI=(r₁, . . . , rₙ)). Then, the PMI may include a codebook arrangement indicator (i₃) for indicating a position of a component vector including a zero matrix. That is, the codebook arrangement indicator may indicate whether the component vector including the zero matrix is at the first column or the last column of the codebook. In some examples, an exemplary codebook may be given by: Wᵢ_{_{1,1}}_{^{, i}}_{1,1}_{^{+k}}₁_{^{,i}}_{1,2}_{^{,i}}_{_{1,2}}_{^{+k}}₂_{^{,i}}_{1,4}_{^{,i}}₂^{(r}₁,r₂,i₃₎ for two antenna panels and Wᵢ_{_{1,1}}_{^{, i}}_{1,1}_{^{+k}}₁_{^{,i}}_{1,2}_{^{,i}}_{_{1,2}}_{^{+k}}₂_{^{,i}}_{1,4}_{^{,i}}₂^{(r}₁,r₂,r₃,r₄,i₃₎ for four antenna panels. Here, r₁, r₂, r₃, and r₄ may indicate a first rank for a first panel, a second rank for a second panel, a third rank for a third panel, and a fourth rank for a fourth panel. When ranks are not the same (i.e., rₘ≠rₙ where m, n ∈ {1, 2} for two antenna panels and {1, 2, 3, 4} for four antenna panels), the codebook can indicate which row of the codebook includes a zero matrix. In addition, i₃ may indicate the codebook arrangement indicator. In some examples, when i₃ is 0, a component vector including a zero matrix is at the last column of the codebook, while when i₃ is 1, a component vector including a zero matrix is at the first column of the codebook. It should be appreciated that the value of i₃ is a mere example. i₃ may be any other suitable symbol or value indicating the position of the zero matrix in the codebook. In further examples, the PMI may further include a multi-panel PMI (i_{1,1}, i_{1,1}+k₁, i_{1,2}, i_{1,2}+k₂, i_{1,4}, and i₂). In some examples, i_{1,1} may refer to a horizontal beam index, i_{1,2} to a vertical beam index, i_{1,4} to a panel co-phasing indicator, i₂ to a cross-polarization co-phasing indicator, k₁ to a horizontal beam separation factor for different layers, k₂ to a vertical beam separation factor for different layers.

At block 1512, in other examples, the RI may include one rank of multiple ranks corresponding to multiple antenna panels. In some instances, the RI may indicate the highest rank in multiple ranks corresponding to multiple antenna panels (i.e., RI=max (r₁, . . . , rₙ)). Then, the PMI may include a codebook arrangement indicator for indicating a position of a component vector including a zero matrix and multiple ranks corresponding to the multiple antenna panels. That is, the codebook arrangement indicator may indicate 1) which row of the codebook includes the zero matrix and 2) whether the component vector including the zero matrix is at the first column or the last column of the codebook. In some examples, an exemplary codebook may be given by: Wᵢ_{_{1,1}}_{^{,i}}_{1,1}_{^{+k}}₁_{^{,i}}_{1,2}_{^{,i}}_{1,2}_{^{+k}}₂_{^{,i}}_{1,4}_{^{,i}}₂^{(r}ₘₐₓ,i₃₎ for two and four antenna panels. Here, rₘₐₓ may indicate the highest rank among multiple ranks corresponding to multiple antenna panels.

In addition, i₃ may indicate the codebook arrangement indicator. In some examples for two antenna panels, i₃ may indicate one or five codebooks. For example, when i₃ is 0, a component vector including a zero matrix is at the last column of the codebook, and the zero matrix is at the second row corresponding to panel 2 having the lowest rank. When i₃ is 1, a component vector including a zero matrix is at the first column of the codebook, and the zero matrix is at the second row corresponding to panel 2 having the lowest rank. When i₃ is 2, a component vector including a zero matrix is at the last column of the codebook, and the zero matrix is at the first row corresponding to panel 1 having the lowest rank. When i₃ is 3, a component vector including a zero matrix is at the first column of the codebook, and the zero matrix is at the first row corresponding to panel 1 having the lowest rank. When i₃ is 4, there is no component vector including a zero matrix in the codebook (i.e., r₁=r₂).

In other examples for four antenna panels, i₃ may indicate one or seven codebooks. For example, when i₃ is 0, a component vector including two zero matrices is at the last column of the codebook, and the two zero matrices are at the first and second rows corresponding to panels 1 and 2 having the lowest rank. When i₃ is 1, a component vector including two zero matrices is at the first column of the codebook, and the two zero matrices are at the first and second rows corresponding to panels 1 and 4 having the lowest rank. When i₃ is 2, a component vector including two zero matrices is at the last column of the codebook, and the two zero matrices are at the first and fourth rows corresponding to panels 1 and 4 having the lowest rank. When i₃ is 3, a component vector including two zero matrices is at the first column of the codebook, and the two zero matrices are at the first and fourth rows corresponding to panels 1 and 4 having the lowest rank. When i₃ is 4, a component vector including two zero matrices is at the last column of the codebook, and the two zero matrices are at the third and fourth rows corresponding to panels 3 and 4 having the lowest rank. When i₃ is 5, a component vector including two zero matrices is at the first column of the codebook, and the two zero matrices are at the third and fourth rows corresponding to panels 3 and 4 having the lowest rank. When i₃ is 6, there is no component vector including two zero matrices (i.e., r₁=r₂=r₃=r₄). It should be appreciated that the value of i₃ is a mere example. i₃ may be any other suitable symbol or value indicating the position of the zero matrix in the codebook.

In further examples for two and four antenna panels, the PMI may further include a multi-panel PMI (i_{1,1}, i_{1,1}+k₁, i_{1,2}i_{1,2}+k₂, i_{1,4}, and i₂) as described in all-rank reporting above.

FIG. 16 is a flow chart illustrating an exemplary process 1600 for multi-panel codebook using an equal row power method in accordance with some aspects of the present disclosure. As described below, a particular implementation may omit some or all illustrated features, and may not require some illustrated features to implement all embodiments. In some examples, the scheduled entity 1300 illustrated in FIG. 13 may be configured to carry out the process 1500. In some examples, any suitable apparatus or means for carrying out the functions or algorithm described below may carry out the process 1500.

In some examples, FIG. 16 may correspond to blocks 1406 and 1408 from FIG. 14 for determining a codebook (W) and configuring a CSI report including an RI and a PMI corresponding to the codebook.

At block 1602, the scheduled entity may configure a multi-panel codebook for different ranks for different antenna panels or different numbers of antenna ports for multiple antenna panels. For the same reason in the same column power method in FIG. 15, a rank difference among multiple antenna panels can be limited to a maximum of 1 (i.e., |rₘ−rₙ|≤1, where m, n ∈ {1, 2} for two antenna panels or {1, 2, 3, 4} for four antenna panels). In some examples, the codebook may include multiple component vectors aligned or stacked vertically. The scheduled entity may normalize a component vector corresponding to a row of the codebook to have a unit norm. The total number of component vectors may correspond to the total number of antenna panels. Each component vector may indicate a single-panel type I codebook for a respective antenna panel having P/2 ports for two antenna panels and P/4 ports for four antenna panels. Here, P may indicate the number of ports for the CSI-RS (i.e., 2 (cross polarizations of an antenna element)×N_{g} (number of antenna panels)×N₁ (number of antenna elements in the horizontal domain)×N₂ (number of antenna elements in the vertical domain)). When ranks for corresponding antenna panels are not the same (i.e., rₘ≠rₙ, where m, n ∈ {1, 2} for two antenna panels and {1, 2, 3, 4} for four antenna panels), the scheduled entity may configure a multi-panel codebook by adding a zero matrix in a component vector corresponding to an antenna panel having the lowest rank at the first column or the last column in the codebook.

In some examples for two antenna panels, a multi-panel codebook for a general rank (r) may be one of three types (r₁, r₂)=(r, r), (r−1, r), or (r, r-1) (total 5 possible codebooks): 1)

$$W = \frac{1}{\sqrt{2}} [ \begin{matrix} & {V}_{1} \\ {θ}_{p} & {V}_{2}\end{matrix} ]$$

where (r₁, r₂)=(r, r), 2)

$$W = \frac{1}{\sqrt{2}} [ \begin{matrix}{V}_{1} & 0 \\ {θ}_{p} & {V}_{2}\end{matrix} ] or W = \frac{1}{\sqrt{2}} [ \begin{matrix}0 & {V}_{1} \\ {θ}_{p} & {V}_{2}\end{matrix} ]$$

where (r₁, r₂)=(r−1, r), or 3)

$$W = \frac{1}{\sqrt{2}} [ \begin{matrix} & {V}_{1} & \\ {θ}_{p} & {V}_{2} & 0\end{matrix} ] or W = \frac{1}{\sqrt{2}} [ \begin{matrix} & & {V}_{1} \\ 0 & {θ}_{p} & {V}_{2}\end{matrix} ]$$

where (r₁, r₂)=(r, r−1). Here, V₁ and V₂ are r₁-layer and r₂- layer (P/2)-port type-I single-panel codebooks, 0 is a zero matrix including a P/2-tuple zero vector, and φₚ is a co-phasing value between two antenna panels. In other examples for four antenna panels, a multi-panel codebook for a general rank (r) may be one of four types: (r₁, r₂, r₃, r₄)=(r, r,r, r), (r−1, r−1, r, r) (r, r, r−1, r−1), or (r−1, r, r, r−1) (total 7 possible codebooks): 1)

$$W = \frac{1}{\sqrt{4}} [ \begin{matrix} & {V}_{1} \\ {θ}_{{p}_{1}} & {V}_{2} \\ {θ}_{{p}_{2}} & {V}_{3} \\ {θ}_{{p}_{3}} & {V}_{3}\end{matrix} ]$$

where (r₁, r₂, r₃, r₄)=(r, r, r, r), 2)

$$W = \frac{1}{\sqrt{4}} [ \begin{matrix} & {V}_{1} & 0 \\ {θ}_{{p}_{1}} & {V}_{2} & 0 \\ {θ}_{{p}_{2}} & {V}_{3} & \\ {θ}_{{p}_{3}} & {V}_{4} & \end{matrix} ] or W = \frac{1}{\sqrt{4}} [ \begin{matrix}0 & & {V}_{1} \\ 0 & {θ}_{{p}_{1}} & {V}_{2} \\ & {θ}_{{p}_{2}} & {V}_{3} \\ & {θ}_{{p}_{3}} & {V}_{4}\end{matrix} ]$$

where (r₁, r₂, r₃, r₄)=(r−1, r−1, r, r), 3)

$$W = \frac{1}{\sqrt{4}} [ \begin{matrix} & {V}_{1} & \\ {θ}_{{p}_{1}} & {V}_{2} & \\ {θ}_{{p}_{2}} & {V}_{3} & 0 \\ {θ}_{{p}_{3}} & {V}_{4} & 0\end{matrix} ] or W = \frac{1}{\sqrt{4}} [ \begin{matrix} & & {V}_{1} \\ & {θ}_{{p}_{1}} & {V}_{2} \\ 0 & {θ}_{{p}_{2}} & {V}_{3} \\ 0 & {θ}_{{p}_{3}} & {V}_{4}\end{matrix} ]$$

where (r₁, r₂, r₃, r₄)=(r, r, r−1, r−1), or

$$W = 4 ) \frac{1}{\sqrt{4}} [ \begin{matrix} & {V}_{1} & \\ {θ}_{{p}_{1}} & {V}_{2} & 0 \\ {θ}_{{p}_{2}} & {V}_{3} & 0 \\ {θ}_{{p}_{3}} & {V}_{4} & \end{matrix} ] or W = \frac{1}{\sqrt{4}} [ \begin{matrix} & & {V}_{1} \\ 0 & {θ}_{{p}_{1}} & {V}_{2} \\ 0 & {θ}_{{p}_{2}} & {V}_{3} \\ & {θ}_{{p}_{3}} & {V}_{4}\end{matrix} ]$$

where (r₁, r₂, r₃, r₄)=(r−1, r, r, r−1). Here, V₁, V₂, V₃, and V₄ are r₁-layer, 2-layer, r₃-layer, and r₄-layer (P/4)-port type-I single-panel codebooks, respectively, 0 is a zero matrix including a P/4-tuple zero vector, and θₚ_{₁}, θₚ_{₂}, and θₚ_{₃} are co-phasing values among four antenna panels.

At block 1606, the scheduled entity may determine a preferred precoding matrix in the configured codebook. For example, the scheduled entity may calculate the SINR on all precoding matrices in the configured codebook based on the measured channel conditions by the CSI-RS. In some examples, the scheduled entity may select the best precoding matrix having the highest SINR. It should be appreciated that the scheduled entity may select scheduled entity's preferred precoding matrix based on any other suitable parameter.

At block 1608, the scheduled entity may configure and transmit a CSI report including a precoding matrix indicator (PMI) and an RI.

At block 1610, in some examples, the RI may include each rank of multiple ranks corresponding to multiple antenna panels (i.e., RI=(r₁, . . . , rₙ)). Then, the PMI may include a codebook arrangement indicator for indicating a position of a zero matrix. That is, the codebook arrangement indicator may indicate whether the component vector including the zero matrix is at the first column or the last column of the codebook. In some examples, the codebook arrangement indicator my further indicate co-phasing value(s) (e.g., θₚ for two antenna panels and θₚ_{₁}, θₚ_{₂}, and θₚ_{₃} for four antenna panels). In further examples, the PMI may further include multiple single-panel PMIs corresponding to multiple antenna panels (e.g., i_{1,1}⁽¹⁾ . . . i_{1,1}⁽ⁿ⁾, i_{1,2}⁽¹⁾ . . . i_{1,2}⁽ⁿ⁾, i_{1,3}⁽¹⁾ . . . i_{1,3}⁽ⁿ⁾, and/or i₂⁽¹⁾ . . . i₂⁽ⁿ⁾ as described above in FIG. 15). Thus, for n-panel codebook using the equal row power method, there are n single-panel PMIs.

In further examples, the scheduled entity may reduce the number of multiple single-panel PMIs in the PMI using shared beam information when the multiple antenna panels are co-located. For example, shared beam information 1212 may indicate that single beam index information can be reported for different antenna panels. Also, shared beam information 1212 may indicate that beam spacing values (k₁, k₂) indicated by i_{1,3} are the same between different antenna panels. Alternatively, shared beam information may indicate that i_{1,3} of single-panel PMIs are the same. In addition, shared beam information may indicate that cross-polarization co-phasing values for multiple antenna panels are the same between antenna panels.

At block 1610, in other examples, the RI may include one rank of multiple ranks corresponding to multiple antenna panels as described in FIG. 15. In some instances, the RI may indicate the highest rank in multiple ranks corresponding to multiple antenna panels (i.e., RI=max (r₁, . . . , rₙ)). Then, the PMI may include a codebook arrangement indicator indicating one of five codebooks for two antenna panels and one of seven codebooks for four antenna panels. Thus, the codebook arrangement indication may indicate which row includes a zero matrix and the position of the zero matrix in a component vector corresponding to an antenna panel having the lowest rank. In further examples, the PMI may further include multiple single-panel PMIs corresponding to multiple antenna panels (e.g., i_{1,1}⁽¹⁾ . . . i_{1,1}⁽ⁿ⁾, i_{1,2}⁽¹⁾ . . . i_{1,2}⁽ⁿ⁾, i_{1,3}⁽¹⁾ . . . i_{1,3}⁽ⁿ⁾, and/or i₂⁽¹⁾ . . . i₂⁽ⁿ⁾ as described above in all-rank reporting). Similar to all-ranking reporting using the equal row power method, the scheduled entity may reduce the number of multiple single-panel PMIs in the PMI using shared beam information when the multiple antenna panels are co-located.

In some examples, the scheduling entity may transmit a CSI-RS from multiple antenna panels having different numbers of antenna ports. The scheduled entity may configure a codebook for multiple antenna panels with different numbers of ports using the equal row power method. For example, when a CSI-RS is transmitted through P-port CSI-RS resources on multiple (N_{g}) panels, a scheduled entity may configure a heterogeneous-panel codebook using P₁-port, P₂-port, . . . , and P_{N}_{_{g}}-port single-panel codebooks, where Pᵢ-port panel may have antenna configuration (N₁⁽ⁱ⁾, N₂⁽ⁱ⁾) and Σᵢ₋₁^{N}_{g}Pᵢ=P. Here, a first set of antenna panels among N_{g} panels may have a different number of antenna ports from a second set of antenna panels among N_{g} panels. In some examples, the scheduled entity may receive heterogeneous panel information indicating port configuration per antenna panel. For the similar reason as a multi-panel codebook using the same column power, a rank difference between ranks for heterogeneous multiple panels may be practically limited to a maximum of 1 (e.g., |rₘ−rₙ↑≤1, where m, n ∈ {1, 2} for two antenna panels and {1, 2, 3, 4} for four antenna panels). For heterogeneous panels, multiple ranks corresponding to the heterogeneous panels might be the same to each other. The scheduled entity may configure a multi-panel codebook and a CSI report using the equal row power method described above. The difference between a codebook for the heterogeneous panels and a codebook for the homogeneous panels is that for the heterogeneous panels, each component vector corresponding ith row may include rᵢ-layer Pᵢ-port single-panel codebook.

### Further Examples Having a Variety of Features

Example 1: A method, apparatus, and non-transitory computer-readable medium for wireless communication operable at a scheduled entity, comprising: receiving a reference signal; and transmitting a channel state information (CSI) report based on the reference signal, the CSI report comprising: a rank indicator configured to indicate one or more ranks among a plurality of ranks corresponding to a plurality of antenna panels associated with the reference signal, a first rank of the plurality of ranks being different from a second rank of the plurality of ranks, and a precoding matrix indicator (PMI) corresponding to a codebook for the plurality of antenna panels.

Example 2: The method, apparatus, and non-transitory computer-readable medium of Example 1, wherein the codebook comprises a plurality of component vectors, and wherein each component vector of a plurality of component vectors is normalized to have a unit norm.

Example 3: The method, apparatus, and non-transitory computer-readable medium of any of Examples 1 to 2, wherein a total number of component vectors in the plurality of component vectors corresponds to a highest rank among the plurality of ranks.

Example 4: The method, apparatus, and non-transitory computer-readable medium of any of Examples 1 to 3, wherein a rank difference between a highest rank and a lowest rank in the plurality of ranks is one (1).

Example 5: The method, apparatus, and non-transitory computer-readable medium of any of Examples 1 to 4, wherein a first component vector of the plurality of component vectors comprises a plurality of entries corresponding to the plurality of antenna panels, wherein a first entry of the plurality of entries of the first component vector corresponds to a first antenna panel of the plurality of antenna panels, wherein the first antenna panel corresponds to the lowest rank, and wherein the first entry comprises a zero matrix.

Example 6: The method, apparatus, and non-transitory computer-readable medium of any of Examples 1 to 5, wherein the first component vector corresponding to the first entry is at a first column or a last column in the codebook.

Example 7: The method, apparatus, and non-transitory computer-readable medium of any of Examples 1 to 6, wherein at least two entries in the plurality of entries of the first component vector correspond to the highest rank, and wherein the at least two entries are at adjacent rows in the first component vector.

Example 8: The method, apparatus, and non-transitory computer-readable medium of any of Examples 1 to 7, wherein the one or more ranks comprises each rank of the plurality of ranks for the plurality of antenna panels, and wherein the PMI comprises a codebook arrangement indicator configured to indicate a position of the first entry of the first component vector in the codebook.

Example 9: The method, apparatus, and non-transitory computer-readable medium of any of Examples 1 to 8, wherein the one or more ranks consists of a one rank, and wherein the PMI comprises a codebook arrangement indicator configured to indicate a position of the first entry of the first component vector in the codebook, and the plurality of ranks for the plurality of antenna panels.

Example 10: The method, apparatus, and non-transitory computer-readable medium of any of Examples 1 to 9, wherein the one rank is the highest rank.

Example 11: The method, apparatus, and non-transitory computer-readable medium of any of Examples 1 to 10, wherein the codebook comprises a plurality of component vectors, wherein the plurality of component vectors corresponds to the plurality of antenna panels, wherein a second component vector of the plurality of component vectors corresponds to a second antenna panel of the plurality of antenna panels, wherein the second antenna panel corresponds to a lowest rank, and wherein the second component vector further comprises a zero matrix.

Example 12: The method, apparatus, and non-transitory computer-readable medium of any of Examples 1 to 11, wherein the zero matrix is at a first column or a last column in the second component vector.

Example 13: The method, apparatus, and non-transitory computer-readable medium of any of Examples 1 to 12, wherein the one or more ranks are the plurality of ranks for the plurality of antenna panels, and wherein the PMI comprises a codebook arrangement indicator configured to indicate the codebook based on a position of the zero matrix of the second component vector in the codebook.

Example 14: The method, apparatus, and non-transitory computer-readable medium of any of Examples 1 to 13, wherein the PMI further comprises a plurality of single-panel PMIs corresponding to the plurality of component vectors.

Example 15: The method, apparatus, and non-transitory computer-readable medium of any of Examples 1 to 14, wherein the PMI further comprises shared beam information for a set of antenna panels in the plurality of antenna panels, for reducing a total number of single-panel PMIs in the plurality of single-panel PMIs.

Example 16: The method, apparatus, and non-transitory computer-readable medium of any of Examples 1 to 15, wherein the one or more ranks consist of a highest rank of the plurality of ranks, and

wherein the PMI comprises a codebook arrangement indicator configured to indicate a position of the zero matrix in the codebook and the plurality of ranks for the plurality of antenna panels.

Example 17: The method, apparatus, and non-transitory computer-readable medium of any of Examples 1 to 16, wherein the PMI further comprises a plurality of single-panel PMIs corresponding to the plurality of component vectors.

Example 18: A method, apparatus, and non-transitory computer-readable medium of wireless communication operable at a scheduled entity, comprising: receiving a reference signal; and transmitting a channel state information (CSI) report based on the reference signal, the CSI report comprising: a rank indicator configured to indicate one or more ranks among a plurality of ranks corresponding to a plurality of antenna panels associated with the reference signal, and a precoding matrix indicator (PMI) corresponding to a codebook for the plurality of antenna panels, a first antenna panel of the plurality of antenna panels having a different number of antenna ports than a second antenna panel of the plurality of antenna panels.

Example 19: The method, apparatus, and non-transitory computer-readable medium of Example 18, wherein the codebook comprises a plurality of component vectors, wherein the plurality of component vectors corresponds to the plurality of antenna panels, wherein a first component vector of the plurality of component vectors corresponds to a lowest-rank antenna panel of the plurality of antenna panels, wherein the lowest-rank antenna panel corresponds to a lowest rank of the plurality of ranks, and wherein the first component vector further comprises a zero matrix.

Example 20: The method, apparatus, and non-transitory computer-readable medium of any of Examples 18 to 19, wherein the zero matrix is at a first column or a last column in the first component vector.

Example 21: The method, apparatus, and non-transitory computer-readable medium of any of Examples 18 to 20, wherein the channel state information report further comprises antenna port information for the plurality of antenna panels, and wherein the PMI comprises a codebook arrangement indicator configured to indicate a position of the zero matrix in the codebook.

Example 22: The method, apparatus, and non-transitory computer-readable medium of any of Examples 18 to 21, wherein the PMI further comprises a plurality of single-panel PMIs corresponding to the plurality of component vectors.

Example 23: The method, apparatus, and non-transitory computer-readable medium of any of Examples 18 to 22, wherein the PMI further comprises shared beam information for a set of antenna panels in the plurality of antenna panels, for reducing a total number of single-panel PMIs in the plurality of single-panel PMIs.

Example 31: A apparatus for wireless communication operable at a scheduled entity, comprising: means for receiving a reference signal; and means for transmitting a channel state information (CSI) report based on the reference signal, the CSI report comprising: a rank indicator configured to indicate one or more ranks among a plurality of ranks corresponding to a plurality of antenna panels associated with the reference signal, a first rank of the plurality of ranks being different from a second rank of the plurality of ranks, and a precoding matrix indicator (PMI) corresponding to a codebook for the plurality of antenna panels.

Example 32: The apparatus of Example 31, wherein the codebook comprises a plurality of component vectors, and wherein each component vector of a plurality of component vectors is normalized to have a unit norm.

Example 33: The apparatus of any of Examples 31 to 32, wherein a total number of component vectors in the plurality of component vectors corresponds to a highest rank among the plurality of ranks.

Example 34: The apparatus of any of Examples 31 to 33, wherein a rank difference between a highest rank and a lowest rank in the plurality of ranks is one (1).

Example 35: The apparatus of any of Examples 31 to 34, wherein a first component vector of the plurality of component vectors comprises a plurality of entries corresponding to the plurality of antenna panels, wherein a first entry of the plurality of entries of the first component vector corresponds to a first antenna panel of the plurality of antenna panels, wherein the first antenna panel corresponds to the lowest rank, and wherein the first entry comprises a zero matrix.

Example 36: The apparatus of any of Examples 31 to 35, wherein the first component vector corresponding to the first entry is at a first column or a last column in the codebook.

Example 37: The apparatus of any of Examples 31 to 36, wherein at least two entries in the plurality of entries of the first component vector correspond to the highest rank, and wherein the at least two entries are at adjacent rows in the first component vector.

Example 38: The apparatus of any of Examples 31 to 37, wherein the one or more ranks comprises each rank of the plurality of ranks for the plurality of antenna panels, and wherein the PMI comprises a codebook arrangement indicator configured to indicate a position of the first entry of the first component vector in the codebook.

Example 39: The apparatus of any of Examples 31 to 38, wherein the one or more ranks consists of a one rank, and wherein the PMI comprises a codebook arrangement indicator configured to indicate a position of the first entry of the first component vector in the codebook, and the plurality of ranks for the plurality of antenna panels.

Example 40: The apparatus of any of Examples 31 to 39, wherein the one rank is the highest rank.

Example 41: The apparatus of any of Examples 31 to 40, wherein the codebook comprises a plurality of component vectors, wherein the plurality of component vectors corresponds to the plurality of antenna panels, wherein a second component vector of the plurality of component vectors corresponds to a second antenna panel of the plurality of antenna panels, wherein the second antenna panel corresponds to a lowest rank, and wherein the second component vector further comprises a zero matrix.

Example 42: The apparatus of any of Examples 31 to 41, wherein the zero matrix is at a first column or a last column in the second component vector.

Example 43: The apparatus of any of Examples 31 to 42, wherein the one or more ranks are the plurality of ranks for the plurality of antenna panels, and wherein the PMI comprises a codebook arrangement indicator configured to indicate the codebook based on a position of the zero matrix of the second component vector in the codebook.

Example 44: The apparatus of any of Examples 31 to 43, wherein the PMI further comprises a plurality of single-panel PMIs corresponding to the plurality of component vectors.

Example 45: The apparatus of any of Examples 31 to 44, wherein the PMI further comprises shared beam information for a set of antenna panels in the plurality of antenna panels, for reducing a total number of single-panel PMIs in the plurality of single-panel PMIs.

Example 46: The apparatus of any of Examples 31 to 45, wherein the one or more ranks consist of a highest rank of the plurality of ranks, and

wherein the PMI comprises a codebook arrangement indicator configured to indicate a position of the zero matrix in the codebook and the plurality of ranks for the plurality of antenna panels.

Example 47: The apparatus of any of Examples 31 to 46, wherein the PMI further comprises a plurality of single-panel PMIs corresponding to the plurality of component vectors.

Example 48: A apparatus of wireless communication operable at a scheduled entity, comprising: means for receiving a reference signal; and means for transmitting a channel state information (CSI) report based on the reference signal, the CSI report comprising: a rank indicator configured to indicate one or more ranks among a plurality of ranks corresponding to a plurality of antenna panels associated with the reference signal, and a precoding matrix indicator (PMI) corresponding to a codebook for the plurality of antenna panels, a first antenna panel of the plurality of antenna panels having a different number of antenna ports than a second antenna panel of the plurality of antenna panels.

Example 49: The apparatus of Example 48, wherein the codebook comprises a plurality of component vectors, wherein the plurality of component vectors corresponds to the plurality of antenna panels, wherein a first component vector of the plurality of component vectors corresponds to a lowest-rank antenna panel of the plurality of antenna panels, wherein the lowest-rank antenna panel corresponds to a lowest rank of the plurality of ranks, and wherein the first component vector further comprises a zero matrix.

Example 50: The apparatus of any of Examples 48 to 49, wherein the zero matrix is at a first column or a last column in the first component vector.

Example 51: The apparatus of any of Examples 48 to 50, wherein the channel state information report further comprises antenna port information for the plurality of antenna panels, and wherein the PMI comprises a codebook arrangement indicator configured to indicate a position of the zero matrix in the codebook.

Example 52: The apparatus of any of Examples 48 to 51, wherein the PMI further comprises a plurality of single-panel PMIs corresponding to the plurality of component vectors.

Example 53: The apparatus of any of Examples 48 to 52, wherein the PMI further comprises shared beam information for a set of antenna panels in the plurality of antenna panels, for reducing a total number of single-panel PMIs in the plurality of single-panel PMIs.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP. such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication operable at a scheduled entity, comprising:
receiving a reference signal; and
transmitting a channel state information (CSI) report based on the reference signal, the CSI report comprising:
a rank indicator configured to indicate one or more ranks among a plurality of ranks corresponding to a plurality of antenna panels associated with the reference signal, a first rank of the plurality of ranks being different from a second rank of the plurality of ranks, and
a precoding matrix indicator (PMI) corresponding to a codebook for the plurality of antenna panels.

2. The method of claim 1, wherein the codebook comprises a plurality of component vectors, and
wherein each component vector of a plurality of component vectors is normalized to have a unit norm.

3. The method of claim 2, wherein a total number of component vectors in the plurality of component vectors corresponds to a highest rank among the plurality of ranks.

4. The method of claim 2, wherein a rank difference between a highest rank and a lowest rank in the plurality of ranks is one (1).

5. The method of claim 4, wherein a first component vector of the plurality of component vectors comprises a plurality of entries corresponding to the plurality of antenna panels,
wherein a first entry of the plurality of entries of the first component vector corresponds to a first antenna panel of the plurality of antenna panels,
wherein the first antenna panel corresponds to the lowest rank, and
wherein the first entry comprises a zero matrix.

6. The method of claim 5, wherein the first component vector corresponding to the first entry is at a first column or a last column in the codebook.

7. The method of claim 5, wherein at least two entries in the plurality of entries of the first component vector correspond to the highest rank, and
wherein the at least two entries are at adjacent rows in the first component vector.

8. The method of claim 5, wherein the one or more ranks comprises each rank of the plurality of ranks for the plurality of antenna panels, and
wherein the PMI comprises a codebook arrangement indicator configured to indicate a position of the first entry of the first component vector in the codebook.

9. The method of claim 5, wherein the one or more ranks consists of a one rank, and
wherein the PMI comprises a codebook arrangement indicator configured to indicate a position of the first entry of the first component vector in the codebook, and the plurality of ranks for the plurality of antenna panels.

10. The method of claim 9, wherein the one rank is the highest rank.

11. The method of claim 1, wherein the codebook comprises a plurality of component vectors,
wherein the plurality of component vectors corresponds to the plurality of antenna panels,
wherein a second component vector of the plurality of component vectors corresponds to a second antenna panel of the plurality of antenna panels,
wherein the second antenna panel corresponds to a lowest rank, and
wherein the second component vector further comprises a zero matrix.

12. The method of claim 11, wherein the zero matrix is at a first column or a last column in the second component vector.

13. The method of claim 11, wherein the one or more ranks are the plurality of ranks for the plurality of antenna panels, and
wherein the PMI comprises a codebook arrangement indicator configured to indicate the codebook based on a position of the zero matrix of the second component vector in the codebook.

14. The method of claim 13, wherein the PMI further comprises a plurality of single-panel PMIs corresponding to the plurality of component vectors.

15. The method of claim 14, wherein the PMI further comprises shared beam information for a set of antenna panels in the plurality of antenna panels, for reducing a total number of single-panel PMIs in the plurality of single-panel PMIs.

16. The method of claim 11, wherein the one or more ranks consist of a highest rank of the plurality of ranks, and
wherein the PMI comprises a codebook arrangement indicator configured to indicate a position of the zero matrix in the codebook and the plurality of ranks for the plurality of antenna panels.

17. The method of claim 16, wherein the PMI further comprises a plurality of single-panel PMIs corresponding to the plurality of component vectors.

18. A method of wireless communication operable at a scheduled entity, comprising:
receiving a reference signal; and
transmitting a channel state information (CSI) report based on the reference signal, the CSI report comprising:
a rank indicator configured to indicate one or more ranks among a plurality of ranks corresponding to a plurality of antenna panels associated with the reference signal, and
a precoding matrix indicator (PMI) corresponding to a codebook for the plurality of antenna panels, a first antenna panel of the plurality of antenna panels having a different number of antenna ports than a second antenna panel of the plurality of antenna panels.

19. The method of claim 18, wherein the codebook comprises a plurality of component vectors,
wherein the plurality of component vectors corresponds to the plurality of antenna panels,
wherein a first component vector of the plurality of component vectors corresponds to a lowest-rank antenna panel of the plurality of antenna panels,
wherein the lowest-rank antenna panel corresponds to a lowest rank of the plurality of ranks, and
wherein the first component vector further comprises a zero matrix.

20. The method of claim 19, wherein the zero matrix is at a first column or a last column in the first component vector.

21. The method of claim 20, wherein the CSI report further comprises antenna port information for the plurality of antenna panels, and
wherein the PMI comprises a codebook arrangement indicator configured to indicate a position of the zero matrix in the codebook.

22. The method of claim 21, wherein the PMI further comprises a plurality of single-panel PMIs corresponding to the plurality of component vectors.

23. The method of claim 22, wherein the PMI further comprises shared beam information for a set of antenna panels in the plurality of antenna panels, for reducing a total number of single-panel PMIs in the plurality of single-panel PMIs.

24. An apparatus for wireless communication, comprising:
a processor;
a transceiver communicatively coupled to the processor; and
a memory communicatively coupled to the processor,
wherein the apparatus is configured to:
receive a reference signal; and
transmit a channel state information (CSI) report based on the reference signal, the CSI report comprising:
a rank indicator configured to indicate one or more ranks among a plurality of ranks corresponding to a plurality of antenna panels associated with the reference signal, a first rank of the plurality of ranks being different from a second rank of the plurality of ranks, and
a precoding matrix indicator (PMI) corresponding to a codebook for the plurality of antenna panels.

25. The apparatus of claim 24, wherein the codebook comprises a plurality of component vectors, and
wherein each component vector of a plurality of component vectors is normalized to have a unit norm.

26. The apparatus of claim 25, wherein a rank difference between a highest rank and a lowest rank in the plurality of ranks is one (1),
wherein a first component vector of the plurality of component vectors comprises a plurality of entries corresponding to the plurality of antenna panels,
wherein a first entry of the plurality of entries of the first component vector corresponds to a first antenna panel of the plurality of antenna panels,
wherein the first antenna panel corresponds to the lowest rank, and
wherein the first entry comprises a zero matrix.

27. The apparatus of claim 24, wherein the codebook comprises a plurality of component vectors,
wherein the plurality of component vectors corresponds to the plurality of antenna panels,
wherein a second component vector of the plurality of component vectors corresponds to a second antenna panel of the plurality of antenna panels,
wherein the second antenna panel corresponds to a lowest rank, and
wherein the second component vector further comprises a zero matrix.

28. An apparatus for wireless communication, comprising:
a processor;
a transceiver communicatively coupled to the processor; and
a memory communicatively coupled to the processor,
wherein the apparatus is configured to:
receive a reference signal; and
transmit a channel state information (CSI) report based on the reference signal, the CSI report comprising:
a rank indicator configured to indicate one or more ranks among a plurality of ranks corresponding to a plurality of antenna panels associated with the reference signal, and
a precoding matrix indicator (PMI) corresponding to a codebook for the plurality of antenna panels, a first antenna panel of the plurality of antenna panels having a different number of antenna ports than a second antenna panel of the plurality of antenna panels.

29. The apparatus of claim 28, wherein the codebook comprises a plurality of component vectors,
wherein the plurality of component vectors corresponds to the plurality of antenna panels,
wherein a first component vector of the plurality of component vectors corresponds to a lowest-rank antenna panel of the plurality of antenna panels,
wherein the lowest-rank antenna panel corresponds to a lowest rank of the plurality of ranks, and
wherein the first component vector further comprises a zero matrix.

30. The apparatus of claim 29, wherein the zero matrix is at a first column or a last column in the first component vector.
